(19) United States
(12) Patent Application Publication
(10) Pub. No.: US 2018/0282625 A1
(43) Pub. Date: Oct. 4, 2018

(54) POLYMER, POLYMER SOLUTION, LIQUID CRYSTAL ALIGNMENT LAYER, OPTICALLY ANISOTROPIC BODY, AND LIQUID CRYSTAL DISPLAY ELEMENT

(71) Applicant: DIC Corporation, Tokyo (JP)

(72) Inventors: Martin Chadt, Seltisberg (CH); Fumiaki Kodera, Kita-adachi-gun (JP); Hiroyuki Itou, Kita-adachi-gun (JP); Haruyoshi Takatsu, Kita-adachi-gun (JP); Hiroshi Hasebe, Kita-adachi-gun (JP); Isa Nishiyama, Kita-adachi-gun (JP); Yoshitaka Saito, Kita-adachi-gun (JP)

(73) Assignee: DIC Corporation, Tokyo (JP)

(21) Appl. No.: 15/768,747

(22) PCT Filed: Oct. 13, 2016
(86) PCT No.: PCT/JP2016/080336

§ 371 Date: Apr. 16, 2018

(30) Foreign Application Priority Data
Oct. 16, 2015 (JP) 2015-204829

(51) Int. Cl. C09K 19/56; C09K 19/38

(52) U.S. Cl. CPC C09K 19/56; C09K 19/3823

(57) ABSTRACT

Provided is a polymer which is capable of forming a liquid crystal alignment layer that combines an excellent alignment regulating force, high sensitivity with respect to polarized ultraviolet ray, and excellent durability. The polymer includes a side chain unit represented General Formula (I) and a side chain unit represented by General Formula (II), in which a polyamic acid or a polyimide is set as a main chain.

### TECHNICAL FIELD

The present invention relates to a polymer, a polymer solution, a liquid crystal alignment layer, an optically anisotropic body, and a liquid crystal display element.

### BACKGROUND ART

The liquid crystal alignment layer has excellent features that there is no microscopic flaw due to mechanical rubbing, there is no danger of dust generation due to rubbing and TFT element breakage due to the generated dust, and high definition patterning can be realized. For this reason, application to various liquid crystal displays is energetically advanced. In particular, there is a great demand for a liquid crystal alignment layer for horizontal alignment (planar orientation) used for IPS/FFS display.

As a producing method of the liquid crystal alignment layer which is not subjected to a rubbing treatment, a method in which first, a solution containing a photoalignable polymer is applied onto a substrate, a dried coating film is formed, and then the coating film is irradiated with polarized light, and thereby an alignment regulating force to the liquid crystal is applied to the surface of the liquid crystal alignment layer is common (for example, refer to PTL 1).

### CITATION LIST

### Patent Literature

[PTL 1] WO2013/002260

### SUMMARY OF INVENTION

### Technical Problem

When the liquid crystal alignment layer having a small alignment regulating force is used for a liquid crystal display element, a problem called AC burn-in is caused. The AC burn-in means a failure mode caused when liquid crystal molecules are not completely returned in the alignment direction defined by the liquid crystal alignment layer even though the voltage is returned to a state where the voltage is not applied after a state where the voltage was continuously applied to the liquid crystal molecules. As the AC burn-in occurs, a serious reduction in contrast occurs as well, so that a liquid crystal alignment layer which is hard to cause AC seizure is desired.

On the other hand, in the producing of the liquid crystal alignment layer, it is also required to reduce an irradiation amount of polarized ultraviolet rays necessary for applying an alignment regulating force, to reduce a tact time and the producing cost of liquid crystal panel production.

In order to meet the above requirements, as a photoalignable side chain unit, a polymer having a cinnamic acid derivative and an azobenzene derivative as a side chain is disclosed in PTL 1. The cinnamic acid derivative is dimerized by polarized ultraviolet rays, which leads to an excellent alignment regulating force, sensitivity with respect to polarized ultraviolet rays is enhanced by azobenzene, and irradiation time is reduced.

However, further improvement of the alignment regulating force and the sensitivity with respect to the polarized ultraviolet rays has been desired. Further, improvement of durability (reliability) for maintaining these excellent characteristics at the time of use has been desired.

The present invention has been made in view of the above circumstances, there are provided a polymer which is capable of forming a liquid crystal alignment layer that combines an excellent alignment regulating force, high sensitivity with respect to polarized ultraviolet ray, and excellent durability, a polymer solution containing the polymer, a liquid crystal alignment layer using the polymer, and an optically anisotropic body provided with the liquid crystal alignment layer and a liquid crystal display element.

### Solution to Problem

According to a first aspect of the present invention, there is provided a polymer comprising one or more kinds of side chain units Ma represented by General Formula (I):

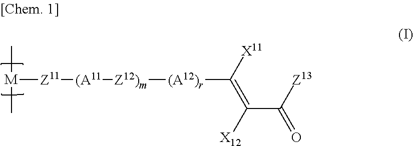

(In the formula, M represents a polymer main chain;

Z¹¹ and Z¹² each independently represent a single bond, —(CH₂)ᵤ— (in the formula, u represents 1 to 20), —OCH₂—, —CH₂O—, —COO—, —OCO—, —CH═CH—, —CF═CF—, —CF₂O—, —OCF₂—, —CF₂CF₂—, or —C≡C—, and one or more non-adjacent —CH₂— groups in these substituents may be independently substituted with —O—, —CO—, —CO—O—, —O—CO—, —Si(CH₃)₂—O—Si(CH₃)₂—, —NR—, —NR—CO—, —CO—NR—, —NR—CO—O—, —O—CO—NR—, —NR—CO—NR—, —CH═CH—, —C≡C— or —O—CO—O— (in the formulae, R independently represents a hydrogen atom or an alkyl group having 1 to 5 carbon atoms);

A¹¹ and A¹² each independently represent (a) a trans-1,4-cyclohexylene group (one methylene group present or two or more non-adjacent methylene groups in the group may be substituted with —O—, —NH—, or —S—), (b) a 1,4-phenylene group (one or two or more —CH═'s present in this group may be substituted with —N═), and (c) a group selected from the group consisting of a 1,4-cyclohexenylene group, a 2,5-thiophenylene group, a 2,5-furanylene group, a 1,4-bicyclo[2.2.2]octylene group, a naphthalene-1,4-diyl group, a naphthalene-2,6-diyl group, a decahydronaphthalene-2,6-diyl group, and a 1,2,3,4-tetrahydronaphthalene-2,6-diyl group, and the group (a), group (b), or group (c) each may be unsubstituted or one or more hydrogen atoms thereof may be substituted with a fluorine atom, a chlorine atom, a cyano group, a methyl group, or a methoxy group;

m represents 0, 1 or 2, and in the case where m represents 2, plural A¹¹'s may be the same or different and plural Z¹²'s may be the same or different;

r represents 0, 1, or 2, and in the case where r represents 2, plural A¹²'s may be the same or different;

X¹¹ and X¹² each independently represent a hydrogen atom, a fluorine atom, a chlorine atom, a cyano group, or an alkyl group having 1 to 20 carbon atoms, the hydrogen atom in the alkyl group may be substituted with a fluorine atom, one —CH₂— group or two or more non-adjacent —CH₂— groups in the alkyl group may be substituted with one or more selected from —O—, —CO—O—, —O—CO—, and —CH═CH—; and

Z¹³ is represented by General Formula (Ia) or (Ib):

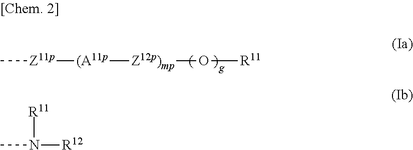

(In the formulae, the dashed lines represent a bond to a carbon atom to which Z¹³ is bonded, R¹¹ and R¹² each independently represent a hydrogen atom or a linear or branched alkyl group having 1 to 30 carbon atoms, one —CH₂— group or two or more non-adjacent —CH₂— group in R¹¹ and R¹² may be substituted with one or more selected from —O—, —CO—, —CO—O—, —O—CO—, —CO—NH—, —NH—CO—, —NCH₃—, —CH═CH—, —CF═CF—, and —C≡C—, one or two or more —CH₂— groups in R¹¹ and R¹² each may be independently substituted with a cycloalkylene group having 3 to 8 ring members, and the hydrogen atoms in R¹¹ and R¹² may be substituted with an alkyl group having 1 to 20 carbon atoms, a cyano group, or a halogen atom;

Z^{11p} and Z^{12p} each independently represent a single bond, —(CH₂)ᵤ— (in the formula, u represents 1 to 20), —OCH₂—, —CH₂O—, —COO—, —OCO—, —CH═CH—, —CF═CF—, —CF₂O—, —OCF₂—, —CF₂CF₂—, or —C≡C—, and one or more non-adjacent —CH₂— groups in these substituents may be independently substituted with —O—, —CO—, —CO—O—, —O—CO—, —Si(CH₃)₂—O—Si(CH₃)₂—, —NR—, —NR—CO—, —CO—NR—, —NR—CO—O—, —O—CO—NR—, —NR—CO—NR—, —CH═CH—, —C≡C—, or —O—CO—O— (in the formulae, R independently represents a hydrogen atom or an alkyl group having 1 to 5 carbon atoms);

A^{11p} represents (a) a trans-1,4-cyclohexylene group (one methylene group or two or more non-adjacent methylene groups present in the group may be substituted with —O—, —NH—, or —S—), (b) a 1,4-phenylene group (one or two or more —CH═'s present in this group may be substituted with —N═), and (c) a group selected from the group consisting of a 1,4-cyclohexenylene group, a 2,5-thiophenylene group, a 2,5-furanylene group, a 1,4-bicyclo[2.2.2]octylene group, a naphthalene-1,4-diyl group, a naphthalene-2,6-diyl group, a decahydronaphthalene-2,6-diyl group, and a 1,2,3,4-tetrahydronaphthalene-2,6-diyl group, and the group (a), group (b), or group (c) each may be unsubstituted or one or more hydrogen atoms thereof may be substituted with a fluorine atom, a chlorine atom, a cyano group, a methyl group, or a methoxy group;

mp represents 0, 1 or 2, and in the case where mp represents 2, plural A^{11p}'s may be the same or different and plural Z^{12p}'s may be the same or different; and

g represents 0 or 1)); and

one or more kinds of side chain units Mb represented by General Formula (II):

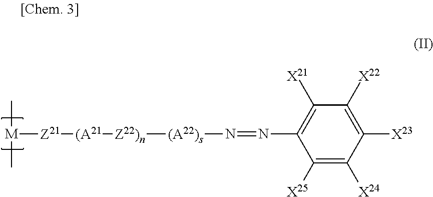

(In the formula, M represents a polymer main chain;

A²¹ and A²² each independently represent a trans-1,4-cyclohexylene group, a trans-1,3-dioxane-2,5-diyl group, a 1,4-naphthylene group, 2,6-naphthylene group, a pyridine-2,5-diyl group, a pyrimidine-2,5-diyl group, a 2,5-thiophenylene group, 2,5-furanylene group, or a 1,4-phenylene group, these may be unsubstituted or one or more hydrogen atoms thereof may be substituted with a fluorine atom, a chlorine atom, or a linear or branched alkyl group having 1 to 20 carbon atoms (one or more non-adjacent —CH₂— groups in the alkyl group may be independently substituted with —O—, —COO—, —OCO—, —CH═CH—, —CF═CF—, —CF₂O—, —OCF₂—, —CF₂CF₂—, —C≡C—, —CO—, —S—, —Si(CH₃)₂—O—Si(CH₃)₂—, —NR′—, —NR′—CO—, —CO—NR′—, —NR′—CO—O—, —O—CO—NR′—, —NR′—CO—NR′—, —CH═CH—, —C≡C—, or —O—CO—O— (in the formulae, R′ independently represents a hydrogen atom or an alkyl group having 1 to 5 carbon atoms), and one or more hydrogen atoms of the alkyl group having 1 to 20 carbon atoms may be substituted with a fluorine atom, a chlorine atom, a hydroxy group, or a cyano group);

X²¹, X²², X²³, X²⁴, and X²⁵ each may independently denote a hydrogen atom, a fluorine atom, a chlorine atom, a hydroxy group, a nitro group, a cyano group, or Formula (IIa):

[Chem. 4]

-A²³-(Z²³-A²⁴)_{q}-R² (IIa)

in the formula, the dashed line represents a bond to a carbon atom to which X²¹ to X²⁵ are bonded;

A²³ and A²⁴ represent a single bond, a trans-1,4-cyclohexylene group, a trans-1,3-dioxane-2,5-diyl group, a 1,4-naphthylene group, 2,6-naphthylene group, a pyridine-2,5-diyl group, a pyrimidine-2,5-diyl group, a 2,5-thiophenylene group, 2,5-furanylene group, or a 1,4-phenylene group, these may be unsubstituted or one or more hydrogen atoms thereof may be substituted with a fluorine atom, a chlorine atom, or a linear or branched alkyl group having 1 to 20 carbon atoms (one or more non-adjacent —CH₂— groups in the alkyl group each may be independently substituted with —O—, —COO—, —OCO—, —CH═CH—, —CF═CF—, —CF₂O—, —OCF₂—, —CF₂CF₂—, —C≡C—, —CO—, —S—, —Si(CH₃)₂—O—Si(CH₃)₂—, —NR′—, —NR′—CO—, —CO—NR′—, —NR′—CO—O—, —O—CO—NR′—, —NR′—CO—NR′—, —CH═CH—, —C≡C—, or —O—CO—O— (in the formulae, R′ independently represents a hydrogen atom or an alkyl group having 1 to 5 carbon atoms), and one or more hydrogen atoms of the alkyl group having 1 to 20 carbon atoms may be substituted with a fluorine atom, a chlorine atom, a hydroxy group, or a cyano group);

Z²¹, Z²², and Z²³ each independently represent a single bond, a linear or branched group having 1 to 40 carbon atoms, —OCH₂—, —CH₂O—, —COO—, —OCO—, —CH═CH—, —CF═CF—, —CF₂O—, —OCF₂—, —CF₂CF₂—, —N═N—, or —C≡C—, one or more non-adjacent —CH₂— groups in the alkylene group each may be independently substituted with —O—, —COO—, —OCO—, —CH═CH—, —CF═CF—, —CF₂O—, —OCF₂—, —CF₂CF₂—, —C≡C—, —CO—, —S—, —Si(CH₃)₂—O—Si(CH₃)₂—, —NR′—, —NR′—CO—, —CO—NR′—, —NR′—CO—O—, —O—CO—NR′—, —NR′—CO—NR′—, —CH═CH—, —C≡C— or —O—CO—O— (in the formulae, R′ independently represents a hydrogen atom or an alkyl group having 1 to 5 carbon atoms), and the hydrogen atoms of one or more —CH₂— groups of the alkylene group may be substituted with a fluorine atom, a chlorine atom, a hydroxy group, or a cyano group;

n and q each independently represent 0 or 1;

s represents 1 or 2, and in the case where s represents 2, plural A²²'s may be the same or different; and

R² represents a hydrogen atom or a linear or branched alkyl group having 1 to 40 carbon atoms, one or more non-adjacent —CH₂— groups in the alkyl group may be independently substituted with —O—, —COO—, —OCO—, —CH═CH—, —CF═CF—, —CF₂O—, —OCF₂—, —CF₂CF₂—, —C≡C—, —CO—, —S—, —Si(CH₃)₂—O—Si(CH₃)₂—, —NR′—, —NR′—CO—, —CO—NR′—, —NR′—CO—O—, —O—CO—NR′—, —NR′—CO—NR′—, —CH═CH—, —C≡C—, or —O—CO—O— (in the formulae, R′ each independently represents a hydrogen atom or an alkyl group having 1 to 5 carbon atoms), the hydrogen atoms of one or more —CH₂— groups of the alkyl group having 1 to 40 carbon atoms may be substituted with a halogen atom, a hydroxy group, or a cyano group, and one or more —CH₂— groups of the alkyl group having 1 to 40 carbon atoms may be independently substituted with a cycloalkylene group having 3 to 8 ring members,

provided that in the case where A²³ is a single bond and q is 0, R² is not a hydrogen atom; and X²¹, X²², X²³, X²⁴, and X²⁵ are not the hydrogen atom at the same time).

A polymer main chain represented by M of the side chain units Ma and Mb is has a repeating unit represented by at least one of General Formulae (U-11) and (U-12):

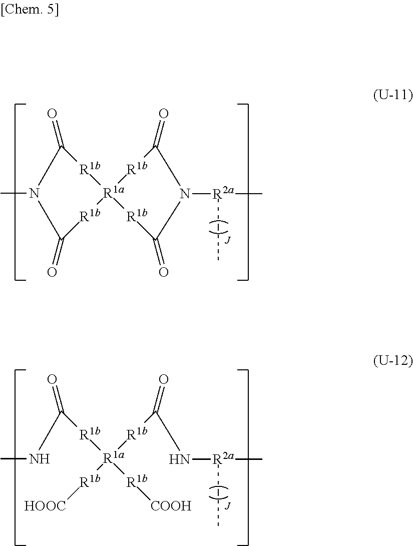

(In the formulae, the dashed lines represent a bond to a group being bonded to M representing the polymer main chain of each side chain unit, R^{1a}'s each independently represent a tetravalent organic group containing a cyclic group, R^{1b}'s each independently represent a single bond or an alkylene group having 1 to 4 carbon atoms, R^{2a} 's each independently represent a trivalent or tetravalent organic group, and J represents 1 or 2).

According to a second aspect of the present invention, there is provided a polymer solution containing the polymer of the first aspect and an organic solvent as essential components.

According to a third aspect of the present invention, there is provided a liquid crystal alignment layer formed of the polymer of the first aspect.

According to a fourth aspect of the present invention, there is provided a liquid crystal display element provided with the liquid crystal alignment layer of the second aspect.

According to a fifth aspect of the present invention, there is provided an optically anisotropic body provided with the liquid crystal alignment layer of the second aspect.

### Advantageous Effects of Invention

According to the polymer of the present invention, it is possible to obtain a liquid crystal alignment layer that combines an excellent alignment regulating force and durability. Since the film obtained by casting this polymer has high sensitivity to polarized ultraviolet ray, a liquid crystal alignment layer having a high alignment regulating force can be obtained with a small amount of light irradiation. As a result, by using the liquid crystal alignment layer according to the present invention, a liquid crystal display element excellent in display image quality can be produced with short tact time.

### BRIEF DESCRIPTION OF DRAWINGS

FIG. 1 is a schematic sectional view illustrating an angle of a liquid crystal molecule with respect to a comb-tooth electrode provided in a liquid crystal cell.

### DESCRIPTION OF EMBODIMENTS

Hereinafter, the present invention will be described based on preferred embodiments, but the present invention is not limited to such embodiments.

### <<Polymer>>

The polymer of the first aspect of the present invention including one or more kinds of side chain units Ma represented by General Formula (I), and one or more kinds of side chain units Mb represented by General Formula (II), and has a repeating unit represented by at least one of General Formula (U-11) and (U-12) as a polymer main chain.

### <Side Chain Unit Ma>

The side chain unit Ma is represented by General Formula (I), and is a side chain unit containing a cinnamic acid derivative.

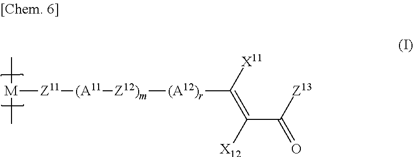

In General Formula (I), M represents a polymer main chain, and has a repeating unit represented by at least one of General Formula (U-11) and General Formula (U-12).

In General Formula (I), Z¹¹ and Z¹² each independently represent a single bond, —(CH₂)ᵤ— (in the formula, u represents 1 to 20), —OCH₂—, —CH₂O—, —COO—, —OCO—, —CH═CH—, —CF═CF—, —CF₂O—, —OCF₂—, —CF₂CF₂—, or —C≡C—, and one or more non-adjacent —CH₂— groups in these substituents may be independently substituted with —O—, —CO—, —CO—O—, —O—CO—, —Si(CH₃)₂—O—Si(CH₃)—, —NR—, —NR—CO—, —CO—NR—, —NR—CO—O—, —O—CO—NR—, —NR—CO—NR—, —CH═CH—, —C≡C— or —O—CO—O— (in the formulae, R independently represents a hydrogen atom or an alkyl group having 1 to 5 carbon atoms), A¹¹ and A¹² each independently represent

(a) a trans-1,4-cyclohexylene group (one methylene group present or two or more non-adjacent methylene groups in the group may be independently substituted with —O—, —NH—, or —S—),
(b) a 1,4-phenylene group (one or two or more —CH═'s present in this group may be substituted with —N═), and
(c) a group selected from the group consisting of a 1,4-cyclohexenylene group, a 2,5-thiophenylene group, a 2,5-furanylene group, a 1,4-bicyclo[2.2.2]octylene group, a naphthalene-1,4-diyl group, a naphthalene-2,6-diyl group, a decahydronaphthalene-2,6-diyl group, and a 1,2,3,4-tetrahydronaphthalene-2,6-diyl group, and the group (a), group (b), or group (c) each may be unsubstituted or one or more hydrogen atoms thereof may be substituted with a fluorine atom, a chlorine atom, a cyano group, a methyl group, or a methoxy group, m represents 0, 1 or 2, and in the case where m represents 2, plural A¹¹'s may be the same or different and plural Z¹²'s may be the same or different, r represents 0, 1, or 2, and in the case where r represents 2, plural A¹²'s may be the same or different, X¹¹ and X¹² each independently represents a hydrogen atom, a fluorine atom, a chlorine atom, a cyano group, or an alkyl group having 1 to 20 carbon atoms, the hydrogen atom in the alkyl group may be substituted with a fluorine atom, and one —CH₂— group or two or more non-adjacent —CH₂— groups may be substituted with one or more selected from —O—, —CO—O—, —O—CO—, and —CH═CH—, Z¹³ is represented by General Formula (Ia) or (Ib):

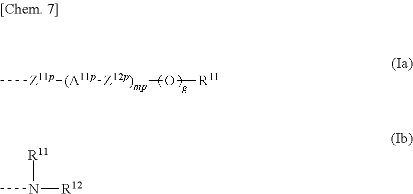

(In the formulae, the dashed lines represent a bond to a carbon atom to which Z¹³ is bonded; R¹¹ and R¹² each independently represent a hydrogen atom or a linear or branched alkyl group having 1 to 30 carbon atoms, one —CH₂— group or two or more non-adjacent —CH₂— group in R¹¹ and R¹² may be substituted with one or more selected from —O—, —CO—, —CO—O—, —O—CO—, —CO—NH—, —NH—CO—, —NCH₃—, —CH═CH—, —CF═CF—, and —C≡C—, one or two or more —CH₂— groups in R¹¹ and R¹² each may be independently substituted with a cycloalkyl group having 3 to 8 ring members, a hydrogen atom in R¹¹ and R¹² may be substituted with an alkyl group having 1 to 20 carbon atoms, a cyano group, or a halogen atom; Z^{11p} and Z^{12p} each independently represent a single bond, —(CH₂)ᵤ— (in the formula, u represents 1 to 20), —OCH₂—, —CH₂O—, —COO—, —OCO—, —CH═CH—, —CF═CF—, —CF₂O—, —OCF₂—, —CF₂CF₂—, or —C≡C—, and one or more non-adjacent —CH₂— groups in these substituents each may be independently substituted with —O—, —CO—, —CO—O—, —O—CO—, —Si(CH₃)₂—O—Si(CH₃)₂—, —NR—, —NR—CO—, —CO—NR—, —NR—CO—O—, —O—CO—NR—, —NR—CO—NR—, —CH═CH—, —C≡C—, or —O—CO—O— (in the formulae, R independently represents a hydrogen atom or an alkyl group having 1 to 5 carbon atoms); A^{11p} represents (a) a trans-1,4-cyclohexylene group (one methylene group present or two or more non-adjacent methylene groups in the group each may be independently substituted with —O—, —NH—, or —S—), (b) a 1,4-phenylene group (one or two or more —CH═'s present in this group may be substituted with —N═), and (c) a group selected from the group consisting of a 1,4-cyclohexenylene group, a 2,5-thiophenylene group, a 2,5-furanylene group, a 1,4-bicyclo[2.2.2]octylene group, a naphthalene-1,4-diyl group, a naphthalene-2,6-diyl group, a decahydronaphthalene-2,6-diyl group, and a 1,2,3,4-tetrahydronaphthalene-2,6-diyl group, and the group (a), group (b), or group (c) each may be unsubstituted or one or more hydrogen atoms thereof may be substituted with a fluorine atom, a chlorine atom, a cyano group, a methyl group, or a methoxy group; mp represents 0, 1 or 2, and in the case where mp represents 2, plural A^{11p}'s may be the same or different and plural Z^{12p}'s may be the same or different; and g represents 0 or 1)).

### <Side Chain Unit Mb>

The side chain unit Mb is represented by General Formula (II), and is a side chain unit containing an azobenzene derivative.

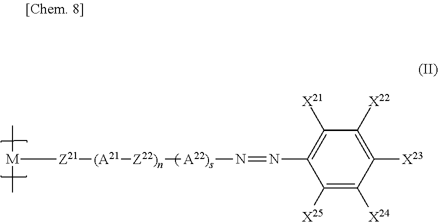

In General Formula (II), M represents a polymer main chain, and has a repeating unit represented by at least one of General Formula (U-11) and General Formula (U-12).

In General Formula (II), A²¹ and A²² each may independently represent a trans-1,4-cyclohexylene group, a trans-1,3-dioxane-2,5-diyl group, a 1,4-naphthylene group, a 2,6-naphthylene group, a pyridine-2,5-diyl group, a pyrimidine-2,5-diyl group, a 2,5-thiophenylene group, 2,5-furanylene group, or a 1,4-phenylene group, and these may be unsubstituted or one or more hydrogen atoms thereof may be substituted with a fluorine atom, a chlorine atom, or a linear or branched alkyl group having 1 to 20 carbon atoms (one or more non-adjacent —CH₂— groups in the alkyl group may be independently substituted with —O—, —COO—, —OCO—, —CH═CH—, —CF═CF—, —CF₂O—, —OCF₂—, —CF₂CF₂—, —C≡C—, —CO—, —S—, —Si(CH₃)₂—O—Si(CH₃)₂—, —NR′—, —NR′—CO—, —CO—NR′—, —NR′—CO—O—, —O—CO—NR′—, —NR′—CO—NR′—, —CH═CH—, —C≡C—, or —O—CO—O— (in the formulae, R′ independently represents a hydrogen atom or an alkyl group having 1 to 5 carbon atoms), or one or more hydrogen atoms of the alkyl group having 1 to 20 carbon atoms may be substituted with a fluorine atom, a chlorine atom, a hydroxy group, or a cyano group), X²¹, X²², X²³, X²⁴, and X²⁵ each may independently denote a hydrogen atom, a fluorine atom, a chlorine atom, a hydroxy group, a nitro group, a cyano group, or Formula (IIa):

[Chem. 9]

-A²³-(Z²³-A²⁴)_{q}-R² (IIa)

(In the formula, the dashed line represents a bond to a carbon atom to which X²¹ to X²⁵ are bonded; A²³ and A²⁴ represent a single bond, a trans-1,4-cyclohexylene group, a trans-1,3-dioxane-2,5-diyl group, a 1,4-naphthylene group, 2,6-naphthylene group, a pyridine-2,5-diyl group, a pyrimidine-2,5-diyl group, a 2,5-thiophenylene group, 2,5-furanylene group, or a 1,4-phenylene group, these may be unsubstituted or one or more hydrogen atoms thereof may be substituted with a fluorine atom, a chlorine atom, or a linear or branched alkyl group having 1 to 20 carbon atoms (one or more non-adjacent —CH₂— groups in the alkyl group may be independently substituted with —O—, —COO—, —OCO—, —CH═CH—, —CF═CF—, —CF₂O—, —OCF₂—, —CF₂CF₂—, —C≡C—, —CO—, —S—, —Si(CH₃)₂—O—Si(CH₃)₂—, —NR′—, —NR′—CO—, —CO—NR′—, —NR′—CO—O—, —O—CO—NR′—, —NR′—CO—NR′—, —CH═CH—, —C≡C—, or —O—CO—O— (in the formulae, R′ independently represents a hydrogen atom or an alkyl group having 1 to 5 carbon atoms), and one or more hydrogen atoms of the alkyl group having 1 to 20 carbon atoms may be substituted with a fluorine atom, a chlorine atom, a hydroxy group, or a cyano group); Z²¹, Z²², and Z²³ each independently represent a single bond, a linear or branched alkylene group having 1 to 40 carbon atoms, —OCH₂—, —CH₂O—, —COO—, —OCO—, —CH═CH—, —CF═CF—, —CF₂O—, —OCF₂—, —CF₂CF₂—, —N═N—, or —C≡C—, and one or more non-adjacent —CH₂— groups in the alkylene group may be independently substituted with —O—, —COO—, —OCO—, —CH═CH—, —CF═CF—, —CF₂O—, —OCF₂—, —CF₂CF₂—, —C≡C—, —CO—, —S—, —Si(CH₃)₂—O—Si(CH₃)₂—, —NR′—, —NR′—CO—, —CO—NR′—, —NR′—CO—O—, —O—CO—NR′—, —NR′—CO—NR′—, —CH═CH—, —C≡C— or —O—CO—O— (in the formulae, R′ independently represents a hydrogen atom or an alkyl group having 1 to 5 carbon atoms), and the hydrogen atoms of one or more —CH₂— groups of the alkylene group may be substituted with a fluorine atom, a chlorine atom, a hydroxy group, or a cyano group; n and q each independently represent 0 or 1; s represents 1 or 2, and in the case where s represents 2, plural A²²'s may be the same or different; R² represents a hydrogen atom or a linear or branched alkyl group having 1 to 40 carbon atoms, one or more non-adjacent —CH₂— groups in the alkyl group may be independently substituted with —O—, —COO—, —OCO—, —CH═CH—, —CF═CF—, —CF₂O—, —OCF₂—, —CF₂CF₂—, —C≡C—, —CO—, —S—, —Si(CH₃)₂—O—Si(CH₃)₂—, —NR′—, —NR′—CO—, —CO—NR′—, —NR′—CO—O—, —O—CO—NR′—, —NR′—CO—NR′—, —CH═CH—, —C≡C—, or —O—CO—O— (in the formulae, R′ independently represents a hydrogen atom or an alkyl group having 1 to 5 carbon atoms), the hydrogen atoms of one or more —CH₂— groups of the alkyl group having 1 to 40 carbon atoms each may be substituted with a halogen atom, a hydroxy group, or a cyano group, and one or more —CH₂— groups of the alkyl group having 1 to 40 carbon atoms may be independently substituted with a cycloalkylene group having 3 to 8 ring members.

Here, in the case where A²³ is a single bond and q is 0, R² is not a hydrogen atom.

### <Polymer Main Chain>

In the polymer of the present invention, repeating units represented by at least one of General Formula (U-11) and (U-12) constitute a polymer main chain.

The repeating units constituting the polymer main chain, represented by M in General Formula (I), and repeating units constituting the polymer main chain, represented by M in General Formula (II) may be the same or different.

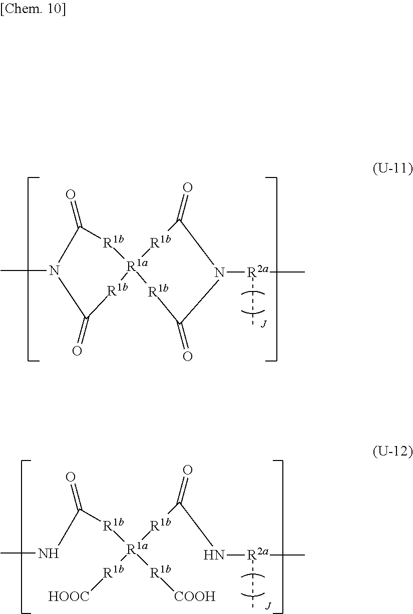

(In the formulae, the dashed lines represent a bond to a group being bonded to M representing the polymer main chain of each side chain unit, R^{1a}'s each independently represent a tetravalent organic group containing a cyclic group, R^{1b}'s each independently represent a single bond or an alkylene group having 1 to 4 carbon atoms, R^{2a} 's each independently represent a trivalent or tetravalent organic group, and J represents 1 or 2).

A group to which the dashed lines in Formulae (U-11) and (U-12) are bonded is a group having one or more selected from Z¹¹'s of the side chain unit Ma, Z²¹'s of the side chain unit Mb, and Sₐₐ's of the side chain unit Mc. In a single polymer chain composed of a plurality of repeating units, one or more kinds of the side chain units Ma and side chain units Mb are respectively contained in the side chain unit bonded to a plurality of R^{2a}'s.

In the case where J is 1, there is one atomic bond represented by a dashed line of R^{2a}, and in the case where J is 2, there are two atomic bonds represented by the dashed line of R^{2a}. In a single polymer chain formed of the plurality of repeating units, there may be only one repeating unit, either a repeating unit in which J is 1 and a repeating unit in which J is 2, or both repeating units may coexist.

A tetravalent organic group represented by R^{1a} is preferably a tetravalent organic group in which four hydrogen atoms have been removed from a compound containing a cycloalkane or an aromatic ring. The cycloalkane is preferably a 4 to 10 membered ring, is more preferably 4 to 6 membered ring, and is still more preferably 4 or 5 membered ring. The aromatic ring is preferably benzene or naphthalene.

Examples of the preferable tetravalent organic group represented by R^{1a} include the groups represented by Formulae (R1a-a) to (R1a-d). Among these, from the viewpoint of improving the durability of the optical alignment layer of the present invention, the groups represented by Formulae (R1a-a) to (R1a-c) are preferable, and the group represented by Formula (R1a-a) or (R1a-b) are more preferable.

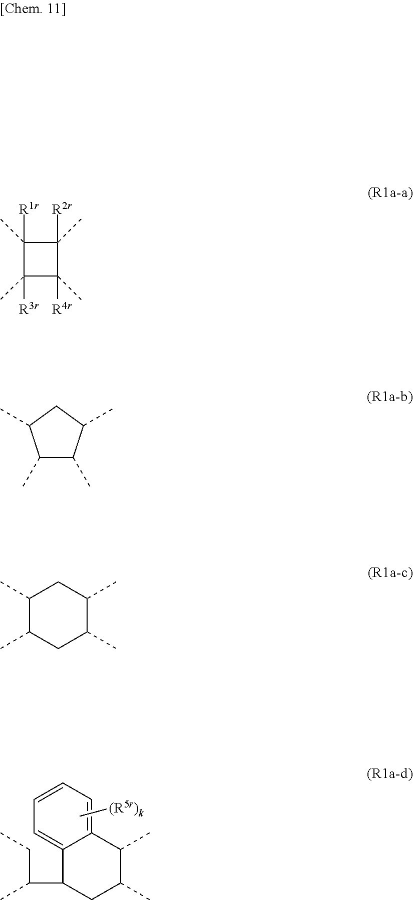

(In the formulae, the dashed lines represent a bond to R^{1b}, R^{1r} to R^{4r}'s each independently represent a hydrogen atom or an alkyl group having 1 to 4 carbon atoms, R^{5r} represents a hydrogen atom, a fluorine atom, or an alkyl group having 1 to 4 carbon atoms, k represents an integer of 0 to 4, and in the case where k is 2 to 4, plural R^{5r}'s may be the same or different.)

A divalent linking group represented by R^{1b} is preferably a single bond, a methylene group, or an ethylene group, and is more preferably a single bond or a methylene group. Plural R^{1b}'s may in General Formulae (U-11) and (U-12) may be the same or different.

The trivalent or tetravalent organic group represented by R^{2a} is preferably a trivalent or tetravalent organic group in which three or four hydrogen atoms are removed from a compound containing an aromatic ring or cycloalkane. The aromatic ring is preferably benzene or naphthalene. The cycloalkane is preferably a 4 to 10 membered ring, and is more preferably a 4 to 6 membered ring.

Examples of the preferable trivalent or tetravalent organic group represented by R^{2a} include the groups represented by Formulae (R2a-a) to (R2a-h). Among these, from the viewpoint of improving the durability of the liquid crystal alignment layer of the present invention, the diamines represented by Formulae (R2a-e) to (R2a-g) are preferable, and the diamines represented by Formula (R2a-f) or (R2a-g) are more preferable.

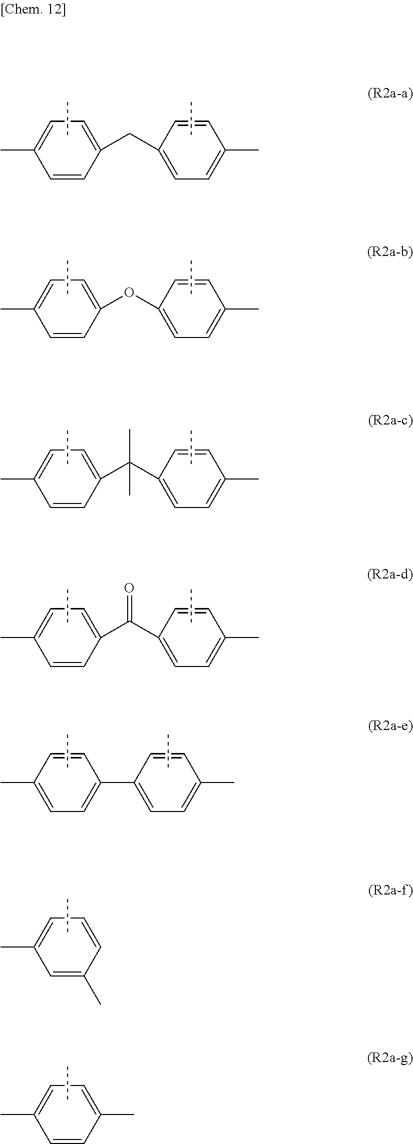

(In the formulae, each of the left end and the right end represents a bond to a nitrogen atom to which R^{2a} is bonded, and each of the dashed lines independently represents a bond to a group bonded to M representing a polymer main chain of each side chain unit).

One or more hydrogen atoms bonded to the organic group represented by R^{1a} and R^{2a} may be substituted with a halogen atom.

### <Preferable Side Chain Unit Ma>

In order to improve the voltage holding ratio (VHR) of the liquid crystal alignment layer from the polymer of the present invention, X¹¹ and X¹² are preferably a hydrogen atom in General Formula (I).

In General Formula (Ia), it is preferable that Z^{11p} is a single bond, mp is 0, and g is 1.

In General Formula (Ia) and General Formula (Ib), R¹¹ preferably represents a linear or branched alkyl group having 1 to 30 carbon atoms (one —CH₂— group or two or more non-adjacent —CH₂— groups in the alkyl group may be substituted with —O—, —CO—, —CO—O—, —O—CO—, —CO—NH—, —NH—CO—, or —NCH₃—, one or two or more —CH₂— groups in the alkyl group each may be independently substituted with a cycloalkylene group having 3 to 8 ring members, and a hydrogen atom in the alkyl group may be substituted with an alkyl group having 1 to 20 carbon atoms, a cyano group, or a halogen atom.)

In General Formula (Ib), R¹² preferably represents a linear or branched alkyl group having 1 to 30 carbon atoms (one or two or more —CH₂— groups in the alkyl group each may be independently substituted with a cycloalkylene group having 3 to 8 ring members, and a hydrogen atom in the alkyl group may be unsubstituted or substituted with an alkyl group having 1 to 20 carbon atoms, a cyano group, or a halogen atom).

In General Formula (Ia) or (Ib), R¹¹ is preferably represented by General Formula (Ic):

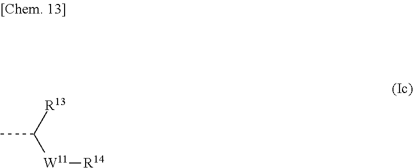

(In the formula, the dashed line represents the bond to the atom to which R¹¹ bonds, W¹¹ represents a methylene group (the hydrogen atom of the methylene group may be unsubstituted or substituted with an alkyl group having 1 to 5 carbon atoms), —CO—O— or —CO—NH—, R¹³ represents a hydrogen atom or an alkyl group having 1 to 5 carbon atoms, R¹⁴ preferably represents a linear or branched alkyl group having 1 to 20 carbon atoms (one —CH₂— group or two or more non-adjacent —CH₂— groups in the alkyl group may be substituted with —O—, —CO—, —CO—O—, —O—CO—, —CO—NH—, —NH—CO—, or —NCH₃—, one or two or more —CH₂— groups in the alkyl group each are independently substituted with a cycloalkylene group having 3 to 8 ring members, and a hydrogen atom in the alkyl group may be unsubstituted or substituted with a fluorine atom, a chlorine atom, or a cyano group).

R¹¹ is preferably represented by General Formula (Ic), from the viewpoint that it is possible to ensure more excellent alignment regulating force and high voltage holding ratio (VHR).

R¹¹ is preferably a cyanoethyl group or a cyanopropyl group, from the viewpoint that it is possible to ensure more excellent alignment regulating force and high voltage holding ratio.

In General Formula (Ia) or (Ib), R¹¹ represents a linear or branched alkyl group having 1 to 30 carbon atoms (one —CH₂— group or two or more non-adjacent —CH₂— groups in the alkyl group are substituted with one or more selected from —CH═CH—, —CF═CF—, and —C≡C—, one or two or more —CH₂— groups in the alkyl group each may be independently substituted with a cycloalkylene group having 3 to 8 ring members, and a hydrogen atom in the alkyl group may be substituted with an alkyl group having 1 to 20 carbon atoms, a cyano group, or a halogen atom), R¹² preferably represents a linear or branched alkyl group having 1 to 30 carbon atoms (one or two or more —CH₂— groups in the alkyl group each may be independently substituted with a cycloalkylene group having 3 to 8 ring members, and a hydrogen atom in the alkyl group may be unsubstituted or substituted with an alkyl group having 1 to 20 carbon atoms, a cyano group, or a halogen atom).

In General Formula (Ia) or (Ib), R¹¹ is preferably represented by General Formula (Id) or (If):

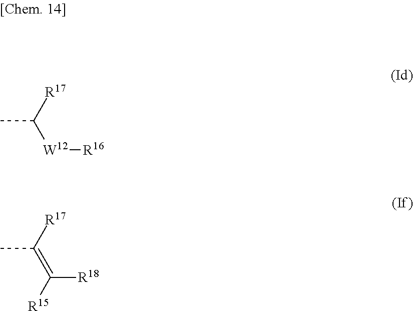

(In the formulae, the dashed lines represent the bond to the atom to which R¹¹ bonds, W¹² represents a single bond, —CH₂—, —CO—O—, or —CO—NH—, R¹⁷ represents a hydrogen atom or an alkyl group having 1 to 5 carbon atoms, R¹⁸ represents a hydrogen atom or a linear or branched alkyl group having 1 to 20 carbon atoms (one or two or more —CH₂— groups in the alkyl group each may be independently substituted with a cycloalkyl group having 3 to 8 ring members, and a hydrogen atom in the alkyl group may be unsubstituted or substituted with a fluorine atom or a chlorine atom), R¹⁵ represents an alkyl group having 1 to 20 carbon atoms (the hydrogen atom in the alkyl group may be substituted with a fluorine atom), R¹⁶ represents an alkyl group having 1 to 20 carbon atoms (one —CH₂— group or two or more non-adjacent —CH₂— groups in the alkyl group are substituted with one or more selected from —CH═CH—, —CF═CF—, and —C≡C—, one or two or more —CH₂— groups in the alkyl group each may be independently substituted with a cycloalkyl group having 3 to 8 ring members, and a hydrogen atom in the alkyl group may be substituted with a fluorine atom or a chlorine atom).

In order to improve the solubility of the polymer of the present invention, it is preferable that Z¹¹ and Z¹² in General Formula (I) are each independently a —(CH₂)ᵤ— group. The carbon atoms of the aforementioned group are preferably 1 to 15, is more preferably 3 to 10, and is still more preferably 5 to 8. It is preferable that one or more non-adjacent —CH₂— groups of the aforementioned group are independently substituted with —O—.

In order to enhance the alignment regulating force of the polymer of the present invention, it is preferable that A¹¹ and A¹² in General Formula (I) each independently the group (b), that is, a 1,4-phenylene group (one or two or more —CH═'s present in this group may be substituted with —N═).

A¹¹ represents any of a trans-1,4-cyclohexylene group, a 2,6-naphthylene group, a pyridine-2,5-diyl group, a pyrimidine-2,5-diyl group, or a 1,4-phenylene group, one or more hydrogen atoms in any of the groups may be substituted with a fluorine atom, a chlorine atom, a methyl group, and a methoxy group, Z¹² represents any of a single bond, —(CH₂)ᵤ— (in the formula, u represents 1 to 20), —OCH₂—, —CH₂O—, —COO—, —OCO—, —CH═CH—, and —C≡C—, and one or more non-adjacent —CH₂— groups in any of the groups may be independently substituted with —O—, —CO—, —CO—O—, —O—CO—, —CH═CH—, or —C≡C—.

A¹² is preferably a pyridine-2,5-diyl group, a pyrimidine-2,5-diyl group, a 2,5-thiophenylene group, or a 1,4-phenylene group, and is more preferably a 1,4-phenylene group in which one or more hydrogen atoms may be substituted with a fluorine atom, a chlorine atom, a methyl group, or a methoxy group.

When A¹² is the above described preferable group, the amount of light irradiation necessary for applying the alignment regulating force to the liquid crystal alignment layer formed of the polymer of the present invention can be reduced (sensitivity to light can be increased).

In order to improve the solubility of the polymer of the present invention, it is preferable that A¹¹ and A¹² are a 1,4-naphthylene group, a 2,6-naphthylene group, a 2,5-thiophenylene group, or a 2,5-furanylene group.

In order to improve the solubility and the alignment regulating force of the polymer of the present invention, in General Formula (I), r is preferably 1 or 2, is more preferably 1.

In order to improve the sensitivity to polarized ultraviolet rays and the alignment regulating force of the present invention of the polymer, m is preferably 0 or 1, and is more preferably 0 in General Formula (I).

In order to make the wavelength of the light used for applying the alignment regulating force to the liquid crystal alignment layer made of the polymer of the present invention longer, A¹² is preferably a pyrimidine-2,5-diyl group, a 2,5-thiophenylene group, a 2,6-naphthylene group, and a 2,5-furanylene group, and X¹¹ and X¹² are preferably a fluorine atom, a chlorine atom, or a cyano group.

In order to reduce a residual charge in the liquid crystal alignment layer formed of the polymer of the present invention, it is preferable that W¹¹ in General Formula (Ic) is —CO—O— or —CO—NH—, and R¹² in General Formula (Ib) is an alkyl group having 1 to 6 carbon atoms, and one —CH₂— group in the alkyl group is substituted with —CH═CH—, or —C≡C—.

In order to improve thermal stability of the alignment regulating force in the liquid crystal alignment layer formed of the polymer of the present invention, it is preferable that Z¹¹ and Z¹² in General Formula (I) are each independently —NR—CO—, —CO—NR—, —NR—CO—O—, —O—CO—NR—, —NR—CO—NR—, or —O—CO—O—, A¹¹'s are independently a 1,4-naphthylene group, a 2,6-naphthylene group, a pyridine-2,5-diyl group, a pyrimidine-2,5-diyl group, a 2,5-thiophenylene group, 2,5-furanylene group, or a 1,4-phenylene group.

In order to improve the solubility of the polymer of the present invention, it is preferable that Z¹² is preferably —OCH₂—, —CH₂O—, —CF₂O—, —OCF₂—, —CF₂CF₂—, —NR—, or —CO—, A¹¹'s are each independently a trans-1,4-cyclohexylene group, a 1,4-naphthylene group, a 2,6-naphthylene group, or a 2,5-furanylene group.

In order to improve the alignment regulating force (liquid crystal alignment property) in the liquid crystal alignment layer formed of the polymer of the present invention, it is preferable that in General Formula (I), Z¹¹ and Z¹² each independently a single bond, a —(CH₂)ᵤ— (in the formula, u represents 1 to 8, one or two non-adjacent —CH₂— group independently represents, —O—, —CO—O—, —O—CO—, —Si(CH₃)₂—O—Si(CH₃)₂—, —CH═CH—, or —C≡C—), —COO—, —OCO—, —CH═CH—, —CF═CF—, or —C≡C—, and A¹¹ and A¹² each independently a trans-1,4-cyclohexylene group, a trans-1,3-dioxane-2,5-diyl group, a pyridine-2,5-diyl group, a pyrimidine-2,5-diyl group, a 2,5-thiophenylene group, or a 1,4-phenylene group.

In General Formula (I), as a combination of —Z¹¹-(A¹¹-Z¹²)ₘ—, for example, those represented by Chemical Formula (Sp-a-1) to Chemical Formula (Sp-ah1-8) are preferable.

In these Chemical Formulae, the left dashed line represents a bond to M and the right dashed line represents a bond to a carbon atom to be bonded to A¹² or X¹¹.

Although it can be selected as required, among these, it is preferable to use those represented by Chemical Formulae (Sp-a-6) to (Sp-a-16), Chemical Formulae (Sp-b-3) to (Sp-b-10), Chemical Formulae (Sp-c-3) to (Sp-c-10), Chemical Formulae (Sp-d-3) to (Sp-d-12), Chemical Formulae (Sp-k-4) to (Sp-k-7), Chemical Formulae (Sp-1-13) to (Sp-1-17), Chemical Formulae (Sp-o-3) to (Sp-o-14), Chemical Formulae (Sp-p-2) to (Sp-p-13), Chemical Formulae (Sp-s-1) to (Sp-s-8), Chemical Formulae (Sp-t-1) to (Sp-t-8), Chemical Formulae (Sp-y-1) to (Sp-y-9), and Chemical Formulae (Sp-aa-1) to (Sp-aa-9).

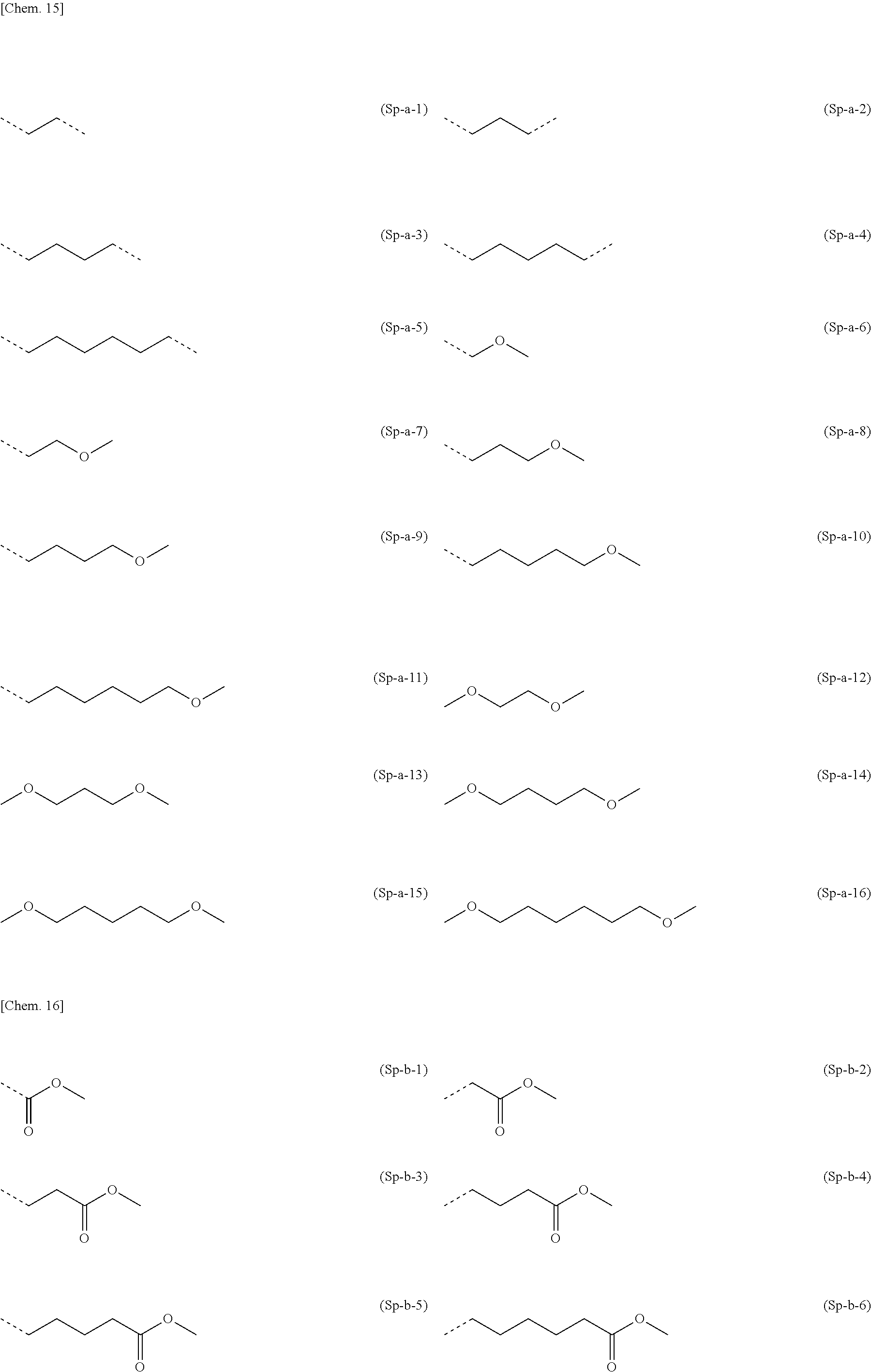

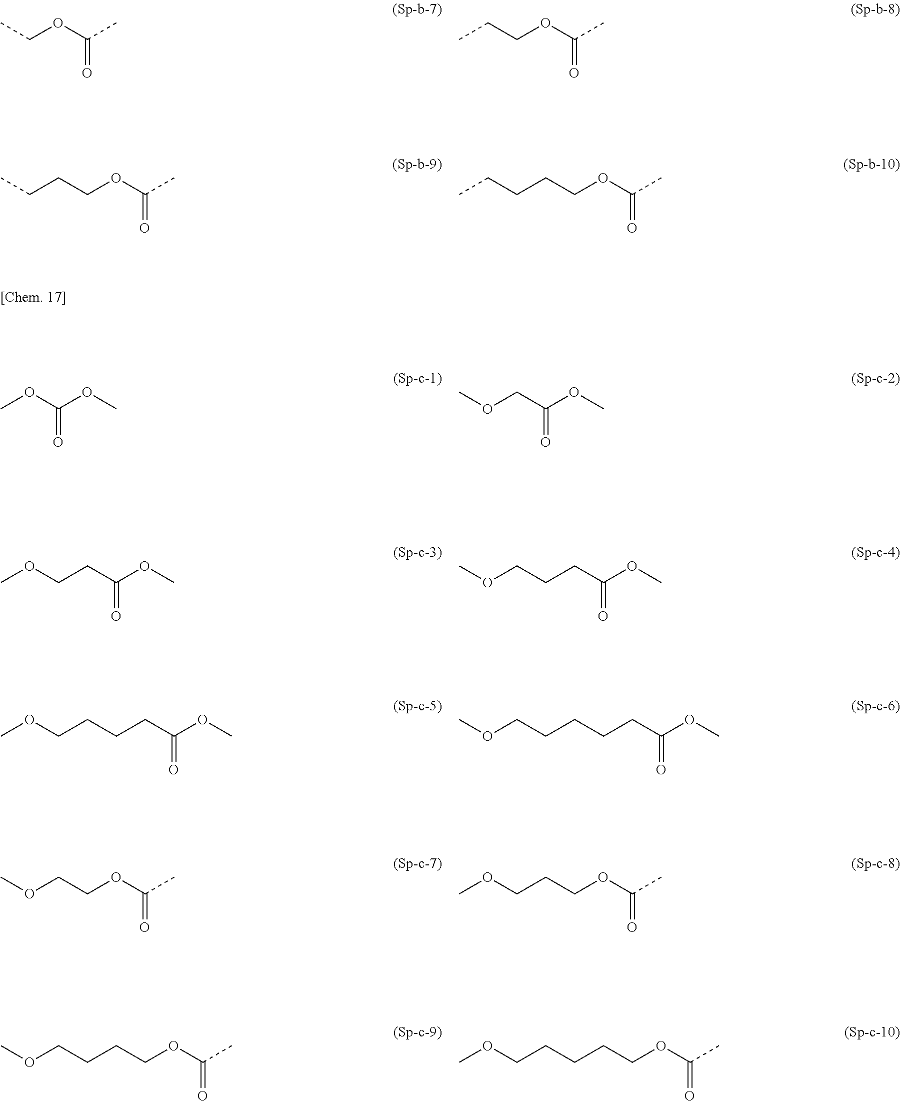

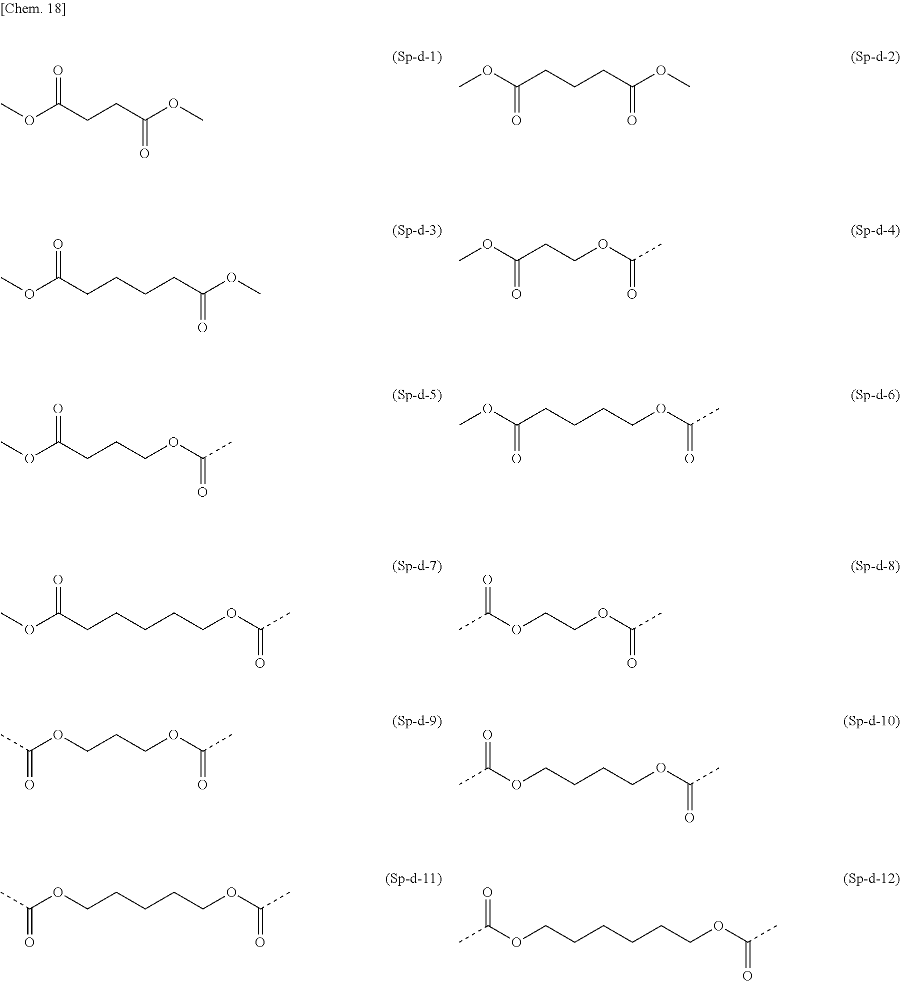

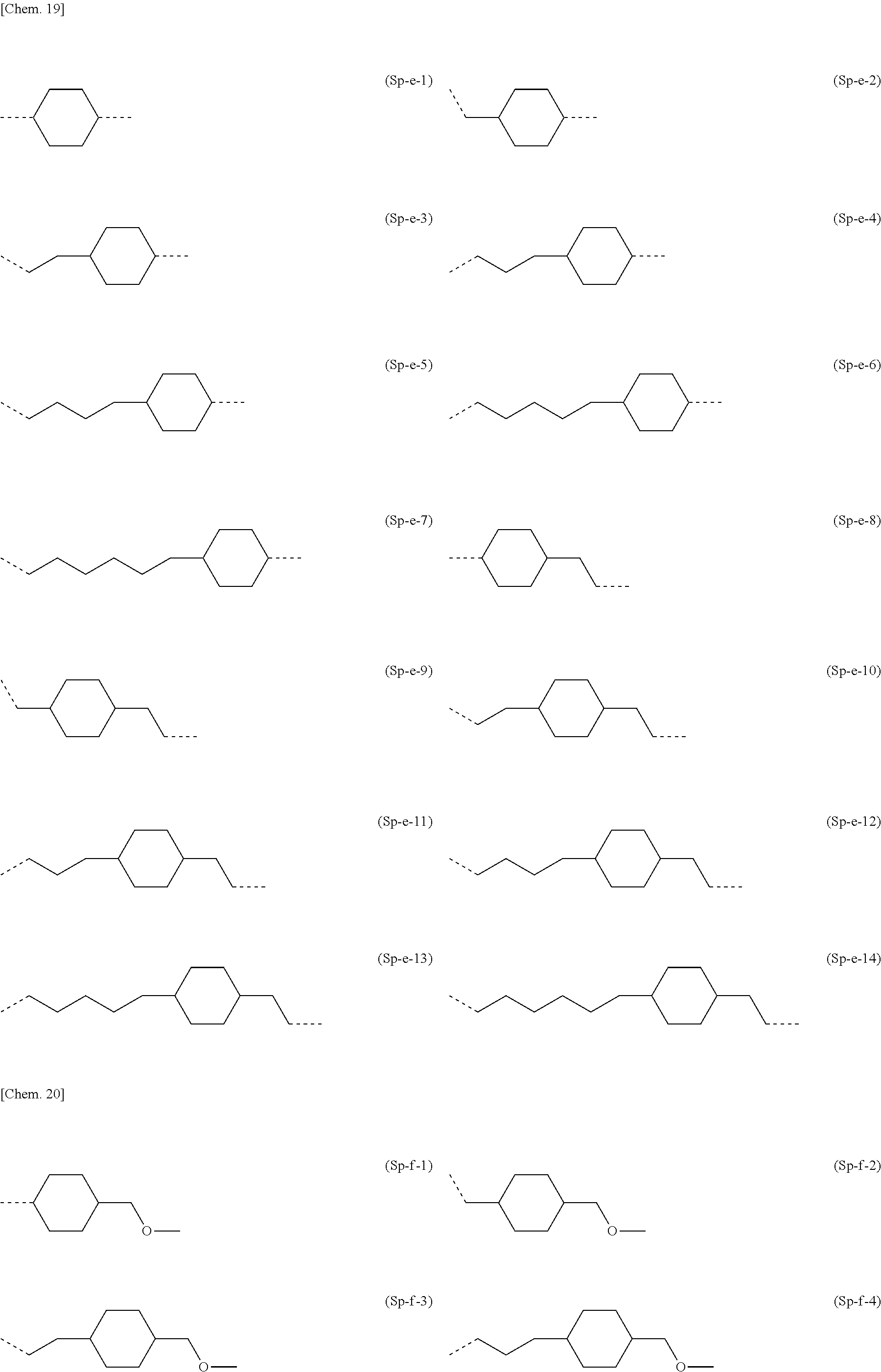

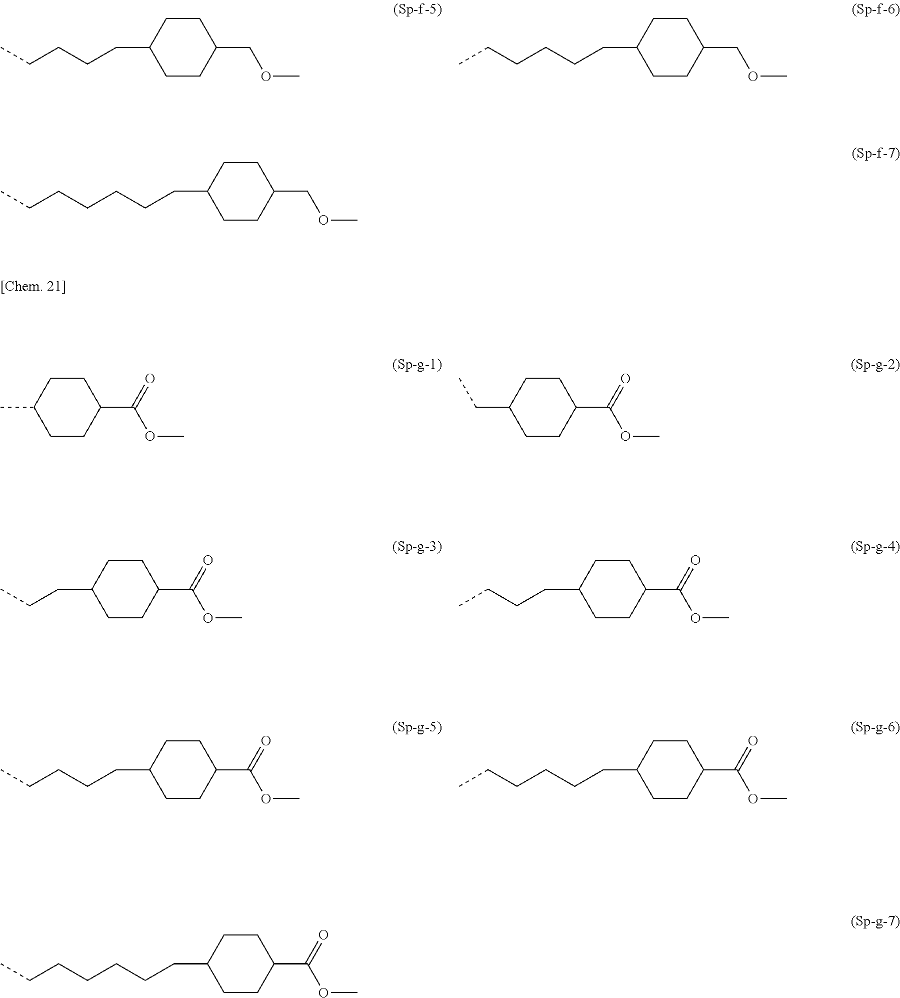

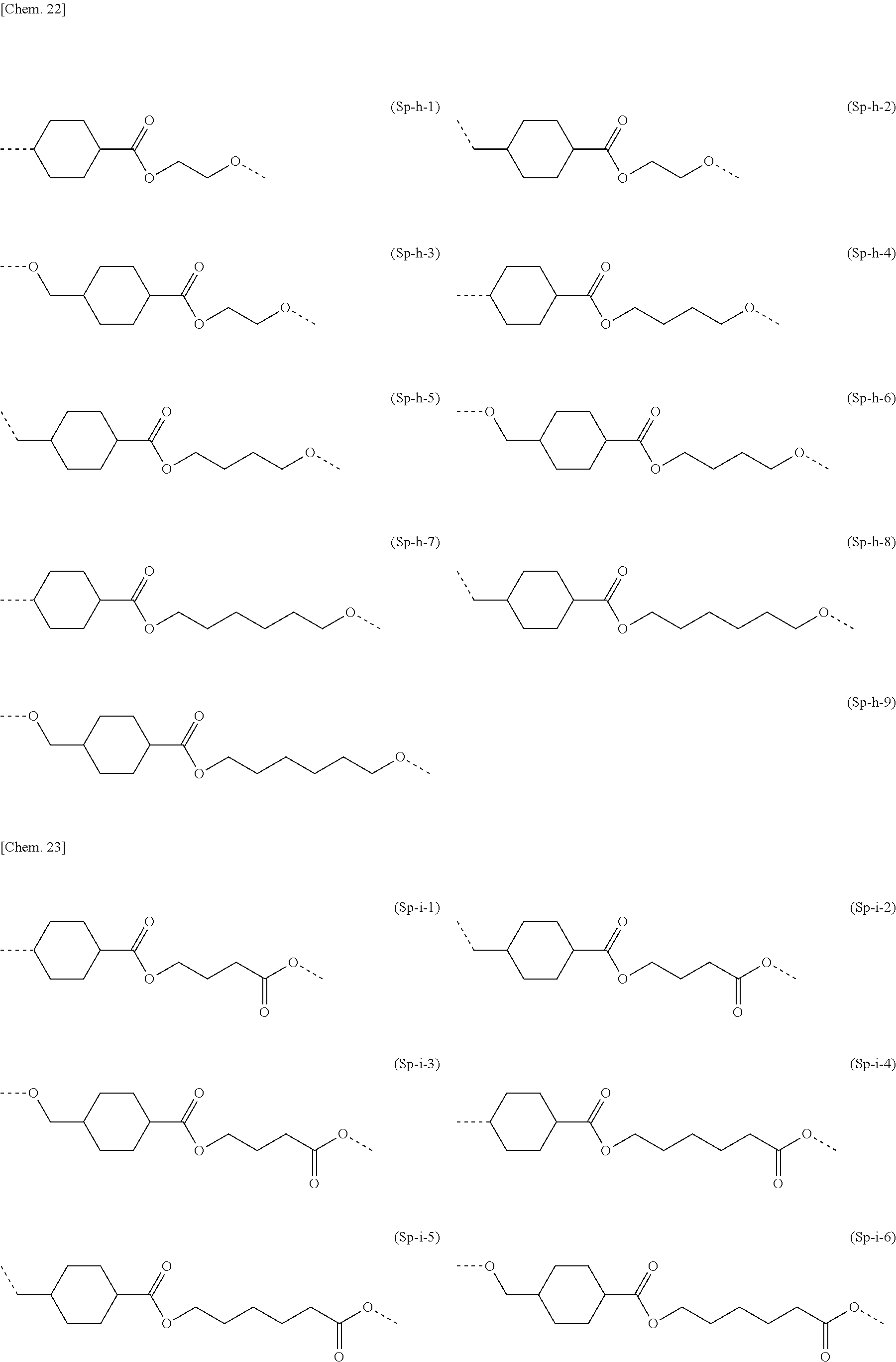

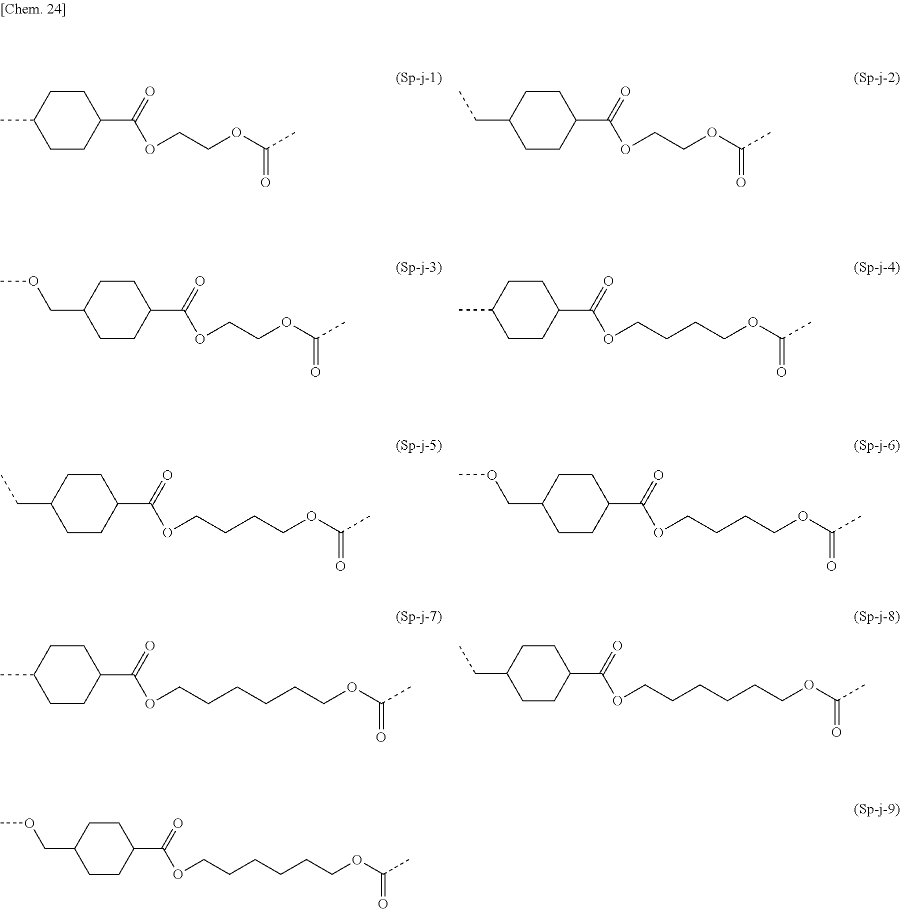

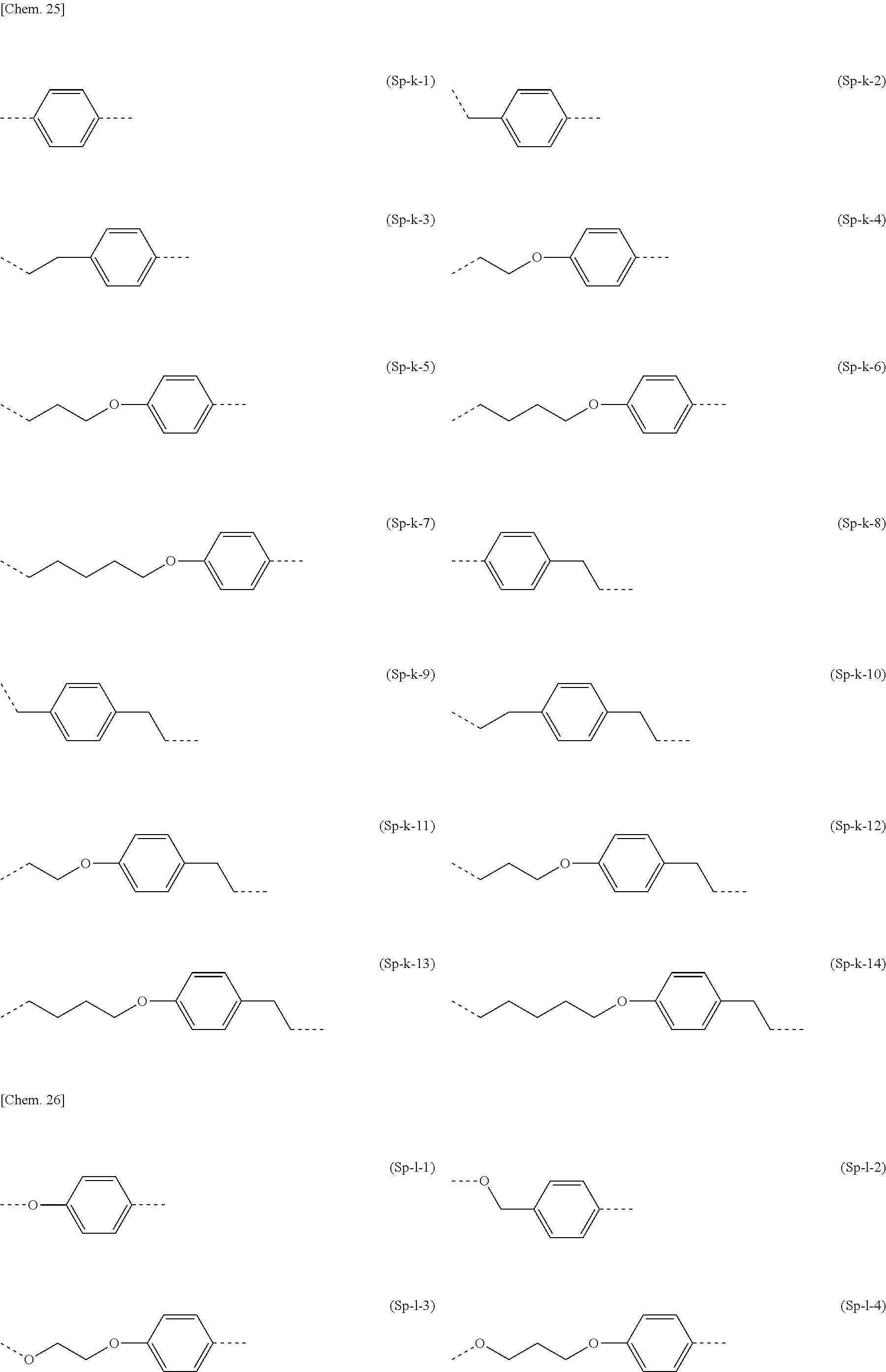

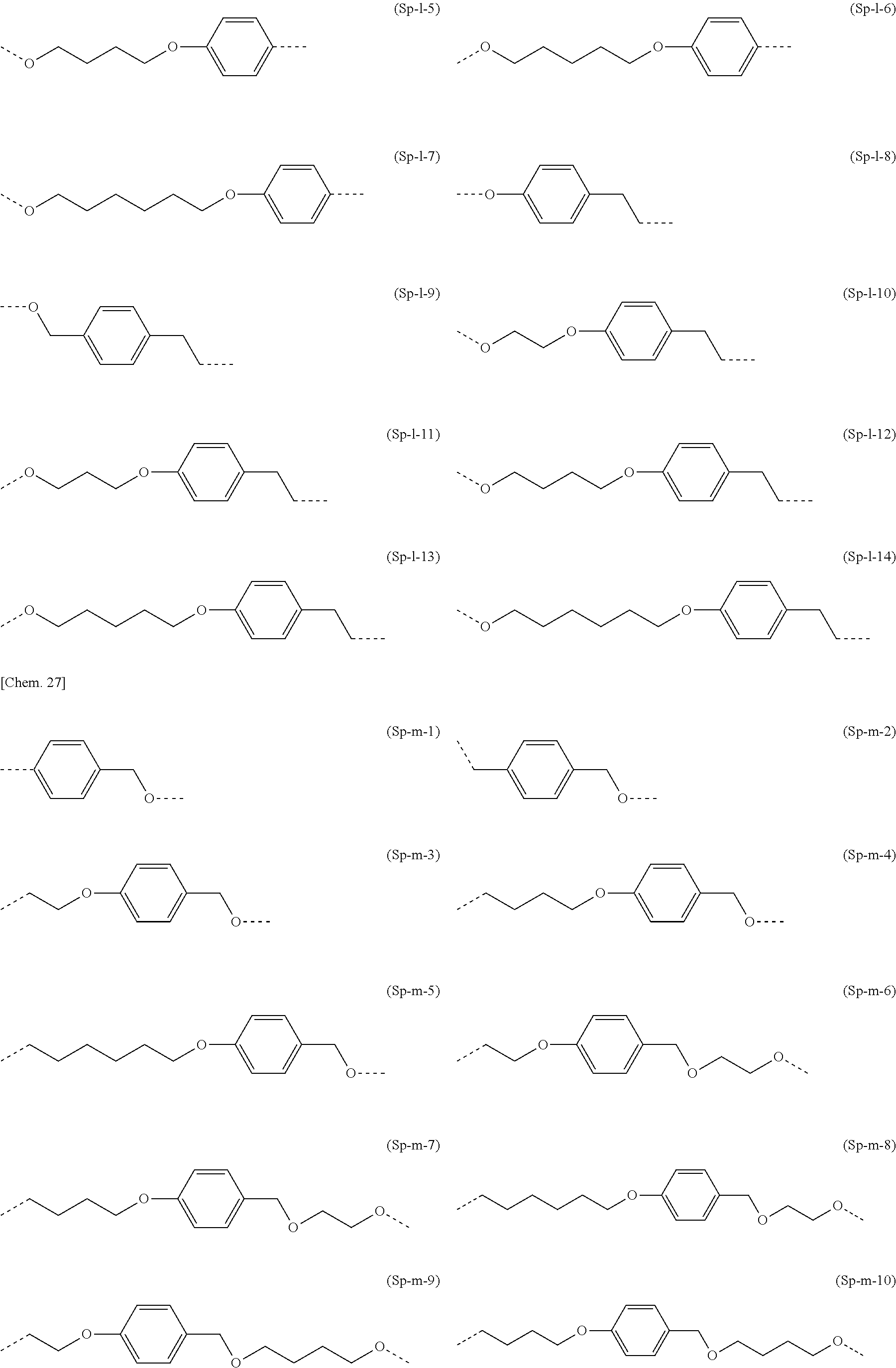

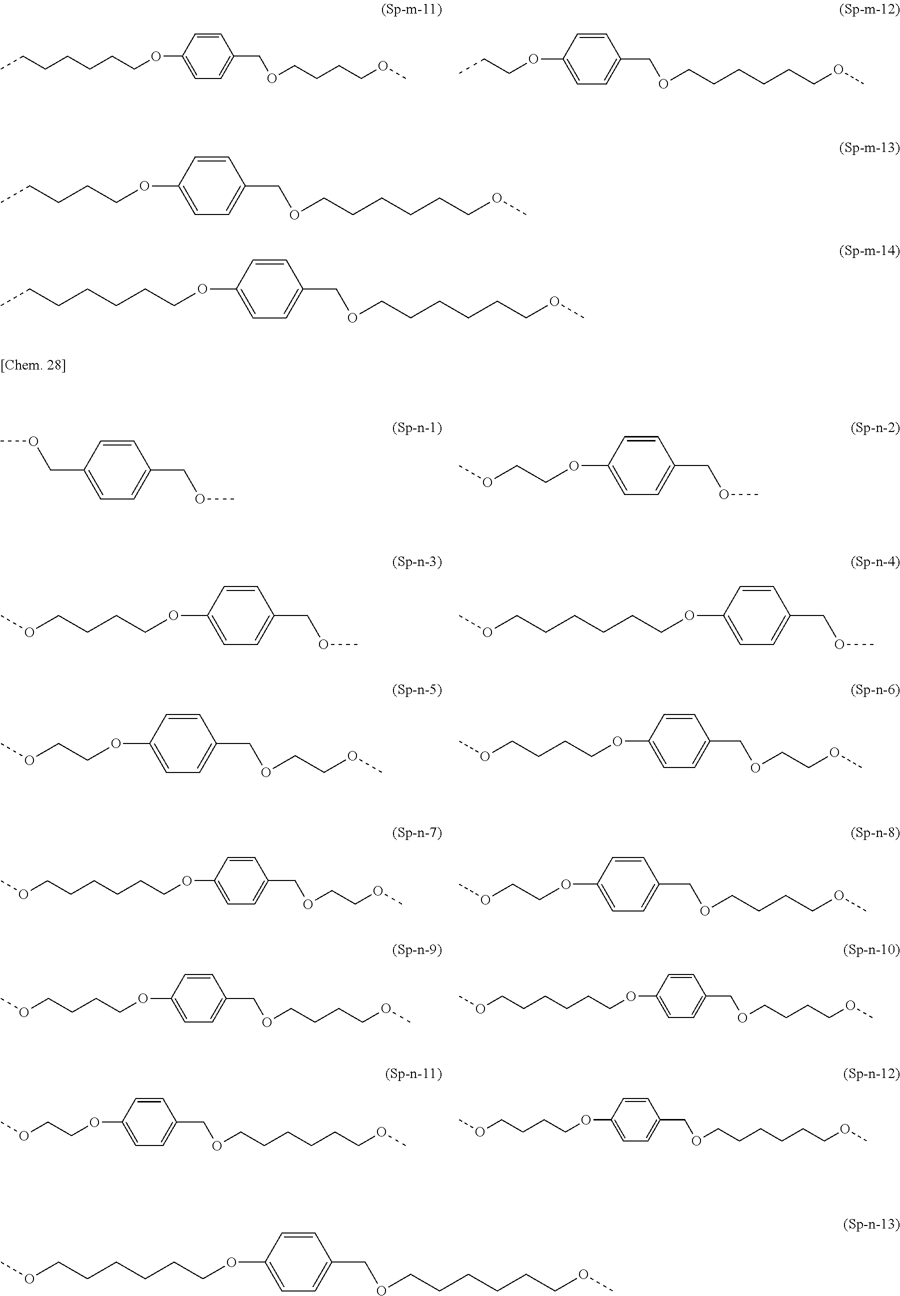

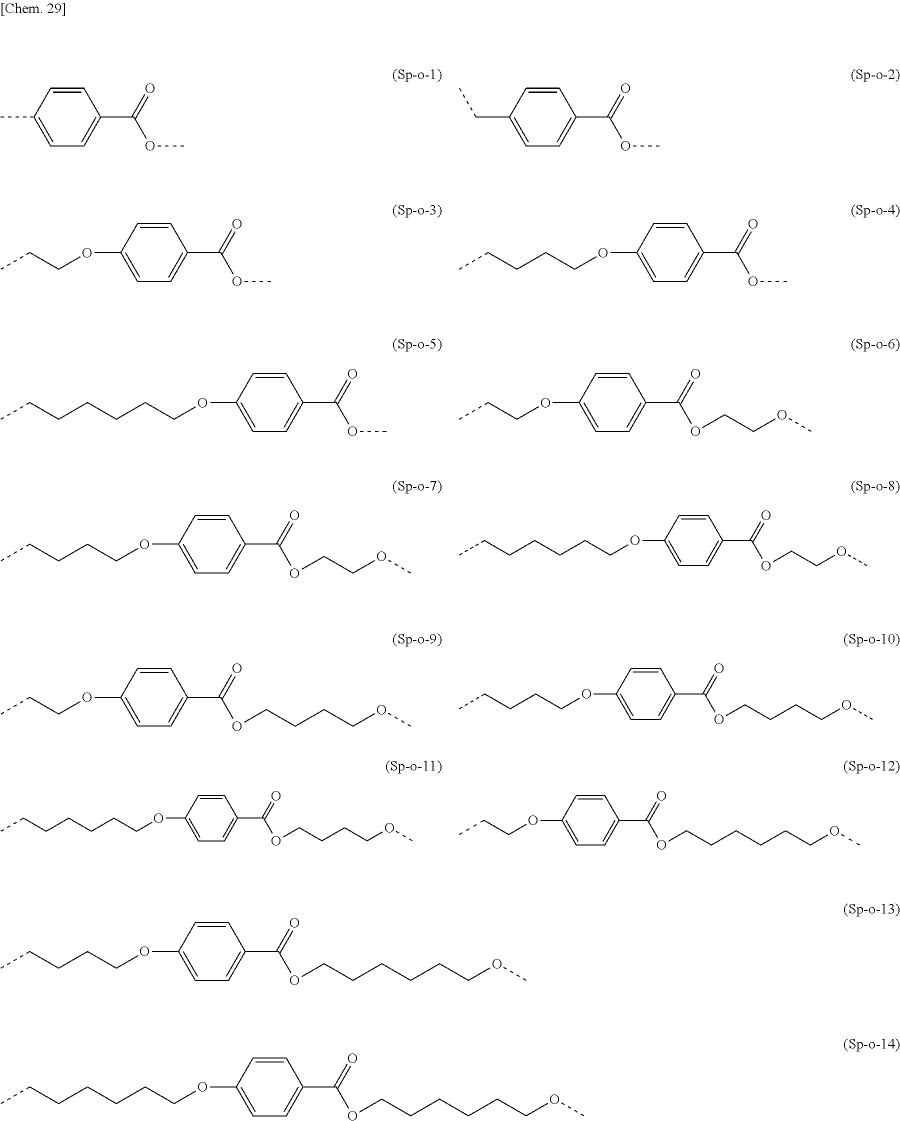

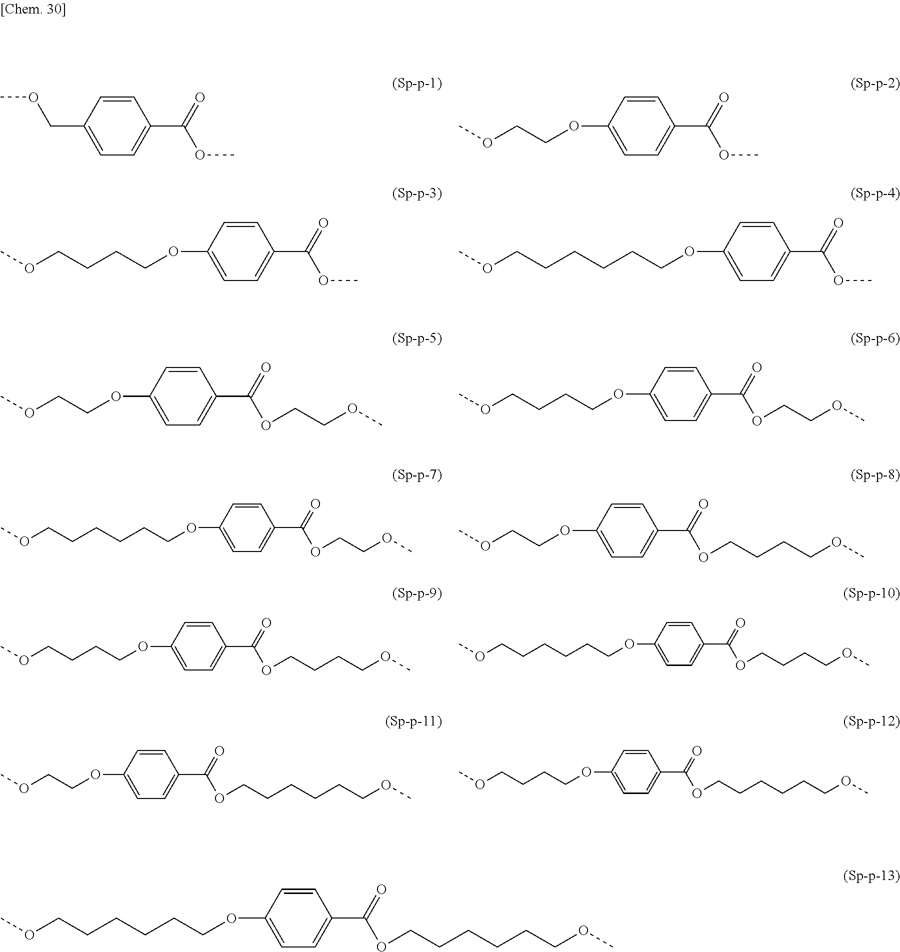

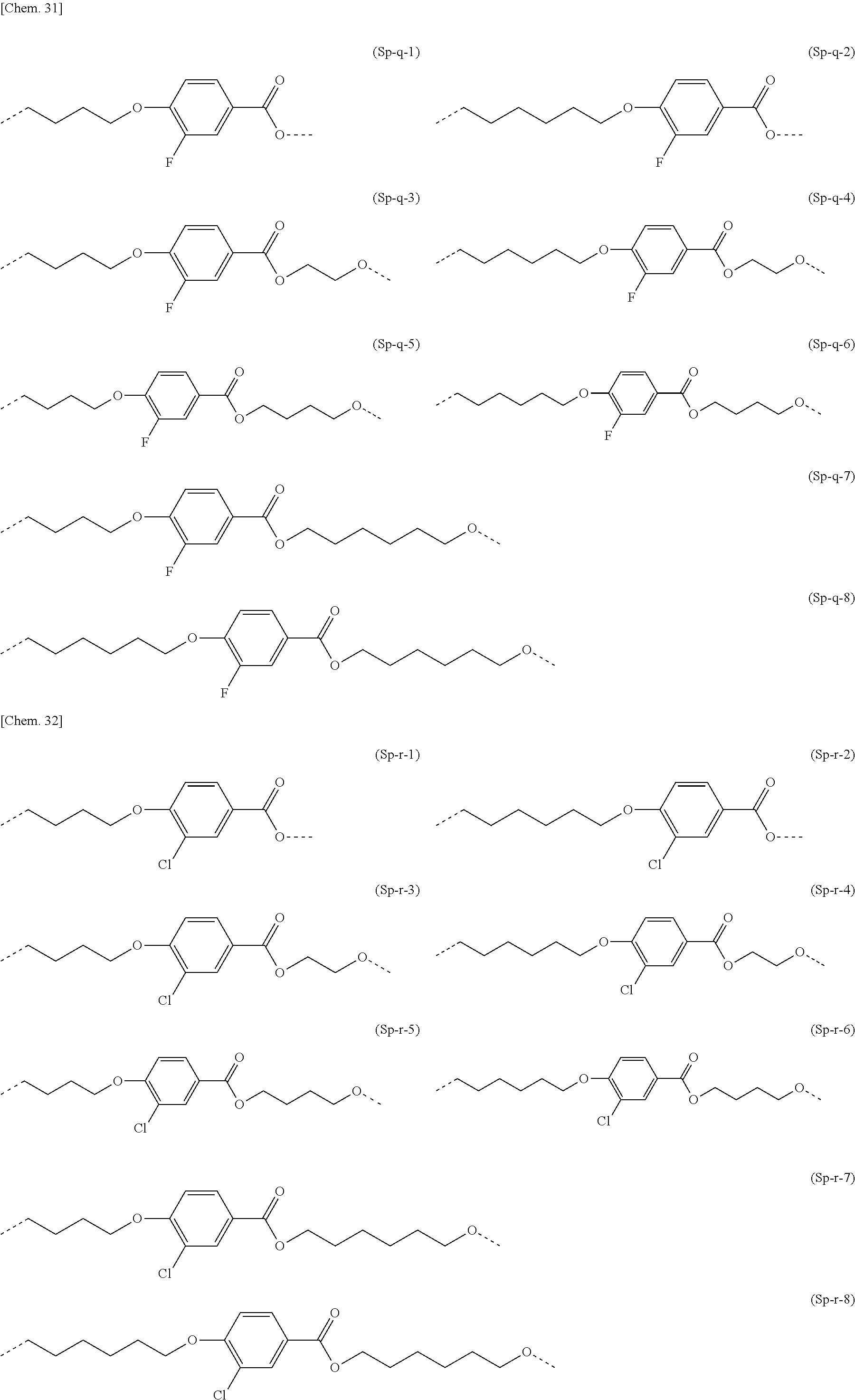

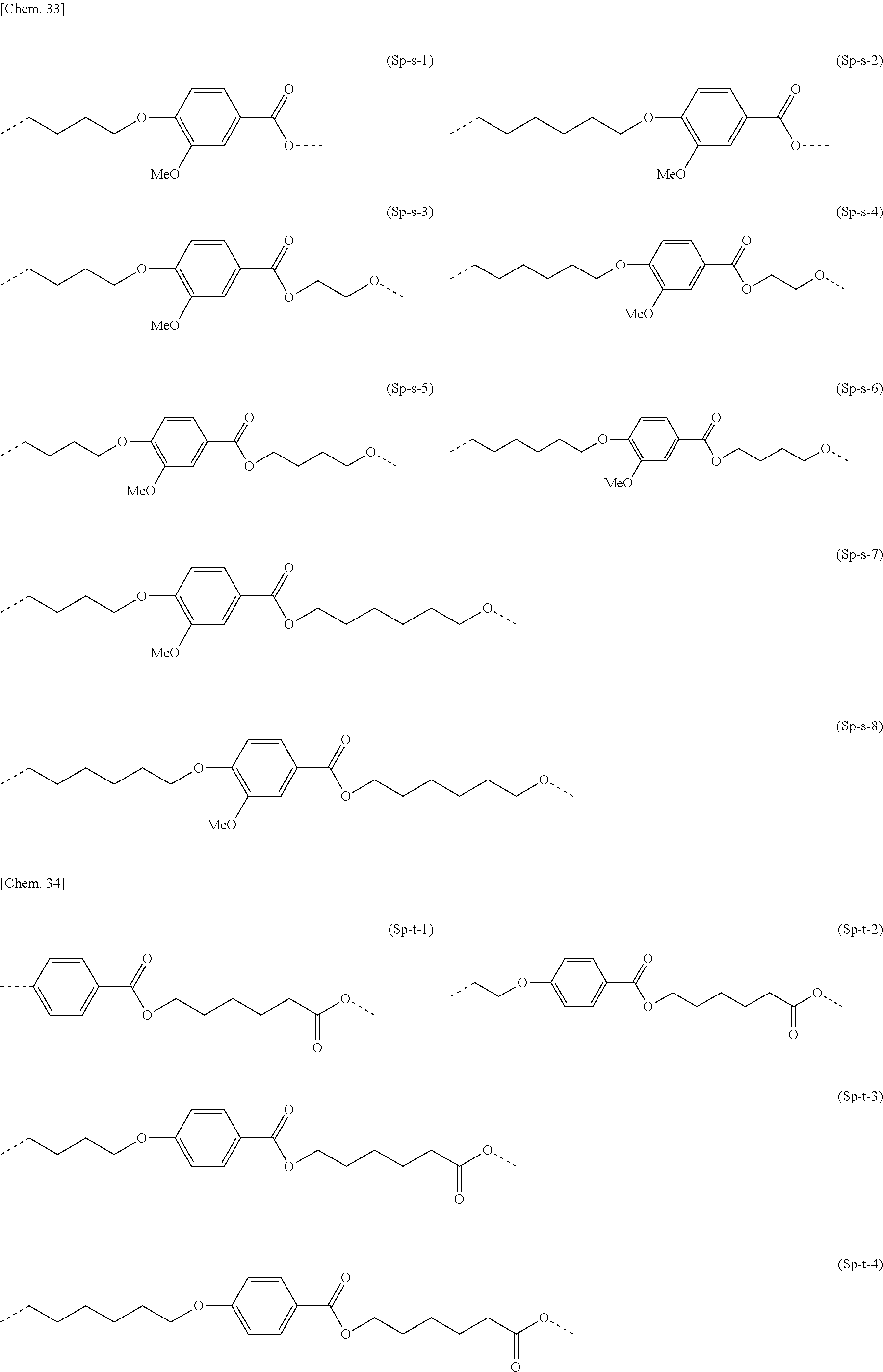

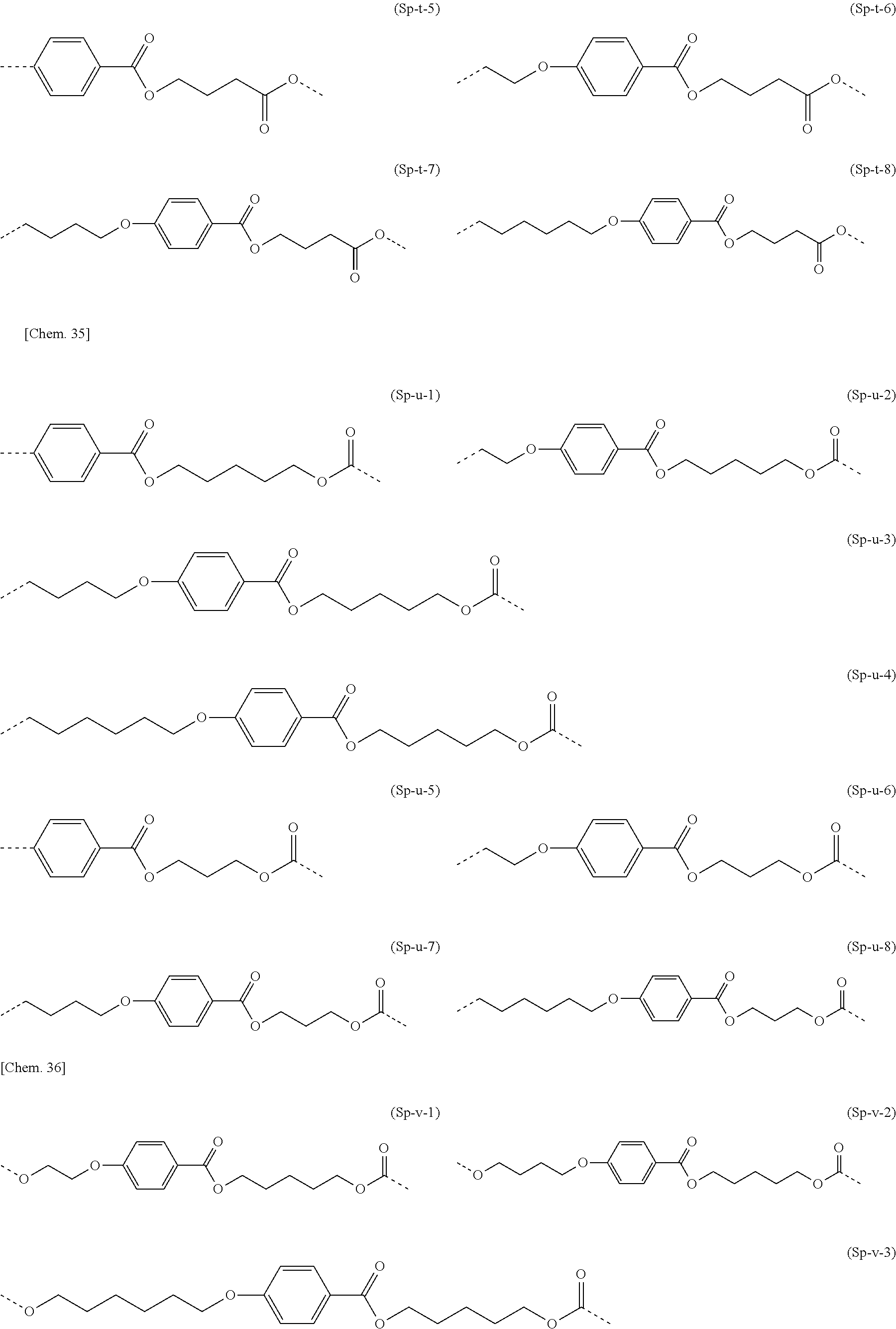

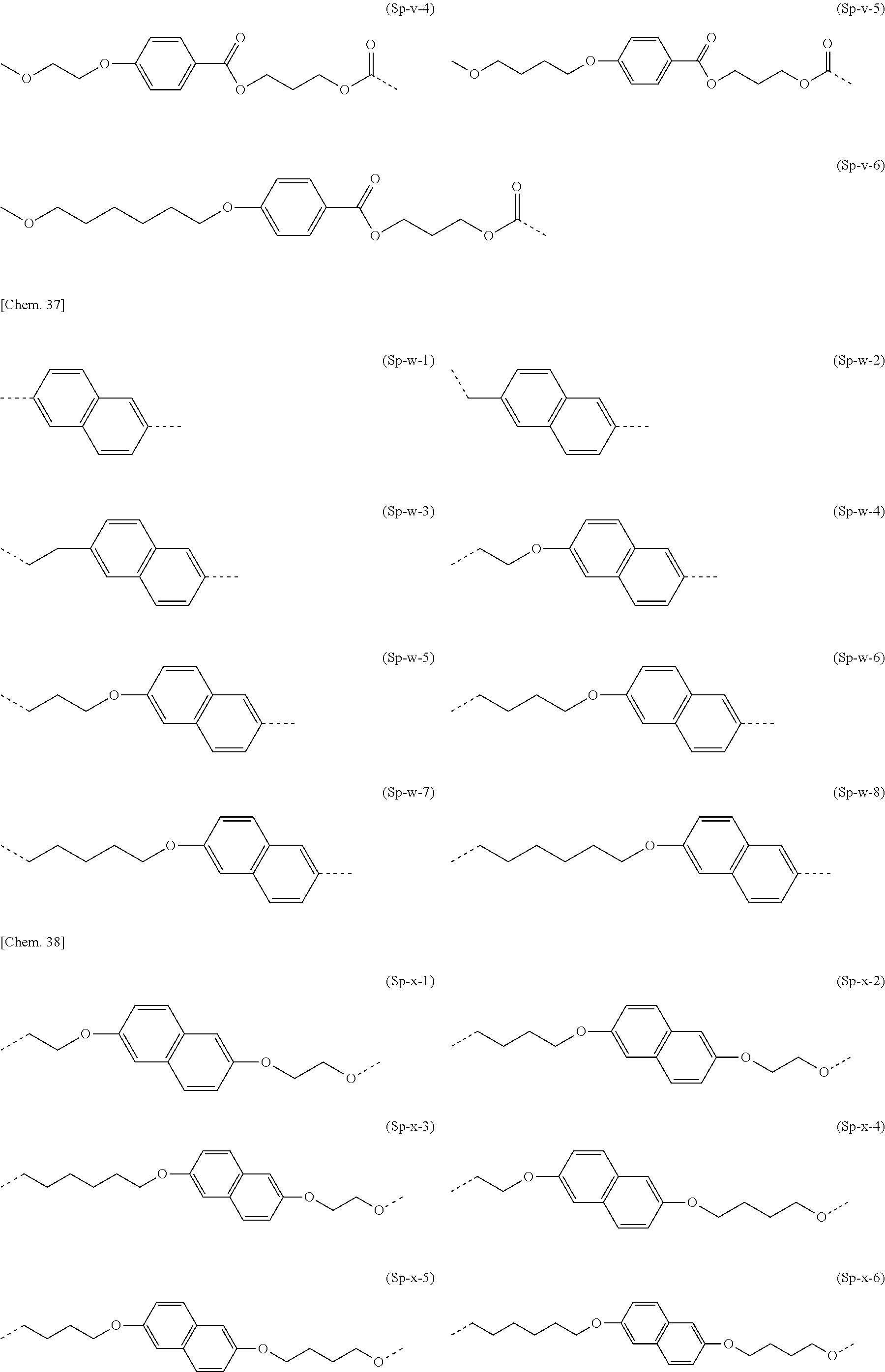

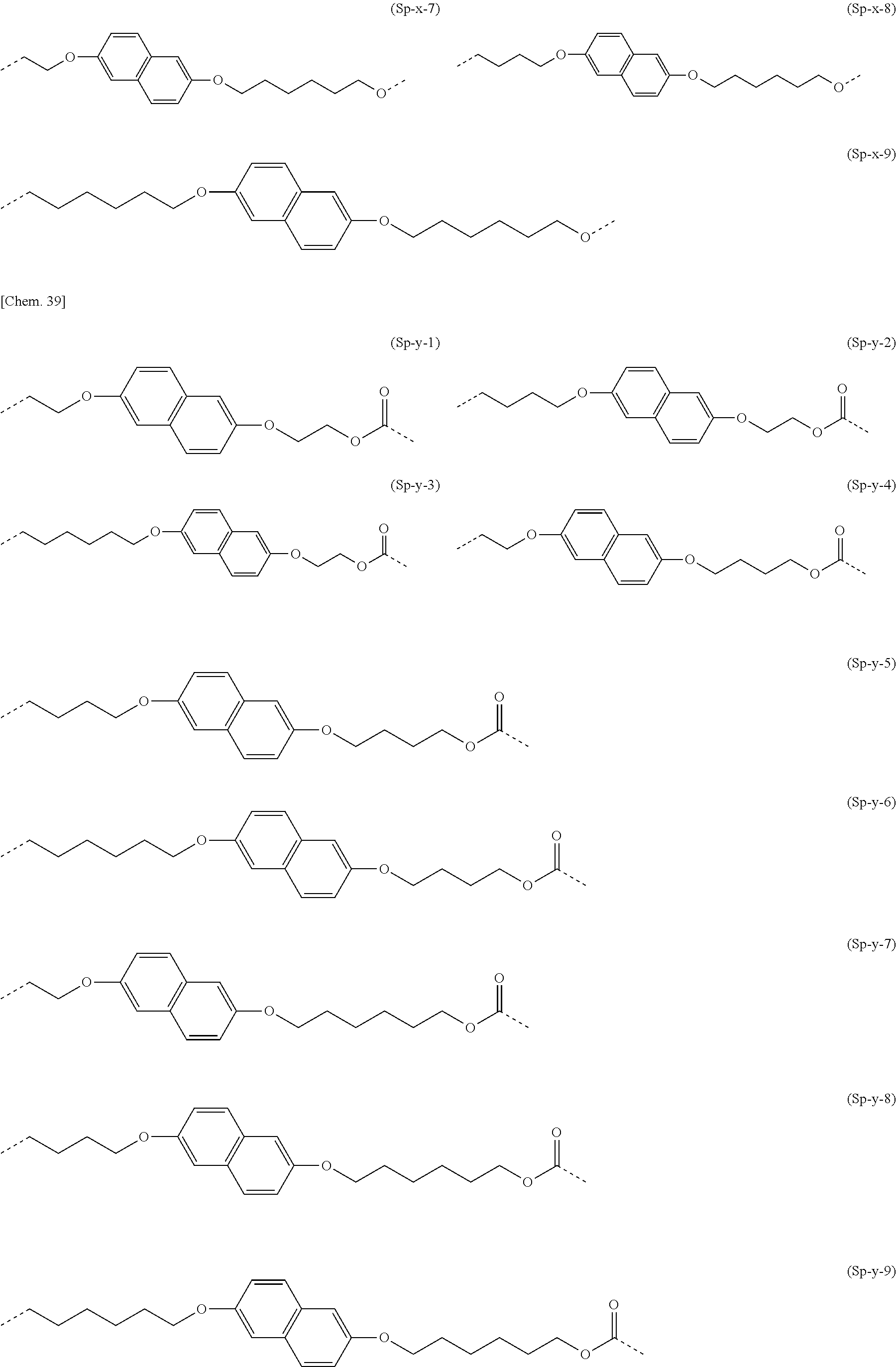

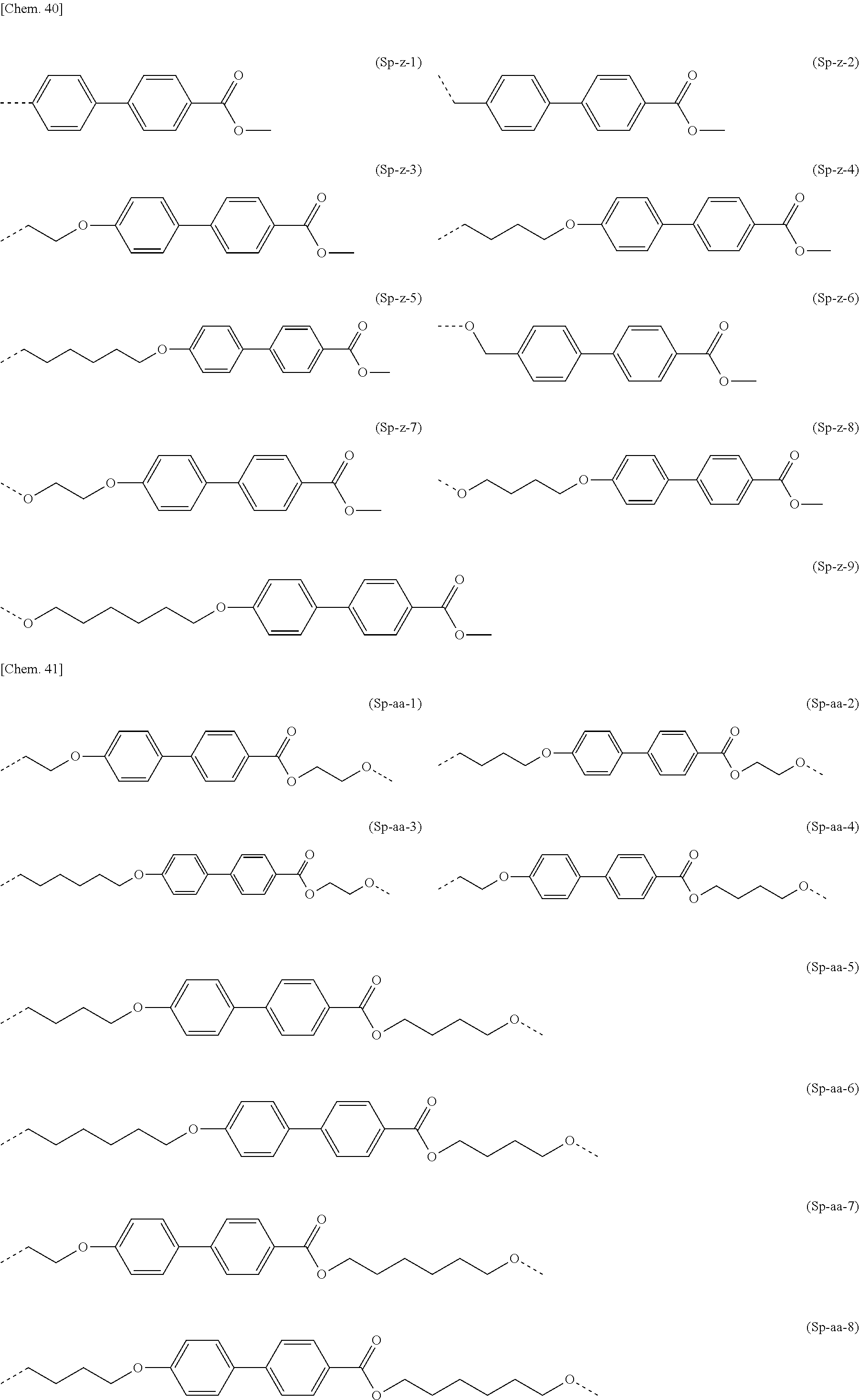

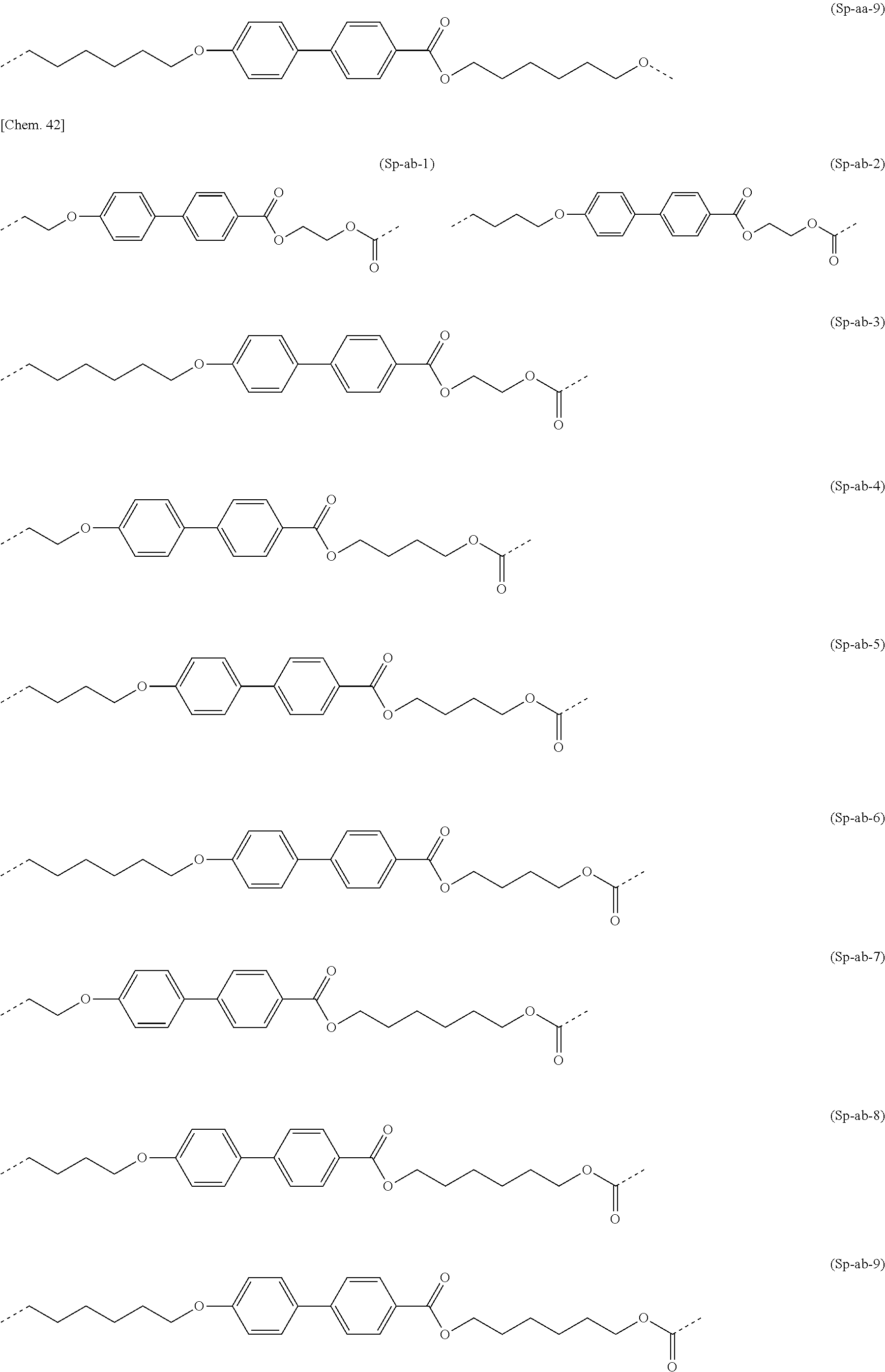

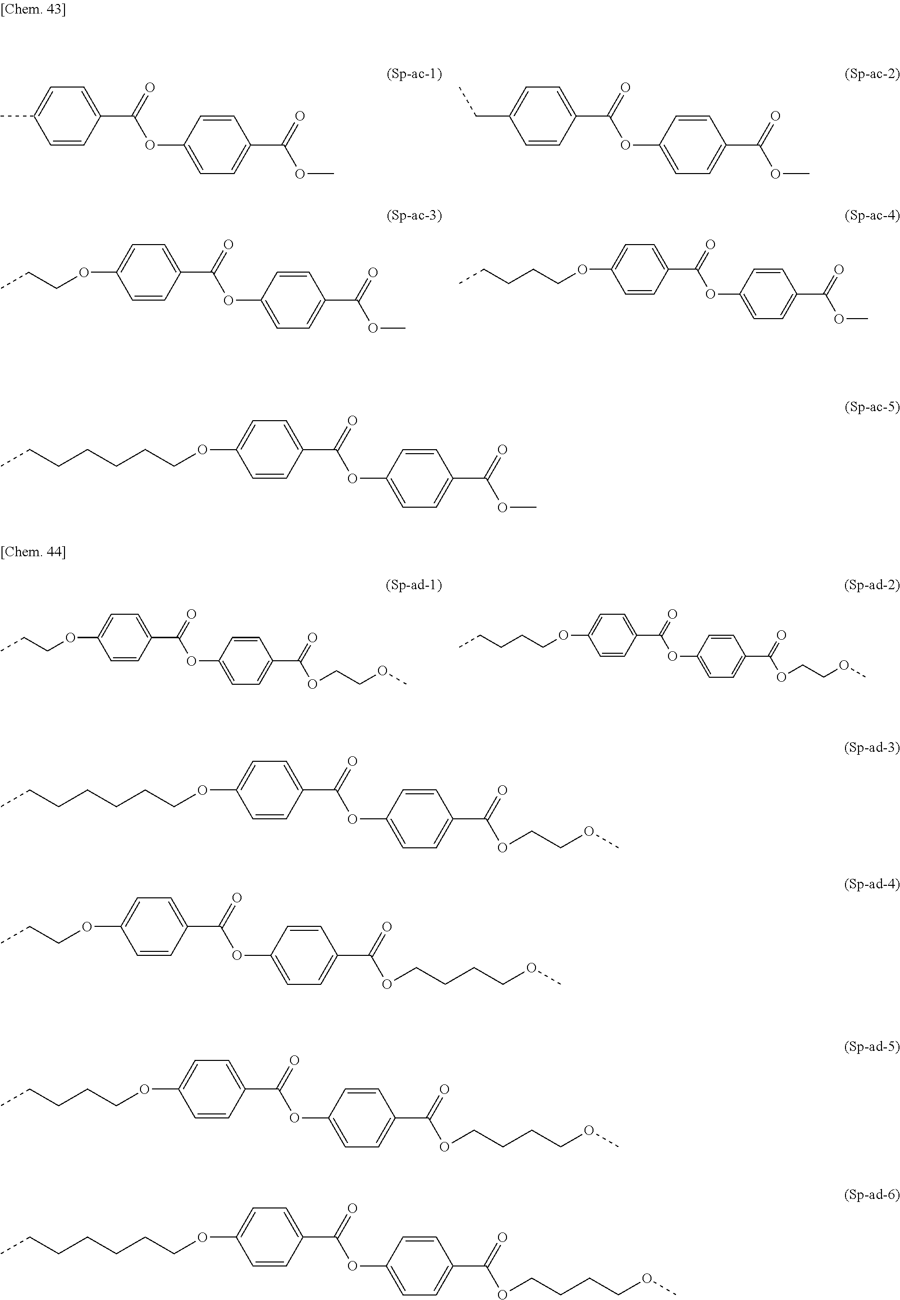

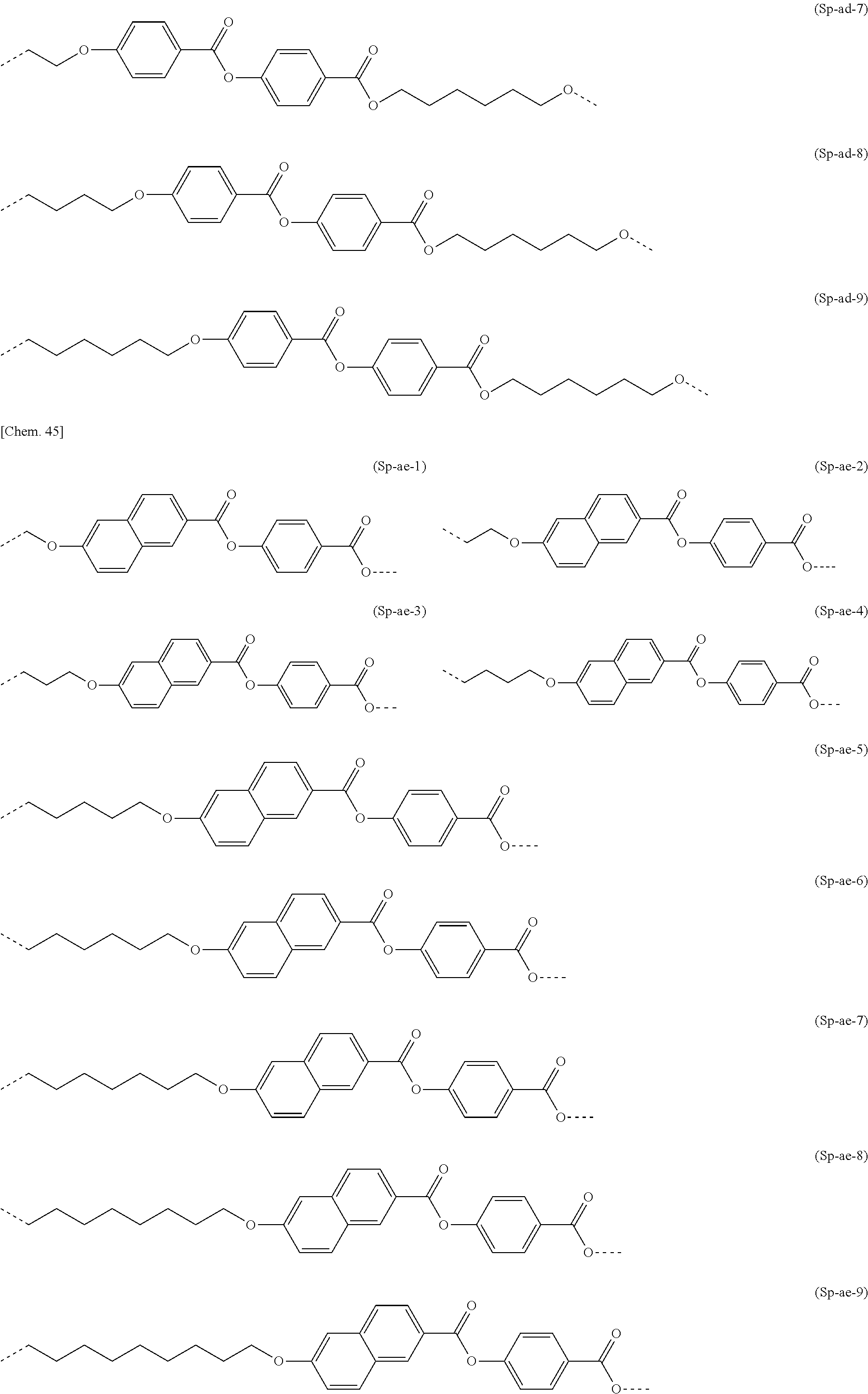

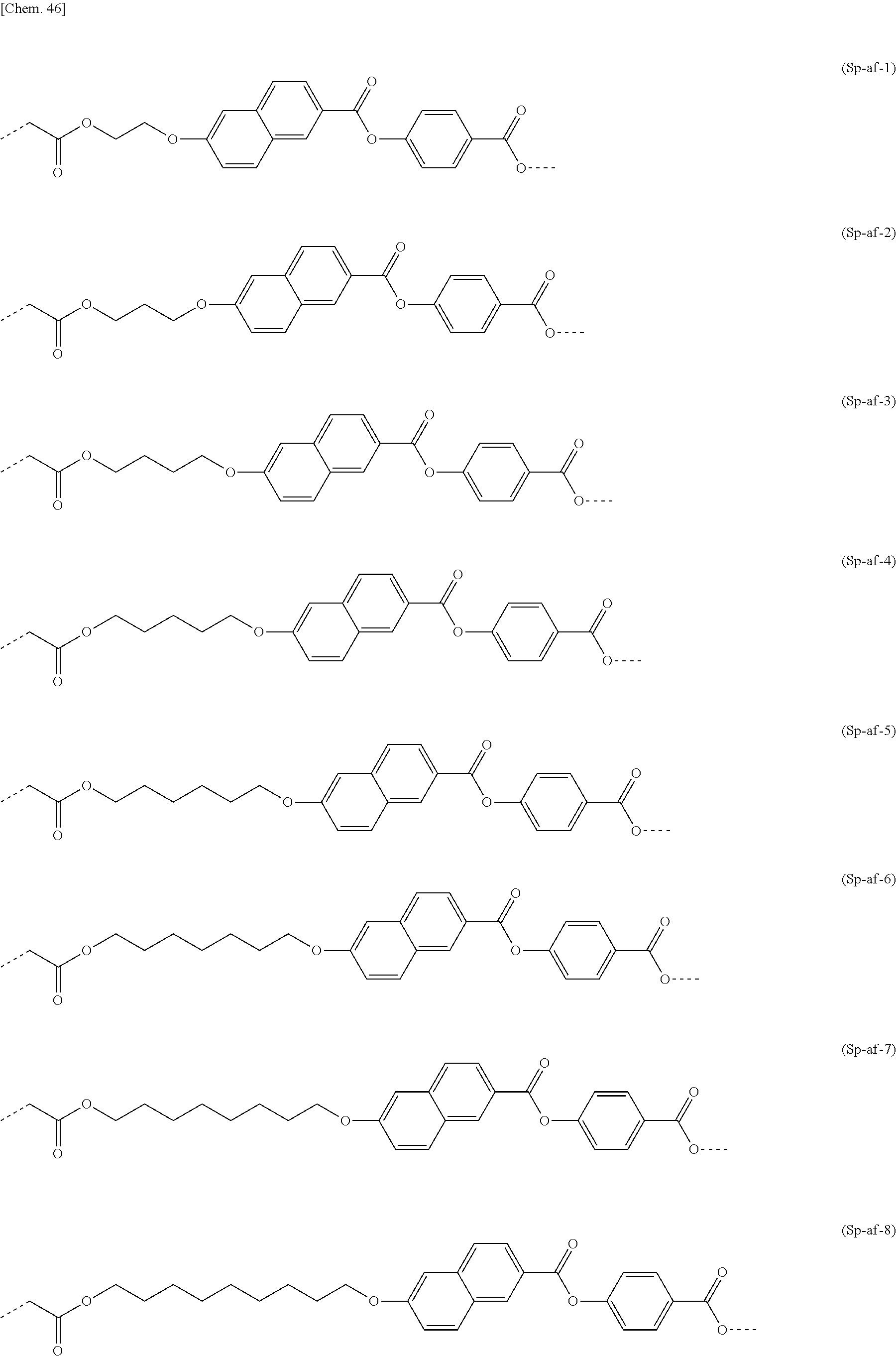

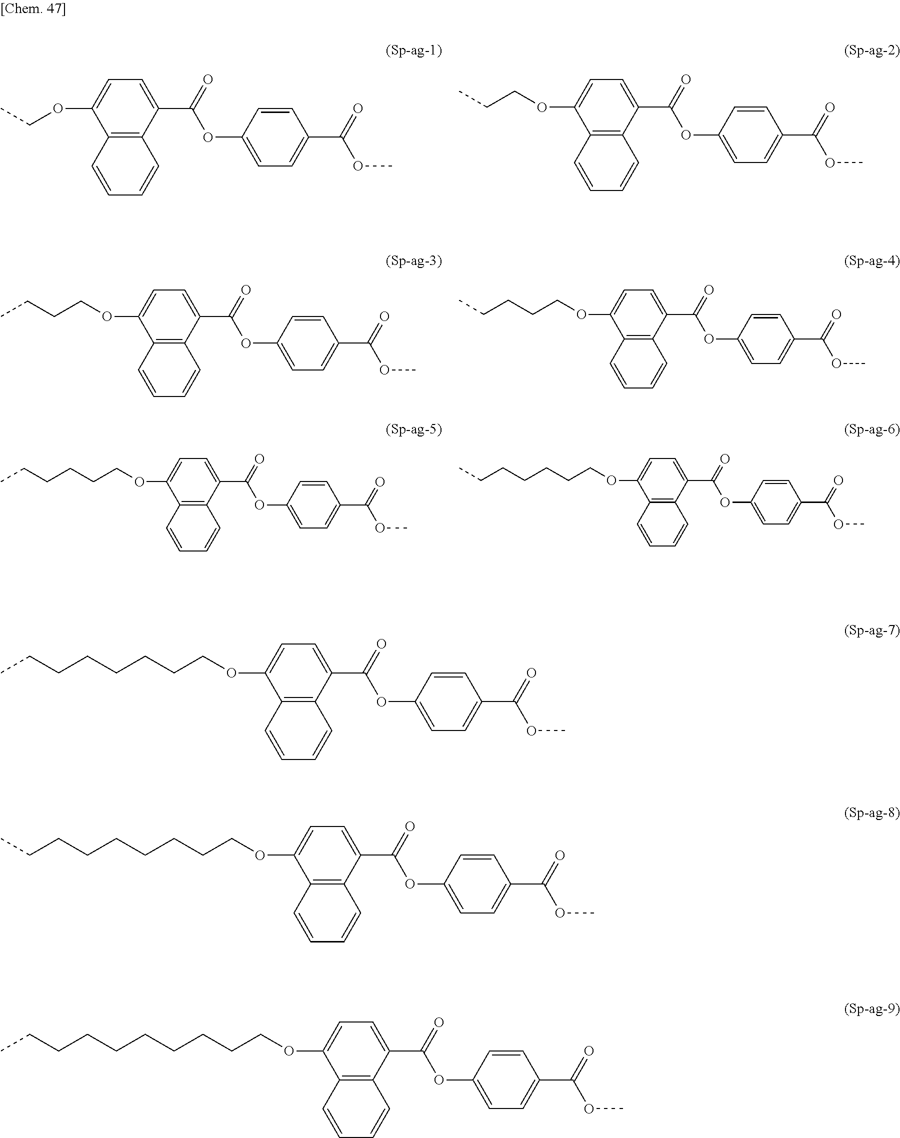

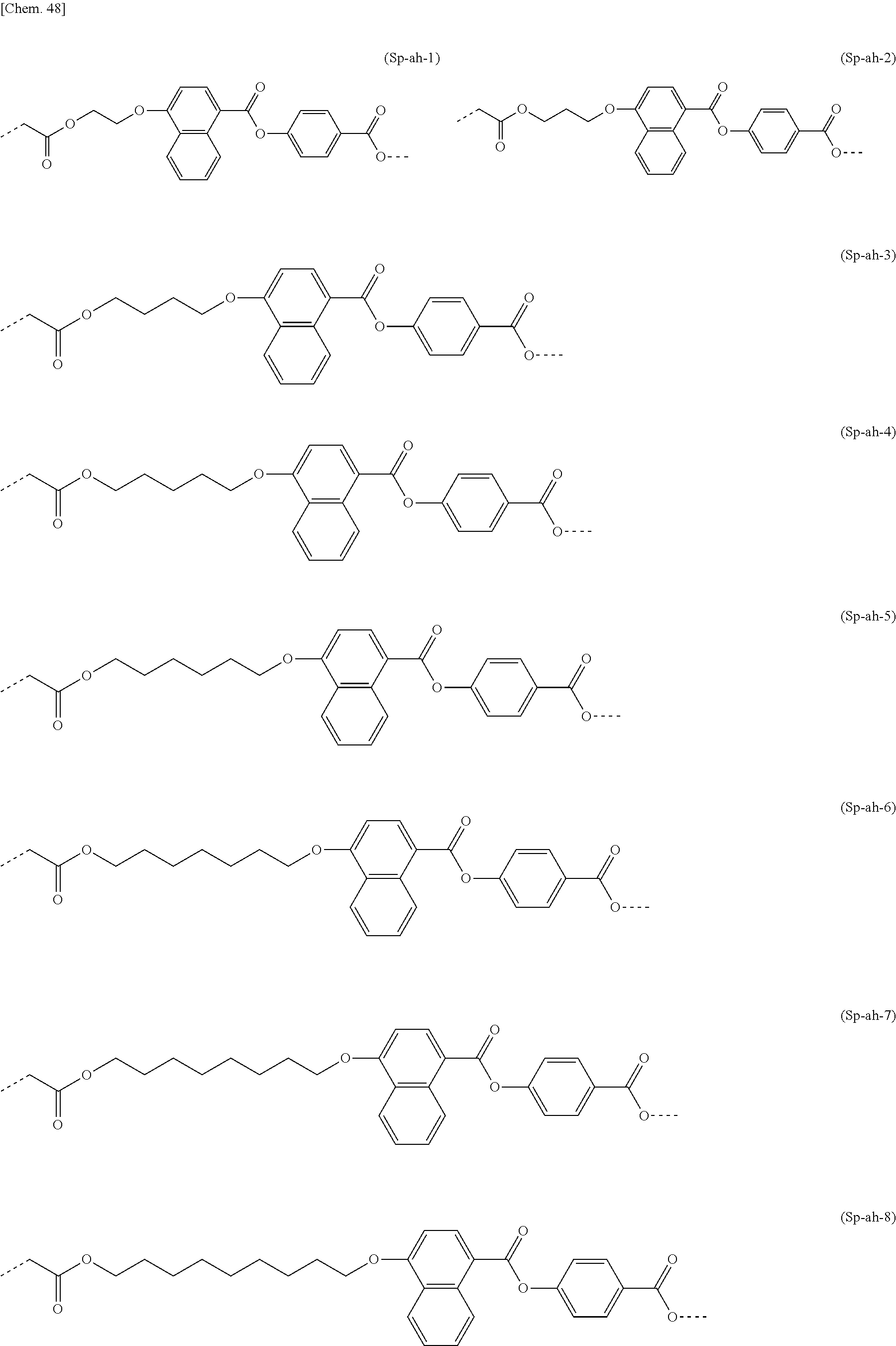

### <Preferable Side Chain Unit Mb>

In General Formula (II), Z²¹ is preferably a linear alkylene group. The carbon numbers of the alkylene group is preferably 2 to 10, and is more preferably 3 to 8.

in order to improve the solubility of the polymer of the present invention, in the alkylene group, it is preferable that one or more non-adjacent —CH₂— groups are independently substituted with —O—, —COO—, or —OCO—.

In General Formula (II), an integer represented by n is preferably 0 to 3, is more preferably 0 to 2, and is still more preferably 0 or 1.

A²¹ in General Formula (II) is preferably a trans-1,4-cyclohexylene group, a 1,4-naphthylene group, a 2,6-naphthylene group, a 2,5-furanylene group, a pyrimidine-2,5-diyl group, and a 1,4-phenylene group. Among them, in order to improve the solubility of the polymer of the present invention, a 1,4-phenylene group is more preferable.

Z²² in General Formula (II) is preferably a single bond, —COO—, —OCO—, —OCH₂—, —CH₂O—, —CF₂O—, —OCF₂—, —CF₂CF₂—, —NR—, —CO—, or —C≡C—. Among them, in order to improve the solubility of the polymer of the present invention, —OCH₂—, —CH₂O—, —CF₂O—, —OCF₂—, —CF₂CF₂—, —NR—, or —CO— is more preferable. In addition, alignment regulating force of the liquid crystal alignment layer of the present invention, a single bond, —COO—, —OCO—, —CF₂O—, or —OCF₂— is more preferable, and a single bond, —COO—, or —OCO— is more preferable.

In General Formula (II), as a combination of —Z²¹-(A²¹-Z²)ₙ—, for example, those represented by Chemical Formula (Sp-a-1) to Chemical Formula (Sp-ah1-8) are preferable.

In these Chemical Formulae, the left dashed line represents a bond to M and the right dashed line represents a bond to a carbon atom to be bonded to A²².

Although it can be selected as required, among these, it is preferable to use those represented by Chemical Formulae (Sp-a-6) to (Sp-a-16), Chemical Formulae (Sp-b-3) to (Sp-b-10), Chemical Formulae (Sp-c-3) to (Sp-c-10), Chemical Formulae (Sp-d-3) to (Sp-d-12), Chemical Formulae (Sp-k-4) to (Sp-k-7), Chemical Formulae (Sp-1-13) to (Sp-1-17), Chemical Formulae (Sp-o-3) to (Sp-o-14), Chemical Formulae (Sp-p-2) to (Sp-p-13), Chemical Formulae (Sp-s-1) to (Sp-s-8), Chemical Formulae (Sp-t-1) to (Sp-t-8), Chemical Formulae (Sp-y-1) to (Sp-y-9), and Chemical Formulae (Sp-aa-1) to (Sp-aa-9).

In General Formula (II), s is preferably 1 or 2, and is more preferably 1.

A²² in General Formula (II) is preferably a trans-1,4-cyclohexylene group, a pyrimidine-2,5-diyl group, and a 1,4-phenylene group, is more preferably a pyrimidine-2,5-diyl group or a 1,4-phenylene group, and is still more preferably a 1,4-phenylene group.

In order to improve the solubility of the polymer of the present invention, it is preferable that one or more hydrogen atoms bonded to the above groups of A²² is substituted with a fluorine atom, a methyl group, or a methoxy group.

X²¹, X²², X²³, X²⁴, and X²⁵ in General Formula (II) are not the hydrogen atoms at the same time. In addition, X²² and X²⁴ preferably have no crosslinkable double bond. Further, when X²¹, X²³, and X²⁵ are the hydrogen atoms at the same time, at least one of X²² and X²⁴ is preferably not to be a hydrogen atom. From the viewpoint of enhancing the alignment regulating force of the liquid crystal alignment layer of the present invention, at least one of X²² and X²⁴ is preferably a fluorine atom, a chlorine atom, a hydroxy group, a nitro group, a cyano group, or a group represented by General Formula (IIa).

In General Formula (IIa), A²³ is preferably a single bond or a linear alkylene group, and is more preferably a single bond. The carbon numbers of the alkylene group is preferably 1 to 20, and is more preferably 1 to 8.

In General Formula (IIa), q is preferably 0.

In General Formula (IIa), Z²³ is preferably a single bond or a linear alkylene group. The carbon numbers of the alkylene group is preferably 1 to 20, and is more preferably 1 to 8.

It is preferably that one or more non-adjacent —CH₂— groups in the alkylene group may be independently substituted with —O—, —COO—, —OCO—, —CH═CH—, —CF═CF—, —CF₂O—, —OCF₂—, —CF₂CF₂—, —C≡C— or —CO—.

In General Formula (IIa), A²⁴ is preferably a trans-1,4-cyclohexylene group, a pyrimidine-2,5-diyl group, and a 1,4-phenylene group, is more preferably a pyrimidine-2,5-diyl group or a 1,4-phenylene group, and is still more preferably a 1,4-phenylene group.

As R² in General Formula (IIa), a linear or branched alkyl group having 1 to 20 carbon atoms is preferable, a linear or branched alkyl group having 3 to 8 carbon atoms is more preferable, a branched linear alkyl group having 3 to 8 carbon atoms is still more preferable, and an isopropyl group, a tertiary butyl group, or a normal butyl group is particularly preferable.

### <Side Chain Unit Mc>

The polymer of the present invention preferable contains one or more kinds of side chain units Mc represented by General Formula (QX). When the side chain unit Mc is contained, a pretilt angle of the liquid crystal alignment layer of the present invention can be easily controlled to be high.

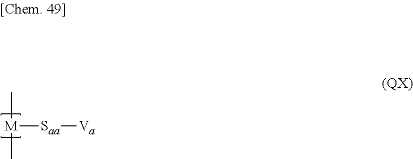

(In the formula, M represents a polymer main chain, the polymer main chain has a repeating unit represented by at least one of General Formulae (U-11) and (U-12), and the dashed lines in General Formulae (U-11) and (U-12) bonded to Sₐₐ in General Formula (QX), Sₐₐ represents a single bond or an alkylene group having 1 to 20 carbon atoms, Vₐ represents a monovalent organic group, one —CH₂— group or two or more non-adjacent —CH₂— groups of the alkylene group are may be independently substituted with one or more substituents selected from —O—, —CO—, —CO—O—, —O—CO—, —Si(CH₃)₂—O—Si(CH₃)₂—, —NR—, —NR—CO—, —CO—NR—, —NR—CO—O—, —O—CO—NR—, —NR—CO—NR— (in the formulae, R independently represents a hydrogen atom or an alkyl group having 1 to 5 carbon atoms), —CH═CH—, —C≡C—, and —O—CO—O—, and one or more hydrogen atoms bonded to the group represented by General Formula (QX) may be substituted with a fluorine atom, a chlorine atom, a cyano group, a hydroxyl group, a carboxyl group, an amide group, a fluorine, a sulfide group, and a nitro group.)

Vₐ in General Formula (QX) is preferably a group represented by General Formula (VII).

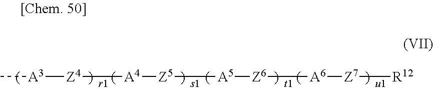

In the formula, the dashed line represents a bond to Sₐₐ; Z⁴, Z⁵, Z⁶ and Z⁷ each independently represent a single bond, —(CH₂)ᵤ— (in the formula, u represents 1 to 20), —OCH₂—, —CH₂O—, —COO—, —OCO—, —CH═CH—, —CF═CF—, —CF₂O—, —OCF₂—, —CF₂CF₂—, or —C≡C—, and one or more non-adjacent —CH₂— groups in these substituents each may be independently substituted with —O—, —CO—, —CO—O—, —O—CO—, —Si(CH₃)₂—O—Si(CH₃)₂—, —NR—, —NR—CO—, —CO—NR—, —NR—CO—O—, —O—CO—NR—, —NR—CO—NR—, —CH═CH—, —C≡C—, or —O—CO—O— (in the formulae, R independently represents a hydrogen atom or an alkyl group having 1 to 5 carbon atoms), A³, A⁴, A⁵, and A⁶ each independently represent (a) a trans-1,4-cyclohexylene group (one methylene group present or two or more non-adjacent methylene groups in the group each may be independently substituted with —O—, —NH—, or —S—), (b) a 1,4-phenylene group (one or two or more —CH═'s present in this group may be substituted with —N═), and (c) a group selected from the group consisting of a 1,4-cyclohexenylene group, a 2,5-thiophenylene group, a 2,5-furanylene group, a 1,4-bicyclo[2.2.2]octylene group, a naphthalene-1,4-diyl group, a naphthalene-2,6-diyl group, a decahydronaphthalene-2,6-diyl group, and a 1,2,3,4-tetrahydronaphthalene-2,6-diyl group, and the group (a), group (b), or group (c) each may be unsubstituted or one or more hydrogen atoms thereof may be substituted with a fluorine atom, a chlorine atom, a cyano group, a methyl group, or a methoxy group, r1, s1, t1 and u1 each independently represent 0 or 1, R¹² is a hydrogen atom, a fluorine atom, a chlorine atom, a cyano group, or an alkyl group having 1 to 20 carbon atoms, or Formulae (CHOL-a) to (CHOL-d).

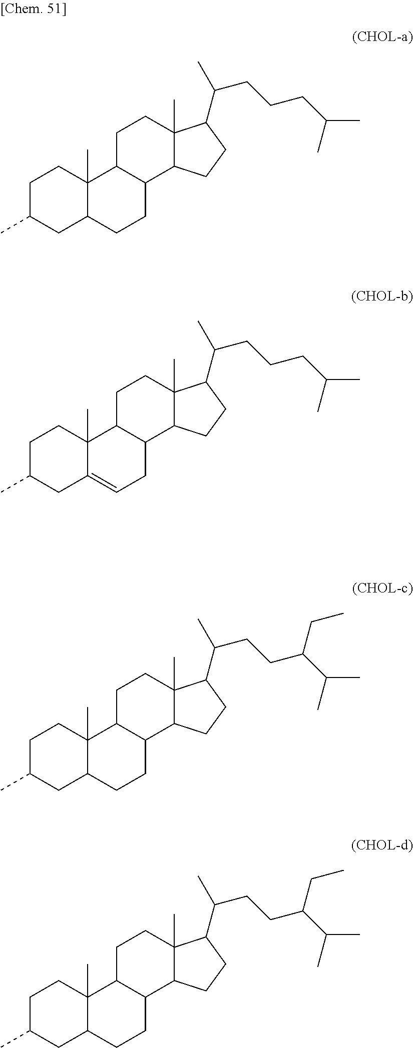

The hydrogen atoms in the alkyl group may be substituted with a fluorine atom, and one —CH₂— group or two or more non-adjacent —CH₂— groups may be substituted with one or more selected from —O—, —CO—O—, —O—CO—, and —CH═CH—.

Z⁴, Z⁵, Z⁶, and Z⁷ each may independently represent a single bond, —(CH₂)ᵤ— (in the formula, u represents 1 to 12, one or more non-adjacent —CH₂— groups may be independently substituted with —O—, —CO—, —CO—O—, —O—CO—, —NR—CO—, —CO—NR—, —NR—CO—NR—, —CH═CH—, —C≡C—, or —O—CO—O—, and R independently represents a hydrogen atom, a methyl group, or an ethyl group), —OCH₂—, —CH₂O—, —COO—, —OCO—, —CH═CH—, —CF₂O—, —OCF₂—, or —C≡C—.

It is preferable that A³, A⁴, A⁵, and A⁶ each are independently a trans-1,4-cyclohexylene group, a 2,6-naphthylene group, a pyridine-2,5-diyl group, a pyrimidine-2,5-diyl group, or a 1,4-phenylene group, these are unsubstituted, or one or more hydrogen atoms thereof are substituted with a fluorine atom, a chlorine atom, a methyl group, or a methoxy group.

Regarding r1, s1, t1, and u1, r1+s1+t1+u1 is preferably an integer of 0 to 3, R¹² is preferably a hydrogen atom, a fluorine atom, a chlorine atom, a cyano group, or an alkyl group having 1 to 18 carbon atoms (one —CH₂— group or two or more non-adjacent —CH₂— groups in the alkyl group may be substituted with —O—, —CO—O—, —O—CO—, and/or —CH═CH—).

In order to improve the solubility of the polymer of the present invention, it is preferable that Z⁴, Z⁵, Z⁶, and Z⁷ are each independently —OCH₂—, —CH₂O—, —CF₂O—, —OCF₂—, —CF₂CF₂—, —NR—, or —CO—. It is preferable that A³, A⁴, A⁵, and A⁶ are each independently a trans-1,4-cyclohexylene group, a 1,4-naphthylene group, a 2,6-naphthylene group, or a 2,5-furanylene group.

In order to improve the liquid crystal alignment property of the liquid crystal alignment layer of the present invention, it is preferable that Z⁴, Z⁵, Z⁶, and Z⁷ each independently represent a single bond, —(CH₂)ᵤ— (in the formula, u represents 1 to 8, one or two non-adjacent —CH₂— groups independently may be substituted with —O—, —CO—O—, —O—CO—, —Si(CH₃)₂—O—Si(CH₃)₂—, —CH═CH—, —C≡C—), —COO—, —OCO—, —CH═CH—, —CF═CF—, or —C≡C—. It is preferable that A³, A⁴, A⁵, and A⁶ each independently a trans-1,4-cyclohexylene group, a trans-1,3-dioxane-2,5-diyl group, a pyridine-2,5-diyl group, a pyrimidine-2,5-diyl group, a 2,5-thiophenylene group, or a 1,4-phenylene group.

In order to improve the thermal stability of alignment of the liquid crystal alignment layer of the present invention, it is preferable that Z⁴, Z⁵, Z⁶ and Z⁷ each are independently —NR—CO—, —CO—NR—, —NR—CO—O—, —O—CO—NR—, —NR—CO—NR—, or —O—CO—O—. It is preferable that A³, A⁴, A⁵, and A⁶ are each independently a 1,4-naphthylene group, a 2,6-naphthylene group, a pyridine-2,5-diyl group, a pyrimidine-2,5-diyl group, a 2,5-thiophenylene group, a 2,5-furanylene group, or a 1,4-phenylene group.

In order to apply the pretilt angle of 80 degrees or more to the liquid crystal alignment layer of the present invention, it is preferable that Z⁴, Z⁵, Z⁶, and Z⁷ each independently represent a single bond, —OCH₂—, —CH₂O—, —COO—, —OCO—, and —C≡C—. It is preferable that A³, A⁴, A⁵, and A⁶ are each independently a trans-1,4-cyclohexylene group, a trans-1,3-dioxane-2,5-diyl group, or a 1,4-phenylene group, and R¹² is an alkyl group having 1 to 10 carbon atoms, an alkoxy group, a fluorine atom, a trifluoromethyl group, or a trifluoromethoxy group.

General Formula (VII) includes a number of compounds, and specifically, the compounds represented by Formulae (VII-a-1) to Formula (VII-q-10) are particularly preferable. In Chemical Formulae, the dashed lines represent a bond to Sₐₐ.

Among them, compounds represented by Formulae (VII-a-1) to (VII-a-15), Formulae (VII-b-11) to (VII-b-15), Formulae (VII-c-1) to (VII-c-11), Formulae (VII-d-10) to (VII-d-15), Formulae (VII-f-1) to (VII-f-10), Formulae (VII-g-1) to (VII-g-10), Formulae (VII-h-1) to (VII-h-10), Formulae (VII-j-1) to (VII-j-9), Formulae (VII-l-1) to (VII-l-11) or Formulae (VII-m-1) to (VII-m-11) are more preferable.

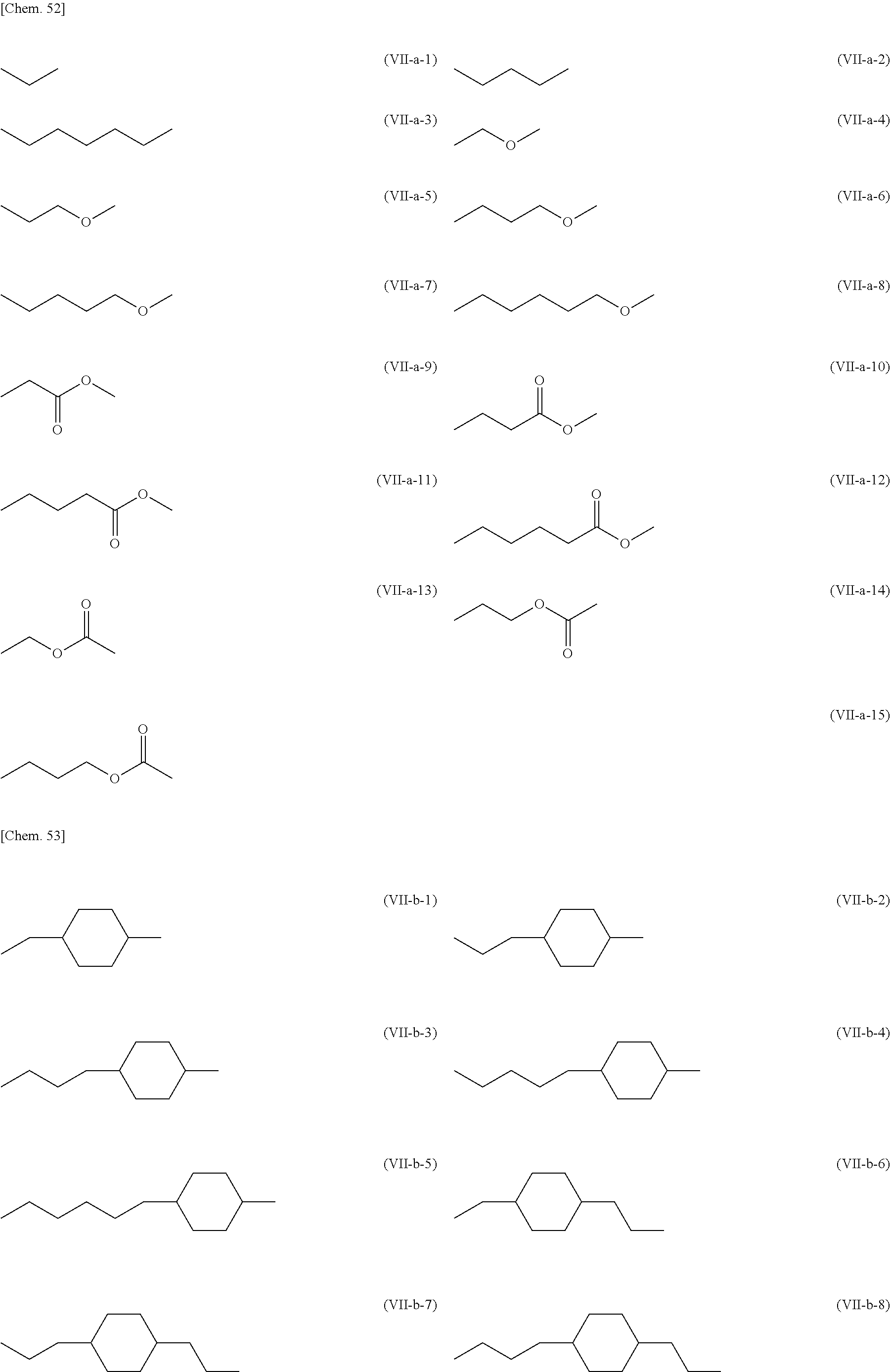

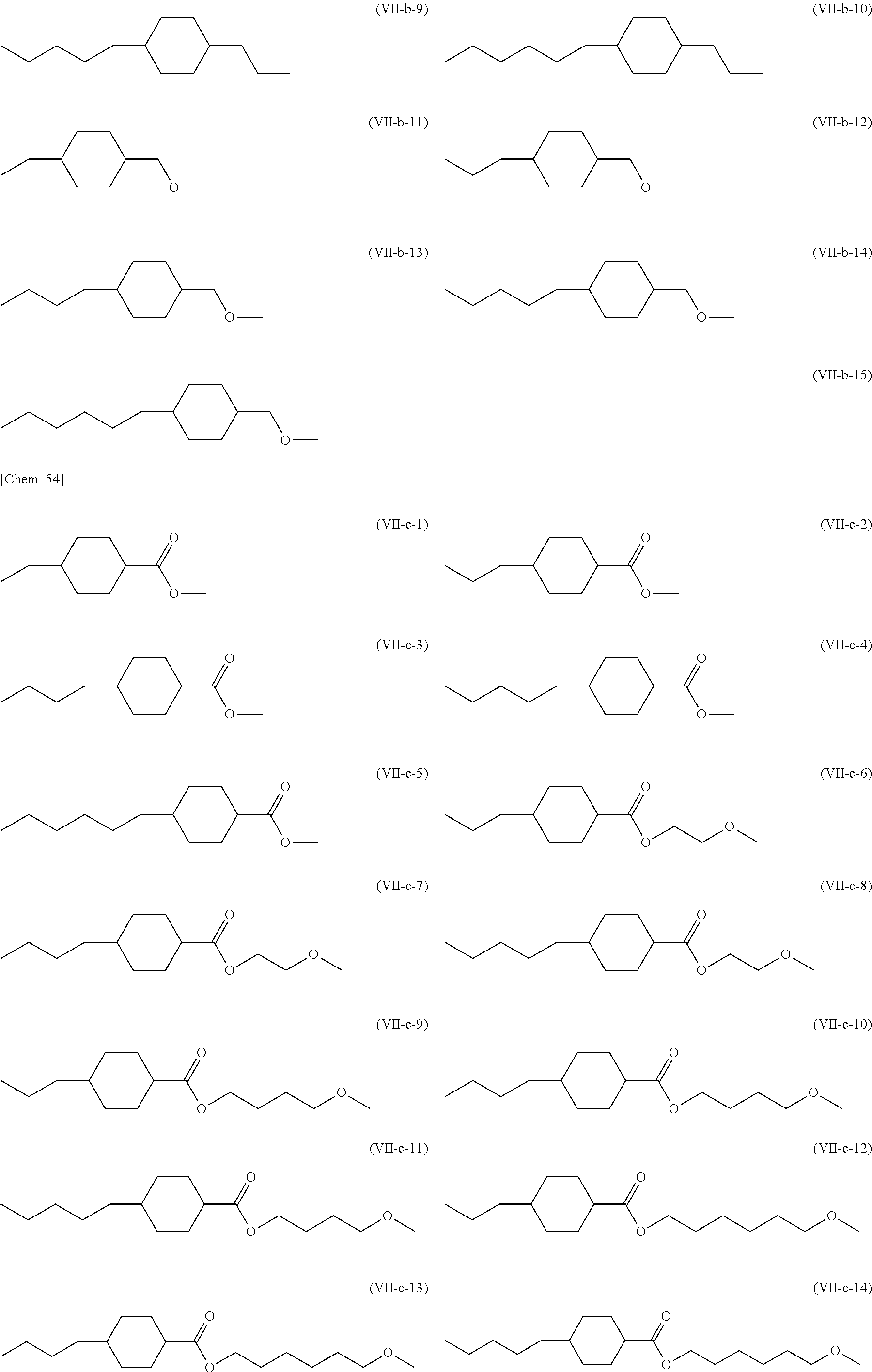

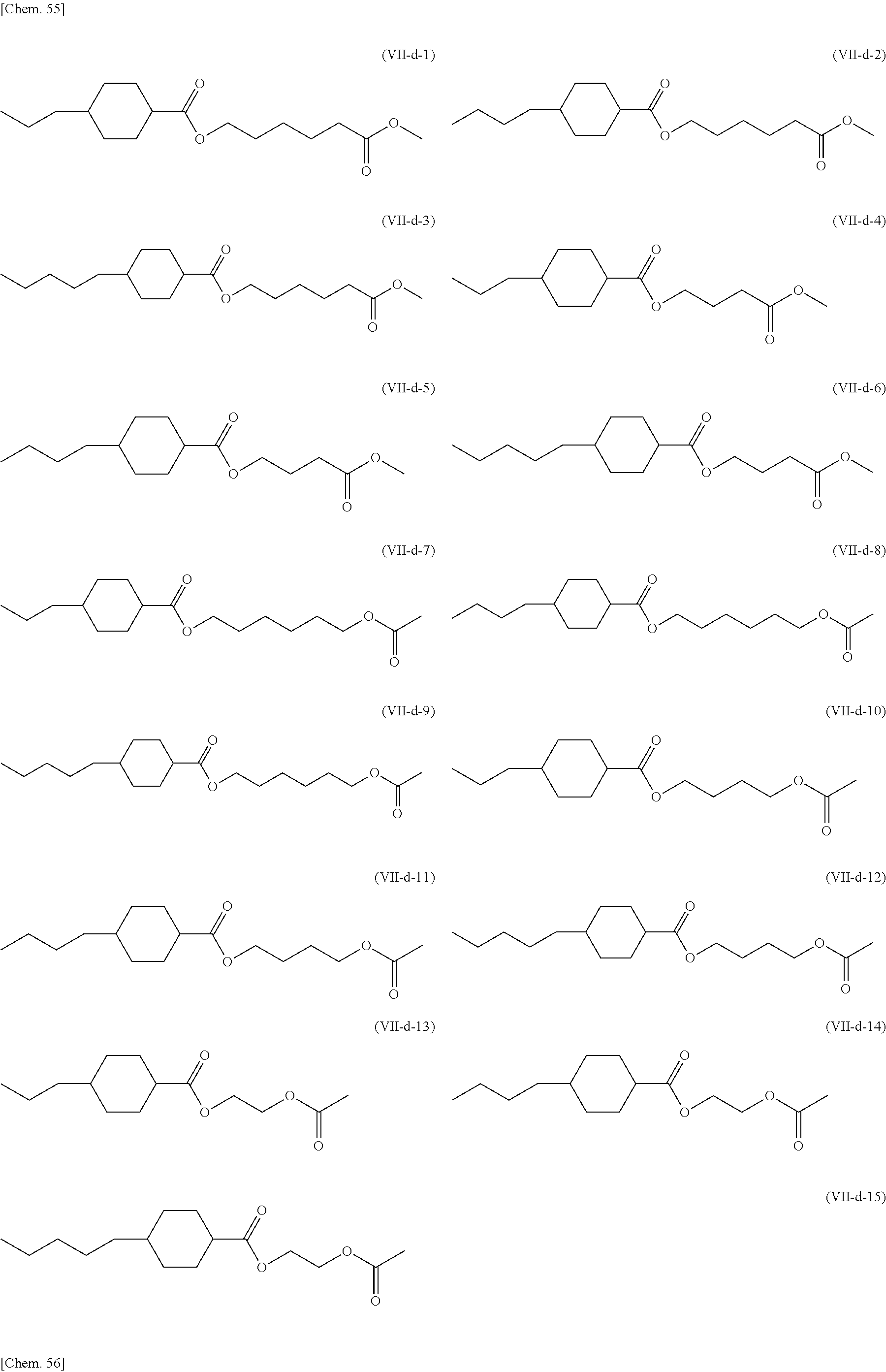

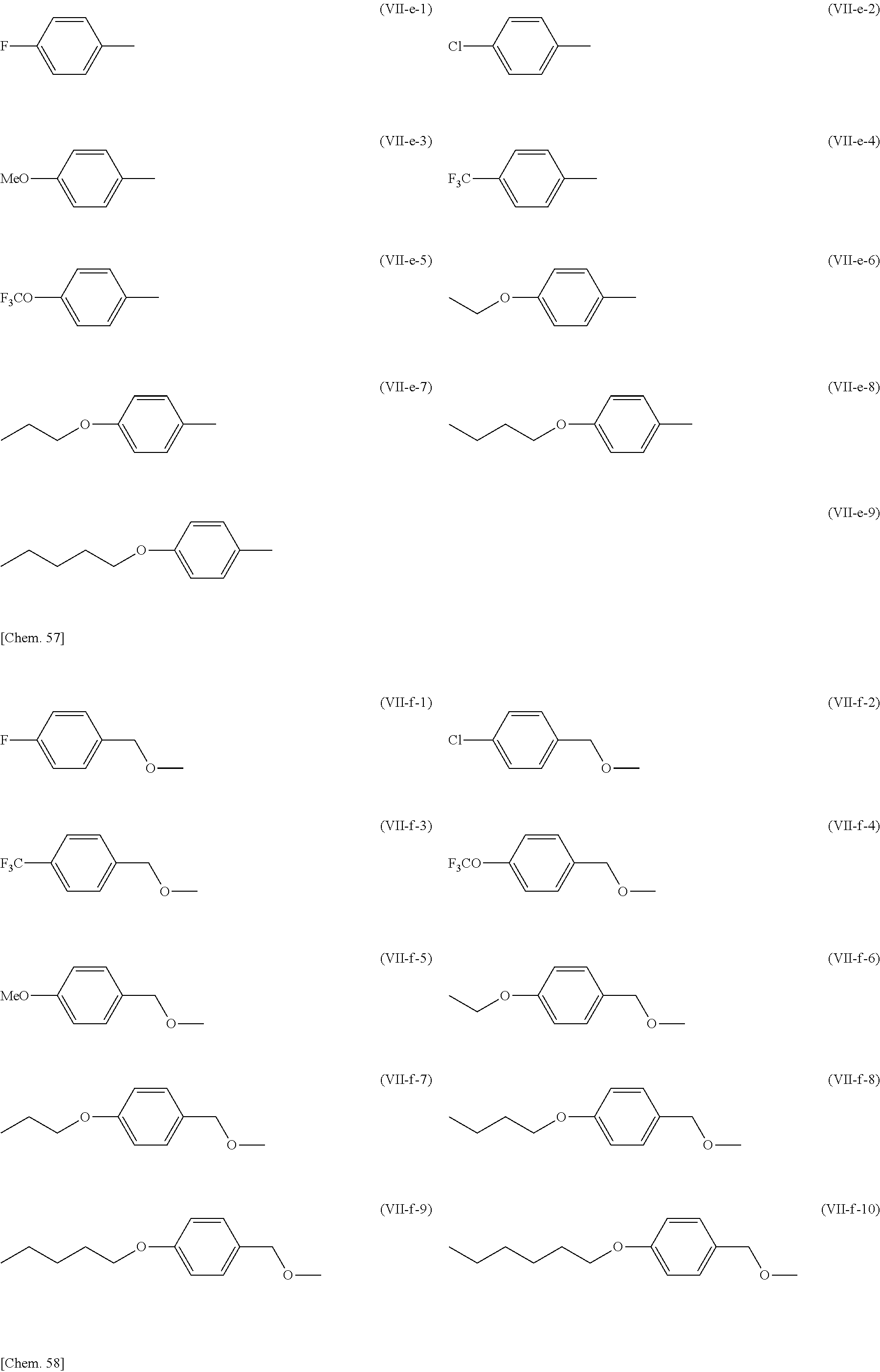

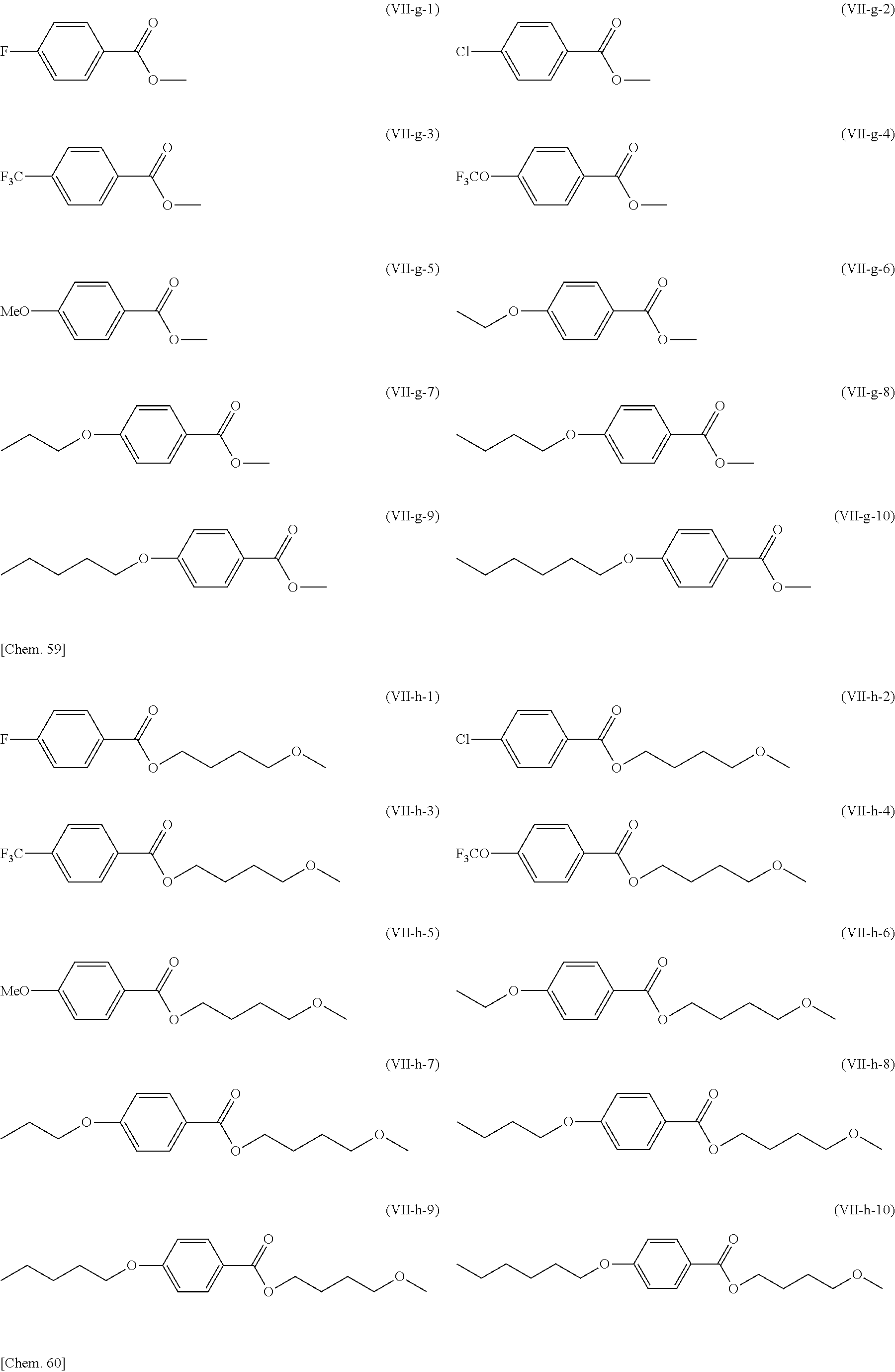

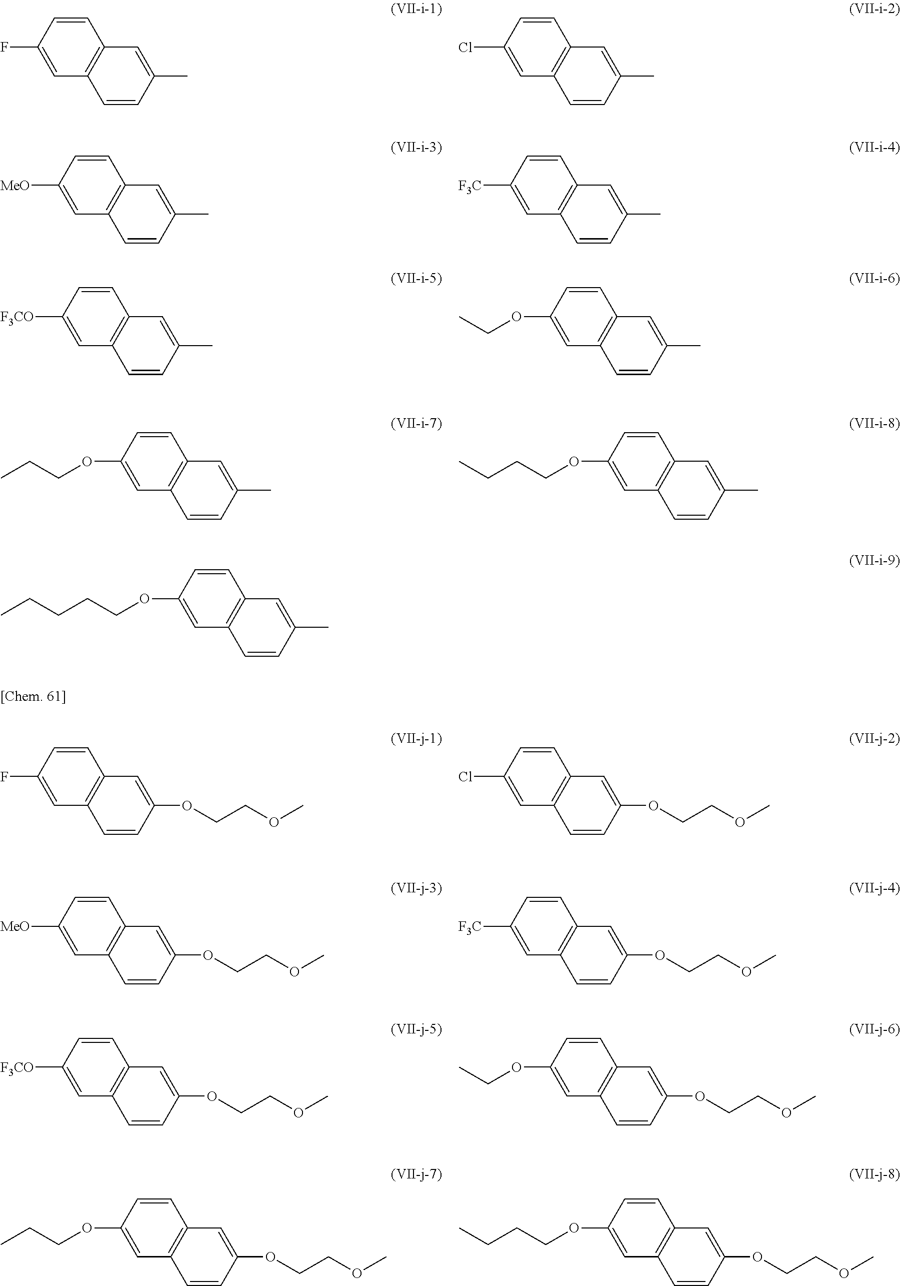

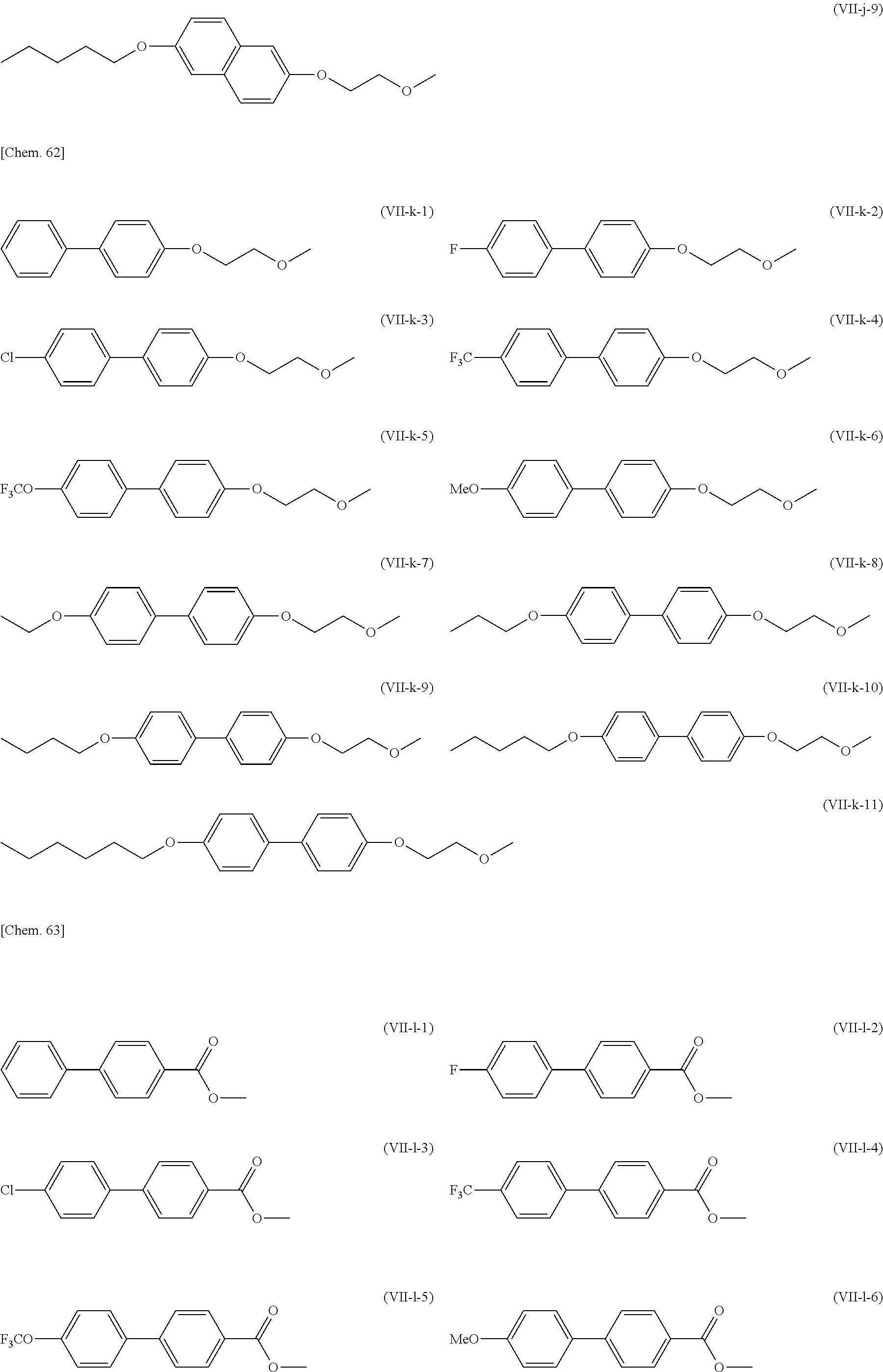

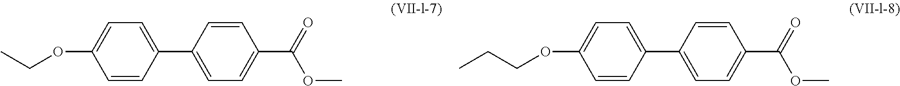 [SMILES: CCOc1ccc(-c2ccc(C(=O)OC)cc2)cc1 ; CCCOc1ccc(-c2ccc(C(=O)OC)cc2)cc1]

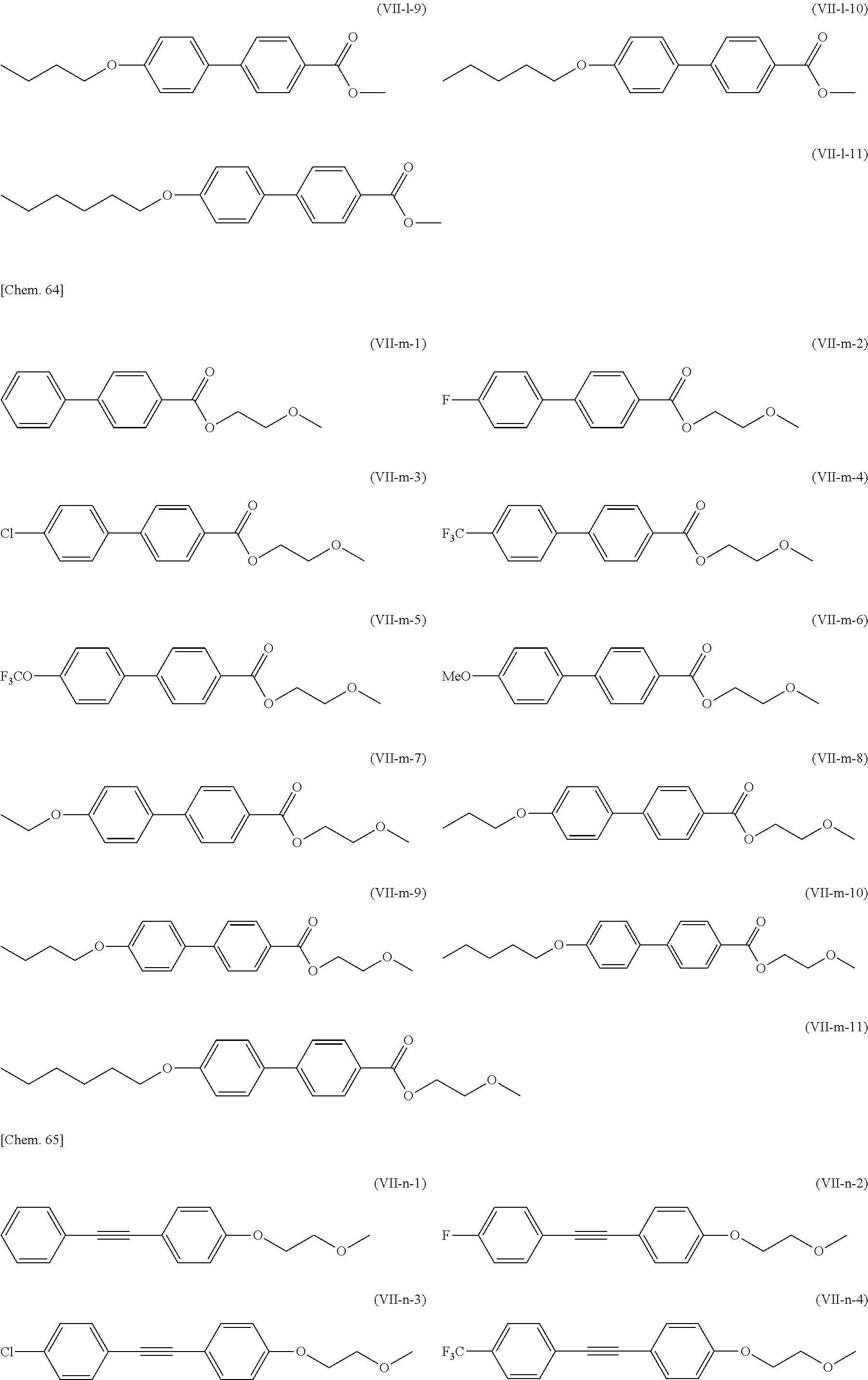

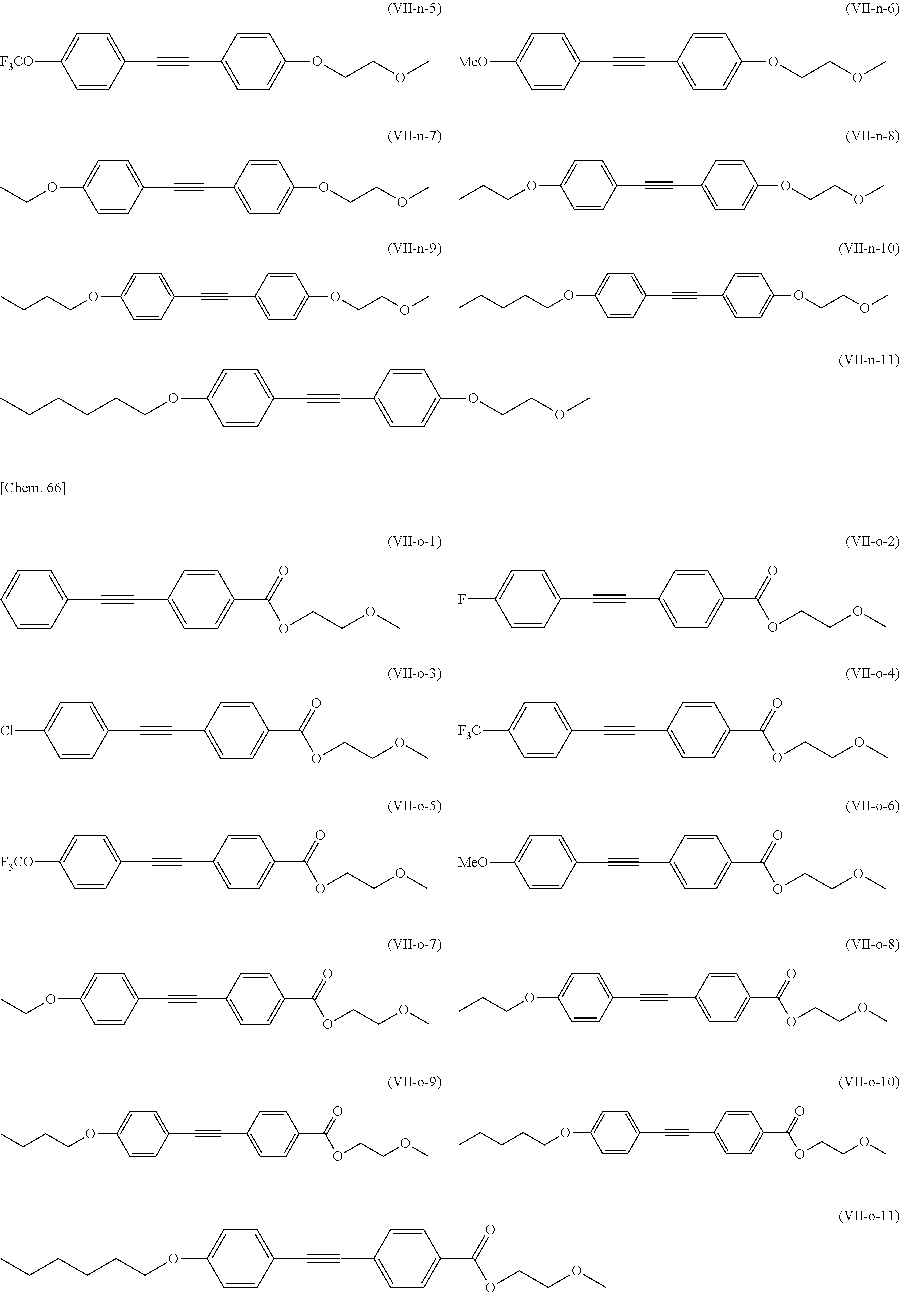

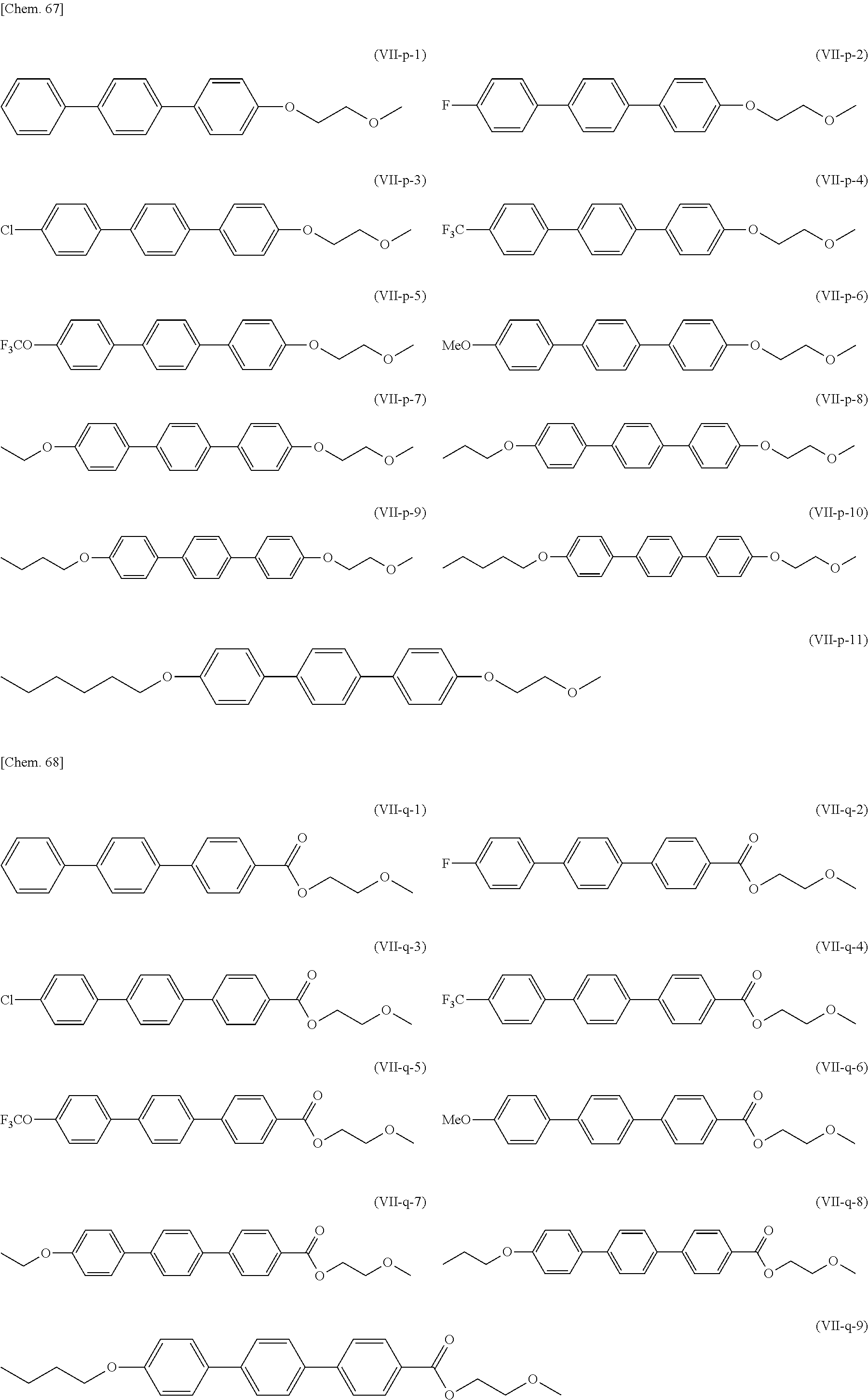

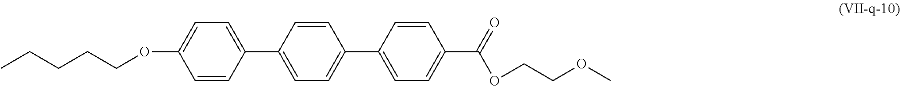 [SMILES: CCCCCOc1ccc(-c2ccc(-c3ccc(C(=O)OCCOC)cc3)cc2)cc1]

### <Preferable Polymer Main Chain>

The main chain of the polymer of the present invention has a repeating unit represented by at least one of General Formulae (U-11) and (U-12). The polymer main chain is preferably polyimide or polyamic acid. When polyimide or polyamic acid constitute the polymer main chain, the liquid crystal alignment layer using the polymer of the present invention is excellent in durability as compared with the liquid crystal alignment layer using a conventional polymer having a main chain of polyacrylic acid or the like.

In a solution state before the polymer of the present invention forms a liquid crystal alignment layer, from the viewpoint of enhancing the solubility of the polymer, the polymer main chain is preferably polyamic acid.

On the other hand, in a solid state in which the polymer of the present invention forms a liquid crystal alignment layer, from the viewpoint of enhancing the durability, the polymer main chain is preferably polyimide.

The polymer of the present invention has a side chain unit Ma and a side chain unit Mb. In the polymer of the present invention, a ratio of mole fraction (Ma/Mb) represented by the side chain unit Ma/side chain unit Mb is preferably 60/40 to 99/1, is more preferably 65/35 to 95/5, and is still more preferably 70/30 to 90/10.

The polymer of the present invention further preferably has a side chain unit Mc. When the side chain unit Mc is contained, a pretilt angle of the liquid crystal alignment layer of the present invention can be controlled to be high.

In the case of controlling the pretilt angle to be high, the mole fraction ratio of “side chain unit Ma+side chain unit Mb”/“side chain unit Mc” is preferably 70/30 to 95/5, is more preferably 75/25 to 90/10, and is still more preferably 80/20 to 85/15.

### <<Synthesizing of Polymer>>

As a method of synthesizing the polymer of the present invention, a known method of synthesizing polyamic acid and polyimide can be applied. For example, when a tetracarboxylic dianhydride and diamine are polymerized in an equimolar amount to obtain a polymer having polyamic acid as a main chain, and the polymer is dehydrated and cyclized by heating or catalysis, and thereby a polymer having a polyimide as a main chain.

In the synthesizing of the polyamic acid, when two kinds of diamines (diamine 1 and diamine 2) respectively having the side chain unit Ma and side chain unit Mb are used as diamine, polyamic acid can be obtained as the polymer of the present invention. Further, when the obtained polyamic acid is dehydrated and cyclized, polyimide can be obtained as the polymer of the present invention.

In the synthesizing of the polyamic acid, when the diamine (diamine 3) having the side chain unit Mc is used as diamine, it is possible to obtain polyamic acid as the polymer of the present invention which is provided with the side chain unit Mc.

As the diamine 1, the compound in which M is substituted with monovalent or divalent diamine in General Formula (I) is preferable.

As the diamine 2, the compound in which M is substituted with monovalent or divalent diamine in General Formula (II) is preferable.

As the diamine 3, the compound in which M is substituted with monovalent or divalent diamine in General Formula (QX) is preferable.

Here, the monovalent or divalent diamine substituting for M preferably has two —NH₂ groups and preferably contains a cyclic group. The cyclic group is a cycloalkane or an aromatic ring, and the atomic bond of the monovalent or divalent diamine is preferably bonded to any one selected from Z¹¹ in General Formula (I), Z²¹ in General Formula (II), and Sₐₐ in General Formula (QX).

The aromatic ring is preferably benzene, and the cycloalkane is preferably a 4 to 6 membered ring.

As the diamine 1 to diamine 3, for example, diamines represented by Formulae (R2A-A) to (R2A-G) can be exemplified. Among these, from the viewpoint of improving the durability of the liquid crystal alignment layer of the present invention, the diamines represented by Formulae (R2A-E) to (R2A-G) are preferable, and the diamines represented by Formula (R2A-F) or (R2A-G) are more preferable. One or more hydrogen atoms bonded to the aromatic ring of the following formula may be substituted with a halogen atom.

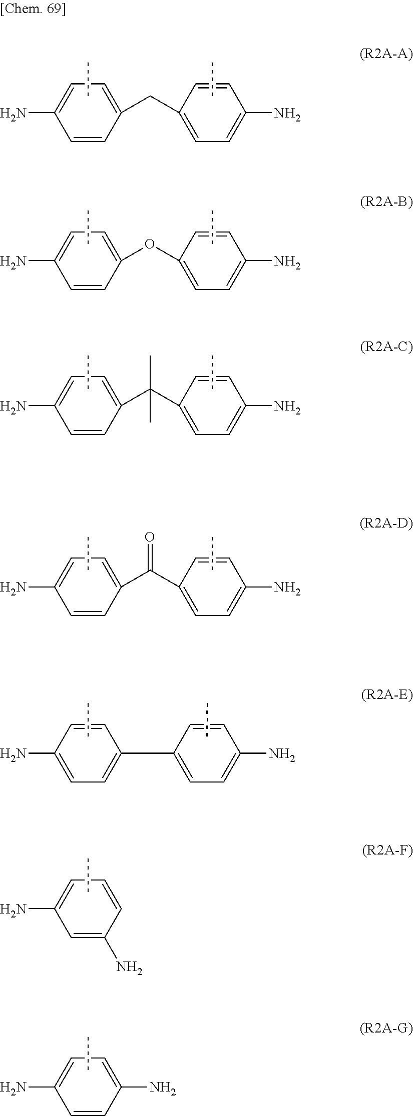

(In the formulae, each of the dashed lines independently represents a bond to any one selected from Z¹¹ in General Formula (I), Z²¹ in General Formula (II), and Sₐₐ in General Formula (QX)).

As the tetracarboxylic dianhydride, a compound is preferably represented by General Formula (U-00).

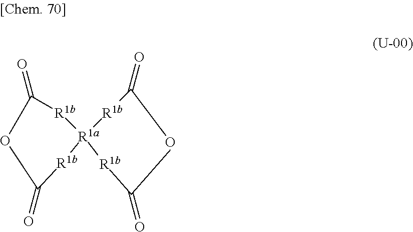

(In the formula, R^{1a} is a tetravalent organic group containing a cyclic group, R^{1b}′ s each independently represents a single bond or an alkylene group having 1 to 4 carbon atoms).

The description of R^{1a} and R^{1b} is the same as that of R^{1a} and R^{1b} in General Formula (U-11).

The polymer solution of the present invention is a solution of the polyimide or polyamic acid and the organic solvent. The organic solvent used here is not particularly limited, and examples thereof include N-methyl pyrrolidinone, butoxyethanol, 1,1,2-trichloroethane, N-methyl pyrrolidone, γ-butyrolactone, ethylene glycol, polyethylene glycol monomethyl ether, propylene glycol, 2-pyrrolidone, N,N-dimethyl formamide, phenoxyethanol, tetrahydrofuran, dimethyl sulfoxide, methyl isobutyl ketone, and cyclohexanone. Also, two or more kinds of organic solvents may be used in combination.

As a mixed solvent in which two or more kinds are used in combination, for example, N-methyl pyrrolidinone:butoxyethanol=1:1 (mass ratio) can be exemplified. In addition, the polymer solution preferably has a solid content of 1% to 10% by mass in terms of coatability. Particularly, the polymer solution of the present invention is preferably a polyamic acid solution in terms of the solubility in particular.

### <<Forming of Liquid Crystal Alignment Layer>>

When the film made of the polymer of the present invention is irradiated with polarized ultraviolet rays, a liquid crystal alignment layer having alignment regulating force can be obtained.

As a method of obtaining a liquid crystal alignment layer (photo-alignment film) made of the polymer can be obtained, for example, a method of obtaining a liquid crystal alignment layer by applying a solution of the polymer onto a substrate and drying the substrate.

The liquid crystal alignment layer of the present invention can be applied to a horizontal alignment or vertical alignment mode liquid crystal display element.

Examples of the material of the substrate include glass, silicon, polyethylene terephthalate, polybutylene terephthalate, polyether sulfone, polycarbonate, and triacetyl cellulose.

An electrode layer such as an ITO film made of Cr, Al, In₂O₃— SnO₂, or a NESA film made of SnO₂ may be provided on these substrates. For patterning these electrode layers, a photo etching method, a method using a mask for forming an electrode layer, or the like is used. Further, a color filter layer or the like may be formed on the substrate.

Examples of a method of coating a substrate with a solution containing a polymer include a spin coating method, a die coating method, a gravure coating method, a flexographic printing method, and an ink jet printing.

The solid content concentration of the solution at the time of coating is preferably 0.5% to 10% by weight. It is more preferable that the solid content concentration of the solution is selected from this range in consideration of the method of coating the solution on the substrate, viscosity, volatility, and the like.

After applying the polymer solution on the substrate, it is preferable to remove the solvent by heating the applied surface. The heating temperature is preferably 50° C. to 300° C., and is more preferably 80° C. to 200° C. The heating time in this preferred temperature range is preferably 2 to 200 minutes, and is more preferably 2 to 100 minutes.

The coating film formed on the substrate is irradiated with linearly polarized light from the direction normal to the coating film surface and/or irradiated with unpolarized light or linearly polarized light from an oblique direction to cause photoisomerization of the side chain unit Mb and a photocrosslinking reaction of the side chain unit Ma, and thereby a liquid crystal alignment layer imparted with alignment control capability is obtained. For giving a desired pretilt angle, linearly polarized light irradiation from an oblique direction is preferable. Here, irradiation from the oblique direction means the case where the angle formed by the light irradiation direction and the substrate surface is 1 degree to 89 degrees. In the case of being used as a liquid crystal alignment layer for vertical alignment, generally, the pretilt angle is preferably 70° to 89.8°. In addition, in the case of being used as a liquid crystal alignment layer for horizontal alignment, generally, the pretilt angle is preferably 0° to 20°.

For example, ultraviolet ray and visible light including light having a wavelength of 150 nm to 800 nm can be used as the light with which the coating film is irradiated, and ultraviolet ray of 270 nm to 450 nm is particularly preferable.

Examples of the light source include a xenon lamp, a high-pressure mercury lamp, an extra-high pressure mercury lamp, and a metal halide lamp. Linear polarized light can be obtained by using a polarizing filter or a polarizing prism for light from these light sources. Further, the ultraviolet ray and the visible light obtained from such a light source may be limited by an interference filter, a color filter, or the like, and the wavelength range to be irradiated may be limited.

The film thickness of the liquid crystal alignment layer to be formed is preferably about 10 to 250 nm, and more preferably about 10 to 100 nm.

### <<Method of Producing Liquid Crystal Display Element>>

By using the liquid crystal alignment layer of the present invention, for example, it is possible to produce a liquid crystal cell sandwiching a liquid crystal composition between a pair of substrates and a liquid crystal display element using the liquid crystal cell, for example, as follows.

A liquid crystal cell can be produced by preparing two substrates on which the above liquid crystal alignment layer in the present invention is formed and disposing liquid crystal between the two substrates. Alternatively, the liquid crystal alignment layer may be formed on only one of the two substrates.

As a method of producing the liquid crystal cell, for example, the following method can be exemplified. First, two substrates are arranged so that the respective liquid crystal alignment layers are opposed to each other, peripheral portions are bonded to each other using a sealing agent in a state where a certain gap (cell gap) is maintained between the two substrates, the liquid crystal composition is injected and filled into the cell gap defined by the substrate surface and the sealing agent, then sealing an injection hole, and thereby a liquid crystal cell can be produced.

Liquid crystal cell can also be produced by a method called a one drop fill (ODF) method. As a procedure, for example, an ultraviolet curable sealing agent is applied to a predetermined position on a substrate on which the liquid crystal alignment layer is formed, the liquid crystal composition is further dropped onto the liquid crystal alignment layer, and then another substrate is boned to the above substrate so as to face each other. Next, the entire surface of the substrate is irradiated with ultraviolet rays so as to cure the sealing agent, and thereby a liquid crystal cell can be produced.

It is desirable to remove flow alignment generated at the time of injection by heating to the temperature at which the liquid crystal used here assumes an isotropic phase and then slowly cooling to room temperature.

The liquid crystal composition is not particularly limited, and for example, a known nematic liquid crystal composition can be used. In the case of a vertically aligned liquid crystal cell, it is preferable to have negative dielectric anisotropy. In the case where a horizontally aligned liquid crystal cell, it is preferable to have positive dielectric anisotropy.

A liquid crystal display element can be obtained by attaching a known polarizing plate to the outer surface of the liquid crystal cell.

### <<Method of Producing of Optically Anisotropic Body>>

The optically anisotropic body of the present invention includes the liquid crystal alignment layer of the present invention, and a film made of a polymer of a polymerizable liquid crystal composition formed on the liquid crystal alignment layer. This optically anisotropic body is useful for applications such as an optically anisotropic film used for optical compensation of the liquid crystal display element and the like. In the optically anisotropic body, when light advances through it, the optical properties such as light propagation speed, refractive index, absorption, and the like are different depending on the traveling direction.

As a method for producing the optically anisotropic body of the present invention, for example, a method of forming a film of a polymer containing liquid crystal molecules aligned by forming the liquid crystal alignment layer on a substrate, and applying a polymerizable liquid crystal composition on the liquid crystal alignment layer.

In the case of producing the optically anisotropic body by applying the polymerizable liquid crystal composition on the liquid crystal alignment layer, a known coating methods such as a bar coating method, a spin coating method, a roll coating method, a gravure coating method, a spray coating method, a die coating method, a cap coating, and a dipping method can be applied. In order to improve the coatability, a known organic solvent may be added to the polymerizable liquid crystal composition. In the case of adding the organic solvent, the polymerizable liquid crystal composition is applied onto the liquid crystal alignment layer, and then the organic solvent is removed by a known drying method.

As a method of polymerizing the polymerizable liquid crystal composition, a method of irradiating the polymerizable liquid crystal composition with the active energy rays and a thermal polymerization method.

In the case where the polymerizable liquid crystal composition is polymerized by being irradiated with active energy rays, it is preferable that the liquid crystal alignment layer is coated with the polymerizable liquid crystal composition, and polymerization is performed in a state where polymerizable liquid crystal molecules are aligned. In the case where the polymerization of the polymerizable liquid crystal composition is performed by being irradiated with active energy rays, for example, a method of performing the irradiation with ultraviolet rays at an irradiation intensity of 1 W/m² to 10 kW/m².

The temperature in the case where the polymerization of the polymerizable liquid crystal composition is performed by heat, it is preferable that the polymerization is performed at or below the temperature at which the polymerizable liquid crystal composition exhibits a liquid crystal phase. A specific heating temperature is, for example, preferably 20° C. to 300° C., is more preferably 30° C. to 200° C., and is still more preferably 30° C. to 120° C. In addition, in the case where a polymerizable group is a (meth)acryloyloxy group, it is preferable to perform the reaction at a temperature lower than 90° C. At the above preferable temperature, heterogeneous polymerization due to heat can be prevented.

As a polymerization method of the polymerizable liquid crystal composition, any one or both of photopolymerization and thermal polymerization can be employed.

The optical axis of the optically anisotropic body of the present invention can be adjusted by controlling the pretilt angle by the liquid crystal alignment layer. In order to adjust the angle formed by the optical axis with respect to the substrate surface from 0° to 45°, the pretilt angle is preferably 0° to 45°. Similarly, in order to adjust the angle formed by the optical axis with respect to the substrate surface from 45° to 90°, the pretilt angle is preferably 45° to 900.

As a step of producing the optically anisotropic body provided with the liquid crystal alignment layer of the present invention, for example, the following methods can be exemplified. In a first step, a coating film of the polymer of the present invention is formed on the substrate. In a second step, light having anisotropy is irradiated to impart alignment control capability to the coating film so as to form a liquid crystal alignment layer. In a third step, a film of the polymerizable liquid crystal composition is formed on the liquid crystal alignment layer. In a fourth step, an optically anisotropic body is formed by polymerizing a film of the polymerizable liquid crystal composition. In the fourth step, the isomerization reaction and the crosslinking reaction may proceed concurrently in the liquid crystal alignment layer.

In the producing step exemplified as described above, the coating film is directly irradiated with the polymer of the present invention, and thus it is possible to obtain the liquid crystal alignment layer excellent in the alignment regulating force of the liquid crystal molecule.

In addition, as another producing method, the following method can be exemplified. In a first step, a coating film of the polymer of the present invention is formed on the substrate. In a second step, a film of the polymerizable liquid crystal composition is formed on the coating layer. In the third step, light having anisotropy is irradiated to impart an alignment control capability of the liquid crystal to the coating film of the polymer of the present invention so as to form a liquid crystal alignment layer. In a fourth step, an optically anisotropic body is formed by polymerizing a film of the polymerizable liquid crystal composition. Here, the third step and the fourth step may be preceded simultaneously by light irradiation or the like. The number of processes can be reduced by simultaneous progress.

If necessary, a plurality of the optically anisotropic bodies may be stacked. As a method of forming a stacked body of the optically anisotropic bodies, a method of repeating a method of forming a single layer plural times can be exemplified. Examples thereof include a method of forming a first layer of the optically anisotropic body on the liquid crystal alignment layer, newly forming a liquid crystal alignment layer on the first layer, and forming a second layer of the optically anisotropic body on the liquid crystal alignment layer, and a method of directly forming the second layer of the optically anisotropic body on the first layer of the optically anisotropic body formed on the liquid crystal alignment layer.

Applications of stacked bodies of optically anisotropic bodies having a plurality of layers of optically anisotropic bodies include, for example, applications that simultaneously perform optical compensation of a liquid crystal layer and a polarizing plate of a liquid crystal display element, applications that simultaneously optical compensation and brightness improvement of the liquid crystal layer of the liquid crystal display element, and applications that simultaneously optical compensation and brightness improvement of the polarizing plate of the liquid crystal display element.

In order to stabilize solvent resistance and heat resistance of the obtained optically anisotropic body, it is possible to perform a heat-aging treatment on the optically anisotropic body.

The polymerizable liquid crystal composition used for producing the optically anisotropic body is not particularly limited, and a known liquid crystal composition containing a polymerizable liquid crystal exhibiting liquid crystallinity in a composition with a single liquid crystal compound or another liquid crystal compound can be employed.

The optically anisotropic body obtained in the step may be used as a single optically anisotropic body by separating the optically anisotropic body layer from the substrate, or can be used as an optically anisotropic body which is not separated from the substrate and provided with the substrate.

### EXAMPLES

Hereinafter, the present invention will be described in further detail with reference to examples, but the scope of the present invention is not limited to these examples. The structure of the compound was confirmed by a nuclear magnetic resonance spectrum (NMR), a mass spectrum (MS), and the like. Unless otherwise specified, “parts” and “%” are on a mass basis.

### Synthetic Example 1

A compound (MW=578.66) represented by Formula (DA-C1) was synthesized in the following procedure.

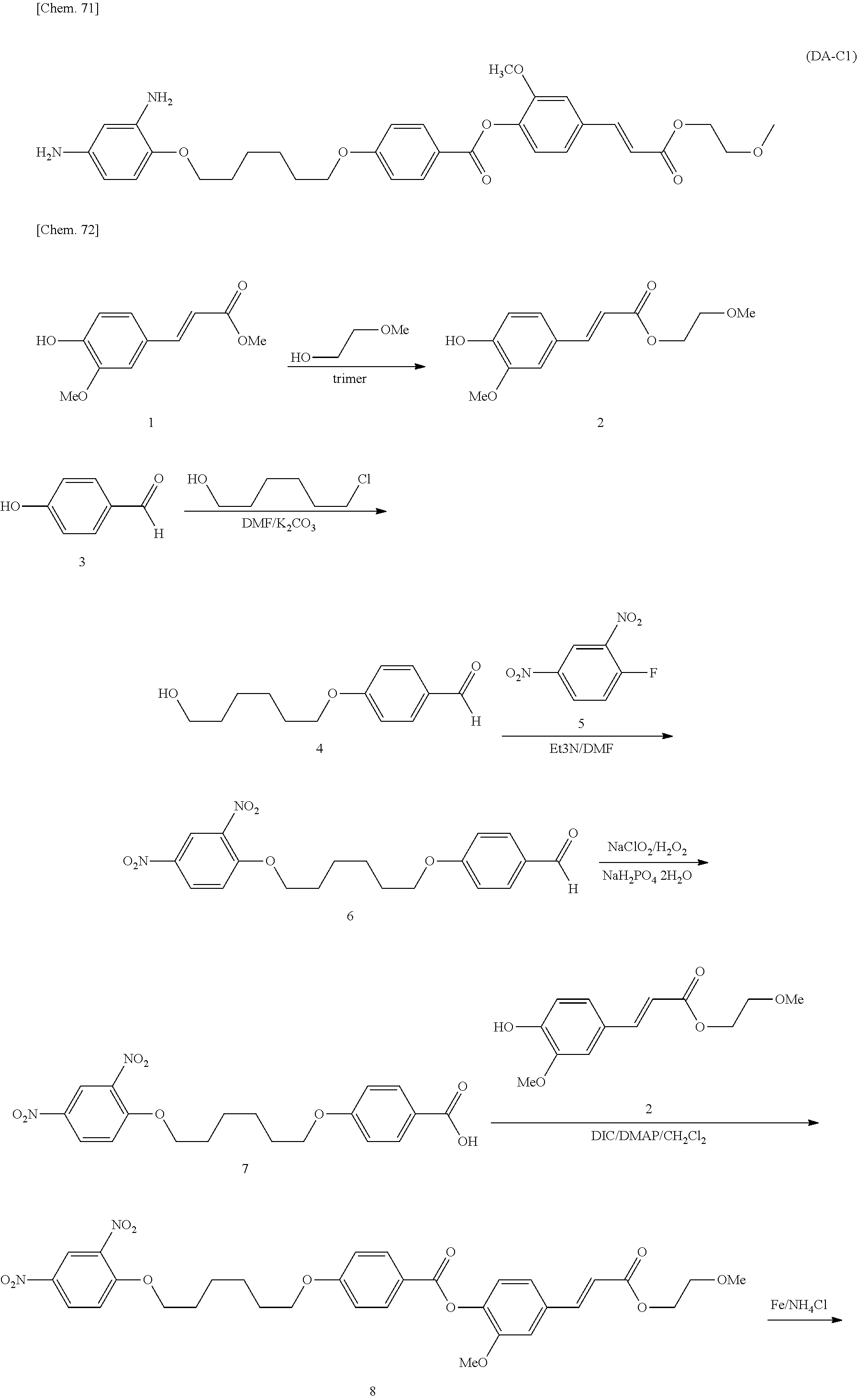

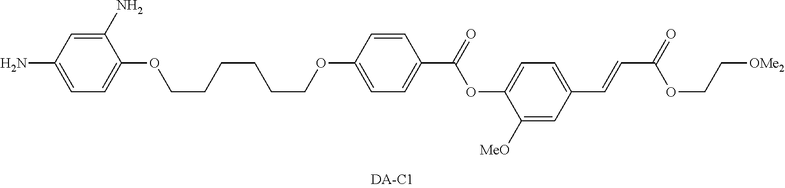

40 g of Compound 1, 1.5 g of trimer, and 600 mL of ethylene glycol monomethyl ether were mixed and stirred at 120° C. for 42 hours while being heated in an oil bath. After concentration of the reaction solution, 300 mL of ethyl acetate and 200 mL of water were added thereto, and the organic layer was extracted. The obtained organic layer was washed twice with 200 mL of saturated saline. After concentration of the obtained solution, and purification was performed with silica gel chromatography (eluent: hexane/ethyl acetate mixed solvent), thereby obtaining 34.1 g of Compound 2.

66.4 g of Compound 3, 112.6 g of potassium carbonate, and 300 mL of DMF were mixed, and stirred at 90° C. under a nitrogen atmosphere. 74 g of 6-chloro-1-hexanol was added dropwise to a reaction solution and stirred at 90° C. for 13 hours. To this solution, 200 mL of ethyl acetate and 100 mL of saturated brine were added, and the mixture was separated into two phases. After concentration of the obtained organic layer, and purification was performed with silica gel chromatography (eluent: hexane/ethyl acetate mixed solvent), thereby obtaining 91.6 g of Compound 4.

37.2 g of Compound 5, 44.4 g of Compound 4, 40.4 g of triethylamine, and 300 mL of DMF were mixed, and stirred at 80° C. for 15 hours under a nitrogen atmosphere. 200 mL of ethyl acetate and 200 mL of saturated brine were added thereto, and the organic layer was extracted. The organic layer was washed twice with 200 mL of saturated saline, and concentrated so as to obtain 95 g of Compound 6.

A solution obtained by dissolving 90 g of Compound 6 and 5.1 g of sodium dihydrogen phosphate dihydrate in 40 g of water, 24 g of H₂O₂ (30%), and 1, 500 mL of acetonitrile were mixed under ice cooling. To this reaction solution, a solution obtained by dissolving 26.5 g of sodium chlorite in 215 g of water was added dropwise and the mixture was stirred at room temperature for 24 hours. To this solution, 150 mL of 10% HCl was added thereto, followed by filtration. The obtained solution was washed with 1,500 mL of water so as to obtain 75 g of Compound 7.

50.1 g of Compound 7, 31 g of Compound 2, 2.2 g of 4-dimethyl aminopyridine, and 1,000 mL of methylene chloride were mixed, and was stirred at 0° C. under a nitrogen atmosphere. To this solution, a solution obtained by dissolving 17.8 g of N,N-diisopropyl carbodiimide with 30 mL of methylene chloride was added dropwise, and then stirred at room temperature for 24 hours. After the obtained solution was concentrated, the purification was performed with silica gel chromatography (eluent: hexane/methylene chloride mixed solvent), and re-crystallization (methanol) so as to obtain 59 g of Compound 8.

54 g of Compound 8, 18.5 g of 20% aqueous solution of ammonium chloride, 1,000 mL of THF, and 100 mL of methanol were mixed, and stirred 0° C. To this solution, 108 g of powdered zinc was added, and stirred at 0° C. for two hours, and stirred at 40° C. for two hours. After 200 mL of water was added, the reaction solution was concentrated, 200 mL of methylene chloride, and the organic layer was extracted. Further, the obtained organic layer was washed with 200 mL of saturated saline, concentrated, and purified with silica gel chromatography (eluent: hexane/ethyl acetate mixed solvent) and re-crystallization (hexane), thereby obtaining 28.4 g of Compound DA-C1.

### Synthetic Example 2

A compound (MW=573.65) represented by Formula (DA-C2) was synthesized in the following procedure.

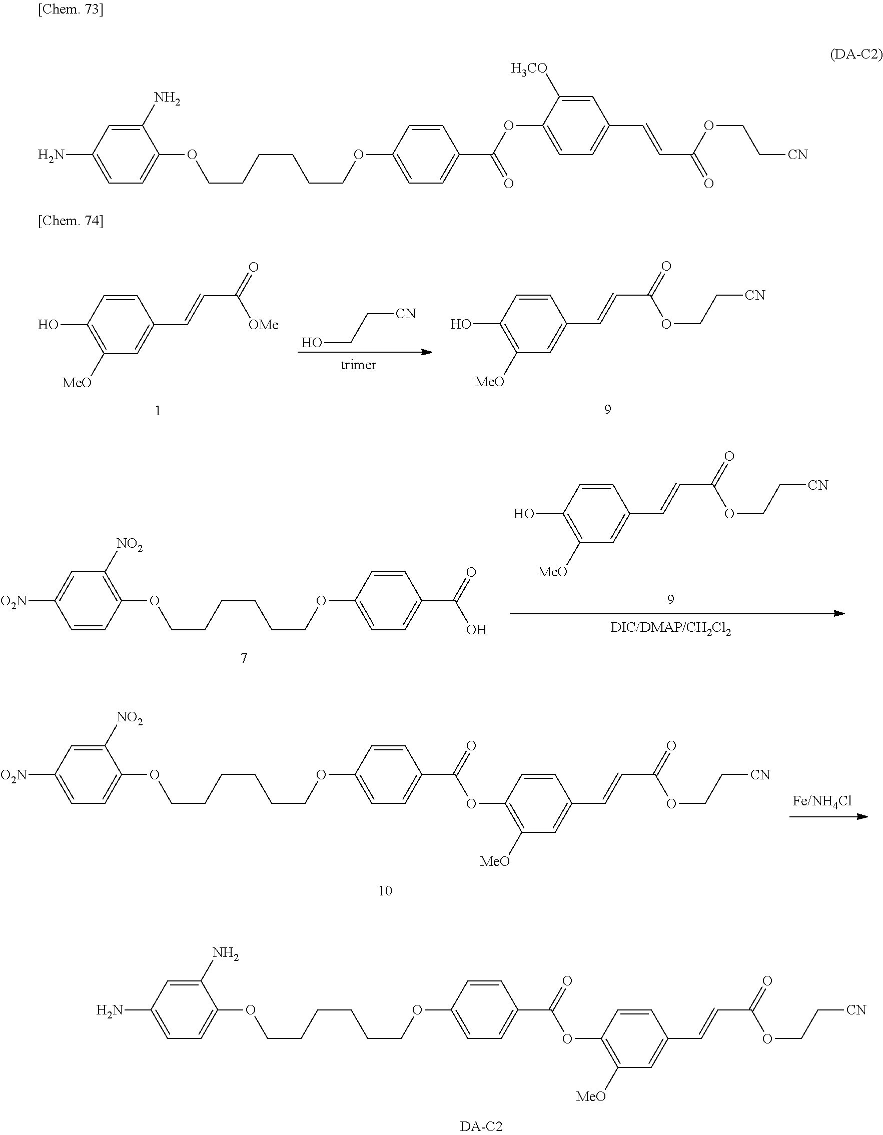

40 g of Compound 1, 1.5 g of trimer, and 600 mL of ethylene cyanohydrin were mixed and stirred at 120° C. for 42 hours while being heated in an oil bath. After concentration of the reaction solution, 300 mL of ethyl acetate and 200 mL of water were added thereto, and the organic layer was extracted. The obtained organic layer was washed twice with 200 mL of saturated saline. After concentration of the obtained solution, and purification was performed with silica gel chromatography (eluent: hexane/ethyl acetate mixed solvent), thereby obtaining 30 g of Compound 9. 25 g of Compound 7, 15 g of Compound 9, 1 g of 4-dimethyl aminopyridine, and 500 mL of methylene chloride were mixed, and was stirred at 0° C. under a nitrogen atmosphere. To this solution, a solution obtained by dissolving 9 g of N,N-diisopropyl carbodiimide with 15 mL of methylene chloride was added dropwise, and then stirred at room temperature for 24 hours. After the obtained solution was concentrated, the purification was performed with silica gel chromatography (eluent: hexane/methylene chloride mixed solvent), and re-crystallization (methanol) so as to obtain 30 g of Compound 10. 27 g of Compound 8, 9 g of 20% aqueous solution of ammonium chloride, 500 mL of THF, and 50 mL of methanol were mixed, and stirred 0° C. To this solution, 54 g of powdered zinc was added, and stirred at 0° C. for two hours, and stirred at 40° C. for two hours. After 100 mL of water was added thereto, the reaction solution was concentrated, 100 mL of methylene chloride was added thereto, and the organic layer was extracted. Further, the obtained organic layer was washed with 100 mL of saturated saline, concentrated, and purified with silica gel chromatography (eluent: hexane/ethyl acetate mixed solvent) and re-crystallization (hexane), thereby obtaining 14 g Compound DA-C2.

### Synthetic Example 3

A compound (MW=516.73) represented by Formula (DA-A1) was synthesized in the following procedure.

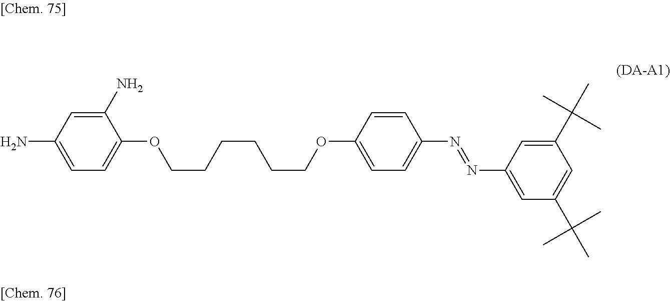 [SMILES: CC(C)(C)c1cc(/N=N/c2ccc(OCCCCCCOc3ccc(N)cc3N)cc2)cc(C(C)(C)C)c1]

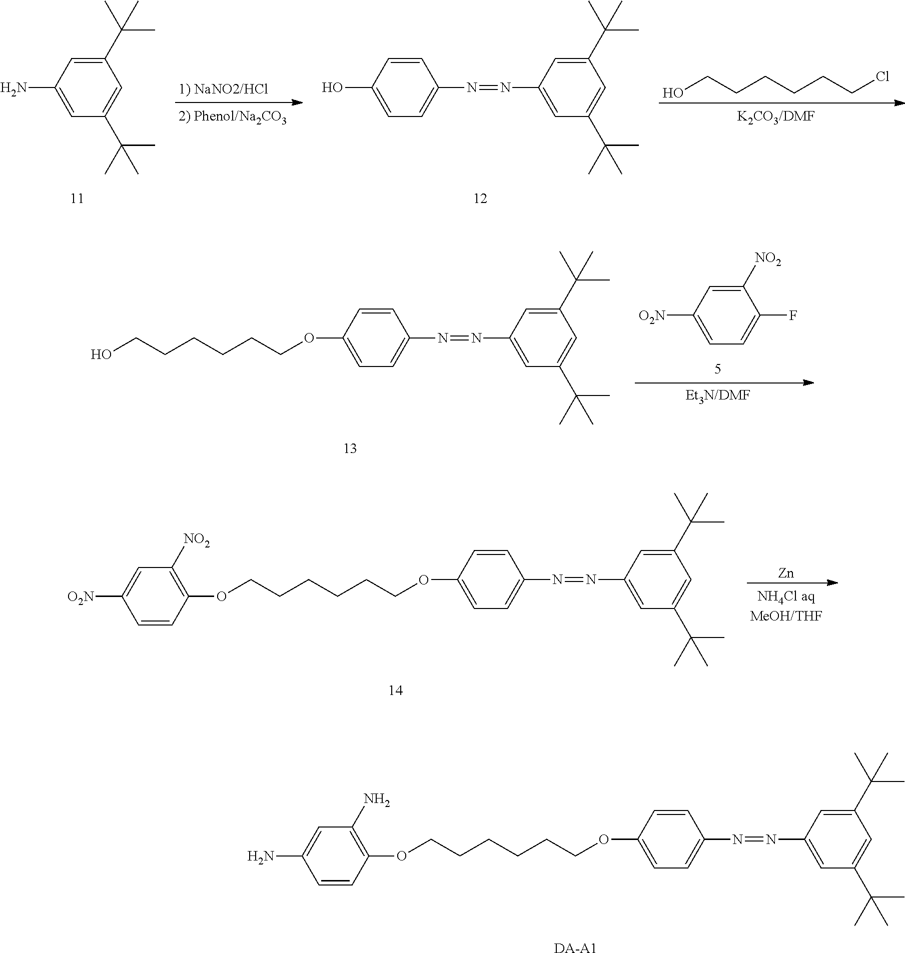

10 g of 36.5% HCl, 200 mL of water, and 5.1 g of Compound 11 were mixed and stirred under reflux until the solution became transparent. Thereafter, the temperature was lowered to 0° C. to precipitate a white solid, and then a solution of 1.9 g of sodium nitrite dissolved in 20 mL of water was slowly added dropwise. The mixture was stirred at 0° C. for 30 minutes to obtain a diazonium solution. Next, 2.3 g of phenol and 17.2 g of sodium carbonate were mixed in a separate reaction vessel and stirred at 0° C. The diazonium solution obtained earlier was slowly added dropwise thereto, and the mixture was stirred at 0° C. for two hours. The obtained solution was quenched with 36.5% HCl (pH3) and washed with water to give 3.2 g of Compound 12 of a yellow solid. 3 g of Compound 12, 1.5 g of 6-chloro-1-hexanol, 1.7 g of potassium carbonate, and 30 mL of DMF were added, and stirred at 90° C. for 16 hours. After 100 mL of water and 100 mL of methylene chloride were added, the organic layer was extracted. After the obtained solution was concentrated, the purification was performed with silica gel chromatography (eluent: hexane/methylene chloride mixed solvent) so as to obtain 4.5 g of Compound 13. 7.5 g of Compound 5, 8.9 g of Compound 13, 2.8 g of triethylamine, and 60 mL of DMF were mixed, and stirred at 80° C. for 32 hours. 200 mL of ethyl acetate and 200 mL of water were added thereto, and the organic layer was extracted. The obtained organic layer was washed with 100 mL of saturated saline, concentrated, and purified with silica gel chromatography (eluent: hexane/ethyl acetate mixed solvent), thereby obtaining 7.9 g of Compound 14. 7.9 g of Compound 14, 3.1 g of ammonium chloride, 10 mL of methanol, 100 mL of THF, and 40 mL of water were mixed, and stirred at 0° C. To this mixture, 17.6 g of powdered zinc was added, and stirred at 40° C. for 3 hours. After adding 100 mL of water, the organic layer was concentrated. To this solution, 100 mL of ethyl acetate was added, and the organic layer was extracted. The obtained organic layer was washed with 100 mL of saturated saline, concentrated, and purified with silica gel chromatography (eluent: hexane/ethyl acetate mixed solvent) and re-crystallization (methanol), thereby obtaining 2.3 g of DA-A1.

### Synthetic Example 4

A compound (MW=460.62) represented by Formula (DA-A2) was synthesized in the following procedure.

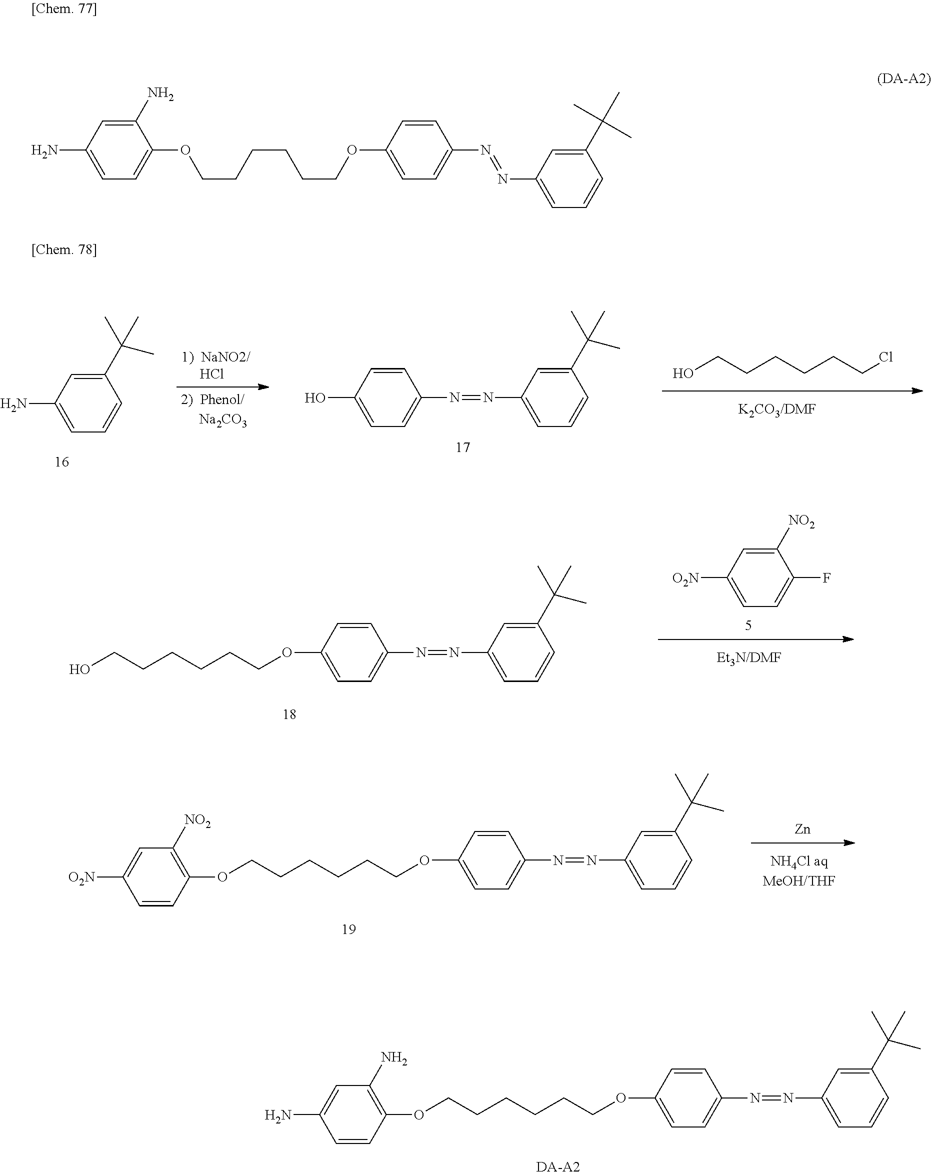

10 g of 36.5% HCl, 200 mL of water, and 3.7 g of Compound 16 were mixed and stirred under reflux until the solution became transparent. Thereafter, the temperature was lowered to 0° C. to precipitate a white solid, and then a solution of 1.9 g of sodium nitrite dissolved in 20 mL of water was slowly added dropwise. The mixture was stirred at 0° C. for 30 minutes, thereby obtaining a diazonium solution. Next, 2.3 g of phenol and 17.2 g of sodium carbonate were mixed in a separate reaction vessel and stirred at 0° C. The diazonium solution obtained earlier was slowly added dropwise thereto, and the mixture was stirred at 0° C. for two hours. The obtained solution was quenched with 36.5% HCl (pH3) and washed with water to give 3.0 g of Compound 17 of a yellow solid. 3 g of Compound 17, 1.4 g of 6-chloro-1-hexanol, 1.7 g of potassium carbonate, and 30 mL of DMF were added, and stirred at 90° C. for 16 hours. After 100 mL of water and 100 mL of methylene chloride were added thereto, the organic layer was extracted. After the obtained solution was concentrated, the purification was performed with silica gel chromatography (eluent: hexane/methylene chloride mixed solvent) so as to obtain 4.2 g of Compound 18. 7.5 g of Compound 5, 7.7 g of Compound 18, 2.8 g of triethylamine, and 60 mL of DMF were mixed, and stirred at 80° C. for 32 hours. 200 mL of ethyl acetate and 200 mL of water were added thereto, and the organic layer was extracted. The obtained organic layer was washed with 100 mL of saturated saline, concentrated, and purified with silica gel chromatography (eluent: hexane/ethyl acetate mixed solvent), thereby obtaining 7.0 g of Compound 19. 7.0 g of Compound 19, 3.1 g of ammonium chloride, 10 mL of methanol, 100 mL of THF, and 40 mL of water were mixed, and stirred at 0° C. To this mixture, 17.6 g of powdered zinc was added, and stirred at 40° C. for 3 hours. After adding 100 mL of water thereto, the organic layer was concentrated. To this solution, 100 mL of ethyl acetate was added, and the organic layer was extracted. The obtained organic layer was washed with 100 mL of saturated saline, concentrated, and purified with silica gel chromatography (eluent: hexane/ethyl acetate mixed solvent) and re-crystallization (methanol), thereby obtaining 2.0 g of DA-A2.

### Synthetic Example 5

A compound (MW=460.62) represented by Formula (DA-A3) was synthesized in the following procedure.

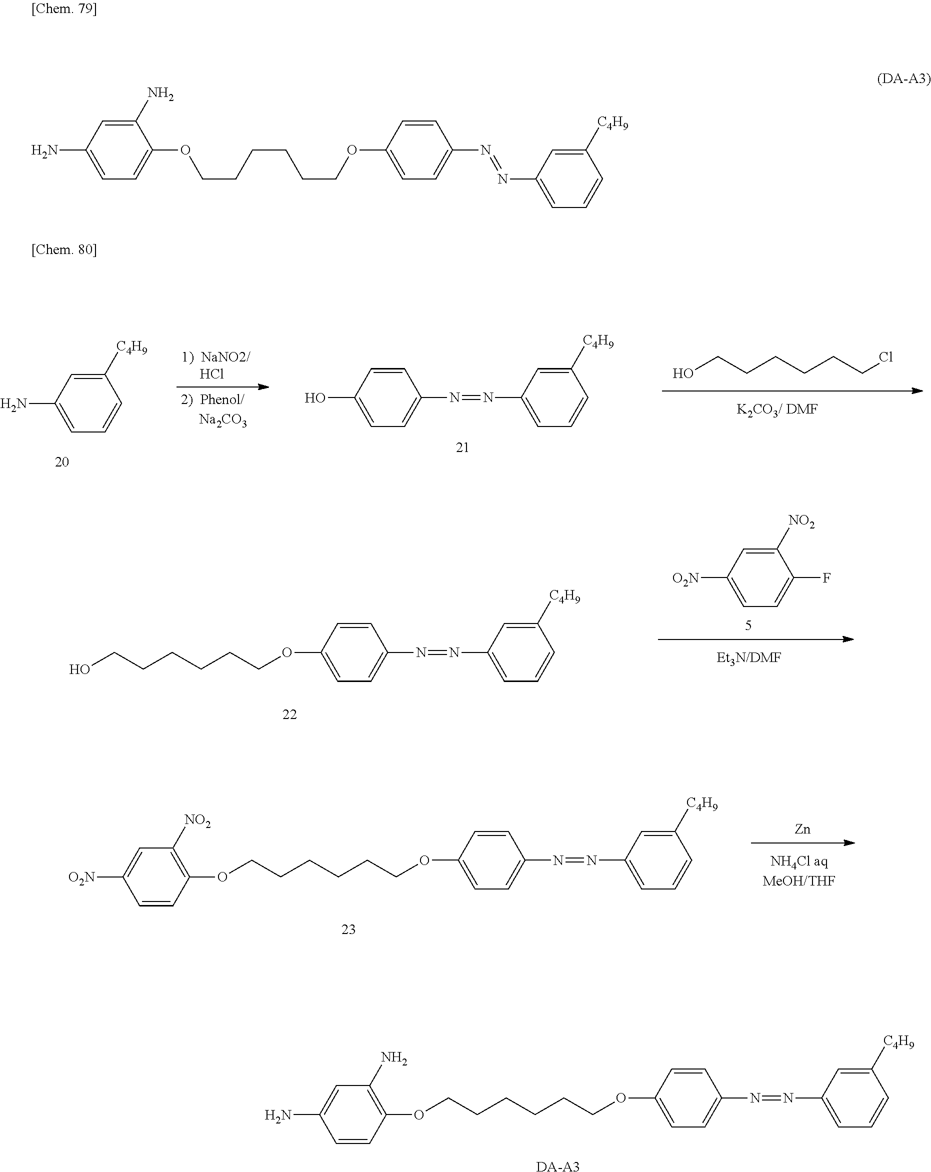

10 g of 36.5% HCl, 200 mL of water, and 3.7 g of Compound 20 were mixed and stirred under reflux until the solution became transparent. Thereafter, the temperature was lowered to 0° C. to precipitate a white solid, and then a solution of 1.9 g of sodium nitrite dissolved in 20 mL of water was slowly added dropwise. The mixture was stirred at 0° C. for 30 minutes, thereby obtaining a diazonium solution. Next, 2.3 g of phenol and 17.2 g of sodium carbonate were mixed in a separate reaction vessel and stirred at 0° C. The diazonium solution obtained earlier was slowly added dropwise thereto, and the mixture was stirred at 0° C. for two hours. The obtained solution was quenched with 36.5% HCl (pH3) and washed with water to give 3.2 g of Compound 21 of a yellow solid. 3 g of Compound 21, 1.4 g of 6-chloro-1-hexanol, 1.7 g of potassium carbonate, and 30 mL of DMF were added, and stirred at 90° C. for 16 hours. After 100 mL of water and 100 mL of methylene chloride were added thereto, and the organic layer was extracted. After the obtained solution was concentrated, the purification was performed with silica gel chromatography (eluent: hexane/methylene chloride mixed solvent) so as to obtain 4.2 g of Compound 22. 7.5 g of Compound 5, 7.7 g of Compound 22, 2.8 g of triethylamine, and 60 mL of DMF were mixed, and stirred at 80° C. for 32 hours. 200 mL of ethyl acetate and 200 mL of water were added, and the organic layer was extracted. The obtained organic layer was washed with 100 mL of saturated saline, concentrated, and purified with silica gel chromatography (eluent: hexane/ethyl acetate mixed solvent), thereby obtaining 7.1 g of Compound 23. 7.0 g of Compound 23, 3.1 g of ammonium chloride, 10 mL of methanol, 100 mL of THF, and 40 mL of water were mixed, and stirred at 0° C. To this mixture, 17.6 g of powdered zinc was added, and the resultant was stirred at 40° C. for 3 hours. After adding 100 mL of water thereto, the organic layer was concentrated. To this solution, 100 mL of ethyl acetate was added, and the organic layer was extracted. The obtained organic layer was washed with 100 mL of saturated saline, concentrated, and purified with silica gel chromatography (eluent: hexane/ethyl acetate mixed solvent) and re-crystallization (methanol), thereby obtaining 2.1 g of DA-A3.

### Synthetic Example 6

3.82 g (0.020 mol) of cyclobutanetetracarboxylic dianhydride (TCl) was added into a mixture containing 10.97 g (0.020 mol) of the compound (DA-C1) having 1,3-phenylene diamine and 140 g of N-methyl pyrrolidinone, which was being mixed and stirred at room temperature. Thereafter, the mixture was stirred for 24 hours. Thereafter, the reaction solution was added dropwise to 2 liters of methanol while stirring sufficiently, and reprecipitation was performed so as to obtain 8.4 g of polyamic acid resin powder (yield: 59%).

The polyamic acid resin powder was dissolved in a mixed solvent of N-methyl pyrrolidone:butoxyethanol=1:1 (mass ratio) in such an amount to provide a solid content of 5% by mass, thereby obtaining a polar acid solution (R1).

### Synthetic Example 7

The following polymer (PA-R1) was synthesized with reference to WO2013/002260 (PTL 1). The weight average molecular weight was about 200,000 as measured by GPC.

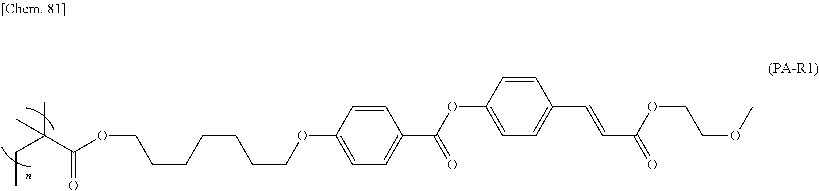

### (Preparation of Liquid Crystal Composition)

A liquid crystal composition A was prepared by mixing the compounds indicated in the following table at the ratios indicated in the table.

As a result of analyzing the liquid crystal composition A, a nematic-isotropic liquid phase transition temperature (clearing point) was 85.6° C., the extraordinary light refractive index nₑ at a wavelength of 589 nm was 1.596, the ordinary light refractive index nₒ at a wavelength of 589 nm was 1.491, the dielectric anisotropy was +7.0, and the K₂₂ was 7.4 pN.

TABLE 1

| | Mixing ratio |
|---|---|
| Liquid crystal compound | (% by mass) |
| 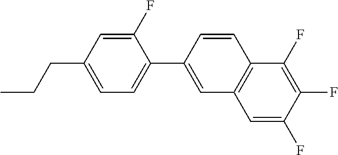 [SMILES: CCCc1ccc(-c2ccc3c(F)c(F)c(F)cc3c2)c(F)c1] | 9 |
| 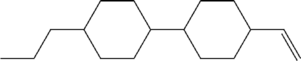 [SMILES: C=CC1CCC(C2CCC(CCC)CC2)CC1] | 37 |
| 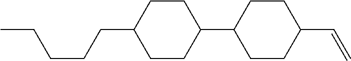 [SMILES: C=CC1CCC(C2CCC(CCCCC)CC2)CC1] | 2 |
| 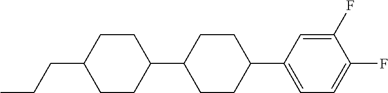 [SMILES: CCCC1CCC(C2CCC(c3ccc(F)c(F)c3)CC2)CC1] | 12 |
| 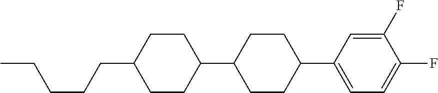 [SMILES: CCCCCC1CCC(C2CCC(c3ccc(F)c(F)c3)CC2)CC1] | 12 |
| 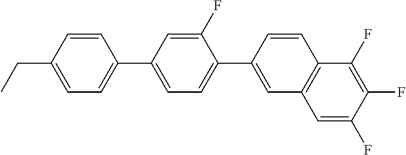 [SMILES: CCc1ccc(-c2ccc(-c3ccc4c(F)c(F)c(F)cc4c3)c(F)c2)cc1] | 4 |
| 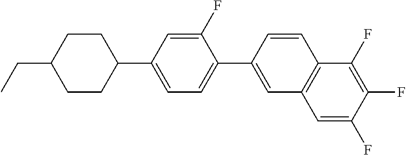 [SMILES: CCC1CCC(c2ccc(-c3ccc4c(F)c(F)c(F)cc4c3)c(F)c2)CC1] | 6 |
| 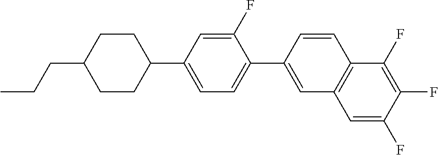 [SMILES: CCCC1CCC(c2ccc(-c3ccc4c(F)c(F)c(F)cc4c3)c(F)c2)CC1] | 13 |
| 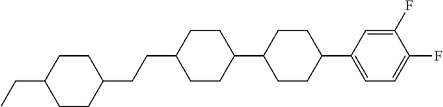 [SMILES: CCC1CCC(CCC2CCC(C3CCC(c4ccc(F)c(F)c4)CC3)CC2)CC1] | 5 |

### (Method of Measuring AC Burn-in)

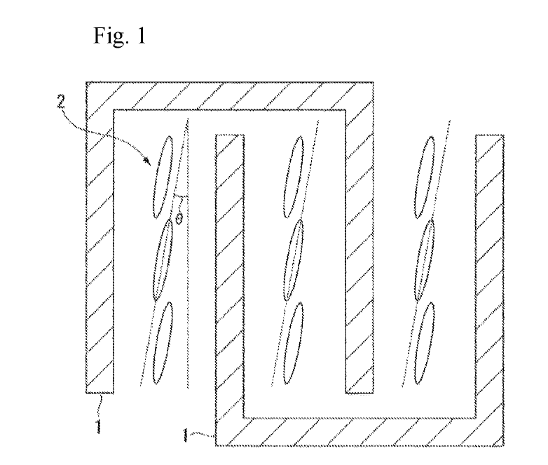

The evaluation of AC burn-in was performed by using a 4 μm IPS (In-Plane Switching) liquid crystal cell provided with a comb-tooth electrode of line/space=10 μm/10 μm. In the comb-tooth electrode having a partial structure shown in FIG. 1, when voltage is not applied, the alignment direction (the direction of the alignment regulating force) of the liquid crystal alignment layer was set such that the liquid crystal molecule has an angle of θ=10° with respect to the electrode.

The liquid crystal material was injected into the liquid crystal cell and then subjected to an aging treatment at 92° C. for two minutes. Thereafter, the polarizing plate was vertically attached to the liquid crystal cell. The upper and lower polarizing plates were arranged in an orthogonal arrangement and were set so that any one of the transmission axes of the upper and lower polarizing plates were parallel with the liquid crystal alignment direction when no voltage was applied.

The transmittance of light when an AC voltage (rectangular wave of 64 Hz) at 4 V was applied to the liquid crystal cell at room temperature was defined as T1. Next, an AC voltage at 10 V (a rectangular wave of 60 Hz) was applied at a temperature of 60° C. for 24 hours, and then the temperature was lowered to room temperature. The transmittance of light when the AC voltage (rectangular wave of 60 Hz) at 4 V was applied to the liquid crystal cell was defined as T2. Here, a value (T1/T2) obtained by dividing T1 by T2 was defined as an evaluation parameter of the AC burn-in. In an ideal state where the AC burn-in is not performed, the evaluation parameter becomes 1, and when being separated from the ideal state, the evaluation parameter becomes larger than 1.

### Comparative Example 1

An electrode free glass substrate and a comb-tooth electrode (line/space=10 μm/10 μm) glass substrate each was subjected to spin coating with a synthesized polyamic acid solution (R1), was heated at 80° C. for three minutes, and further heated and dried at 150° C. for five minutes, and thus, a thin film of polyamic acid with a thickness of 100 nm was formed on each glass substrate. A liquid crystal alignment layer was formed on each glass substrate by irradiating each thin film with 300 mJ/cm² of the polarized ultraviolet ray having a wavelength of 313 nm and an intensity of 20 mW/cm². Thereafter, heating was performed at 230° C. for one hour so as to perform polyimidization on the polymer main chain constituting each liquid crystal alignment layer. An IPS liquid crystal cell was fabricated using the electrode free glass substrate and the comb-tooth electrode glass substrate each having the liquid crystal alignment layer formed above. The structure of the IPS liquid crystal cell was as described above (method of measuring AC burn-in). The sealing agent used for fabricating the IPS liquid crystal cell was cured by heating at 150° C. for one hour. In the case of using the liquid crystal composition A prepared above as the liquid crystal cell, the measurement was performed in accordance with the (method of measuring AC burn-in), and the evaluation parameter was 1.07. The alignment direction of the liquid crystal was parallel to the polarization direction of the polarized UV. The VHR (driving voltage 1 V, 64 Hz, 60° C.) of the liquid crystal cell was measured by a conventional method, which was 96%. Further, when the application time of the AC voltage at 10 V in the above-mentioned measurement (evaluation of AC burn-in) was changed to 336 hours, the evaluation parameter was 1.07.

### Comparative Example 2

The synthesized polymer (PA-R1) was dissolved in a mixed solvent of N-methyl pyrrolidinone:2-butoxyethanol=50:50 (mass ratio) in such an amount to provide a solid content concentration of 5%. Using the resulting solution, a liquid crystal alignment layer was formed on each glass substrate in the same manner as in Comparative Example 1.

Subsequently, an IPS liquid crystal cell in which the liquid crystal composition A was injected was prepared in the same manner as in Comparative Example 1, and the measurement was performed in accordance with the above described (method of measuring AC burn-in), and the evaluation parameter was 1.22. The alignment direction of the liquid crystal was parallel to the polarization direction of the polarized UV. The VHR (driving voltage 1 V, 64 Hz, 60° C.) of the liquid crystal cell was measured by a conventional method, which was 97%. Further, when the application time of the AC voltage at 10 V in the above-mentioned measurement (evaluation of AC burn-in) was changed to 336 hours, the evaluation parameter was 1.24.

### Synthetic Example 8

3.824 g (0.020 mol) of cyclobutanetetracarboxylic dianhydride (TC1) was added into a mixture containing 9.88 g (0.018 mol) of the synthesized compound (DA-C1), 1.03 g (0.002 mol) of the synthesized compound (DA-A1), and 140 g of N-methyl pyrrolidinone, which was being mixed and stirred at room temperature. Thereafter, the mixture was stirred for 24 hours. Thereafter, the reaction solution was added dropwise to 2 liters of methanol while stirring sufficiently, and reprecipitation was performed so as to obtain 8.8 g of polyamic acid resin powder (yield: 62%).

The polyamic acid resin powder was dissolved in a mixed solvent of N-methyl pyrrolidone:butoxyethanol=1:1 (mass ratio) in such an amount to provide a solid content of 5% by mass, thereby obtaining a polar acid solution (E1).

### Example 1

Using the polyamic acid solution (E1), a liquid crystal alignment layer was formed on the respective glass substrates in the same manner as in Comparative Example 1.

Subsequently, an IPS liquid crystal cell in which the liquid crystal composition A was injected was prepared in the same manner as in Comparative Example 1, and an AC burn-in (24 hours voltage application), VHR, and AC burn-in (336 hours voltage application) was evaluated in the same manner as in Comparative Example 1. The results are illustrated in Table 2.

### Synthetic Example 9 to 22

In the same manner as in Synthesis Example 8, two compounds (diamine 1 and diamine 2) synthesized as described above were compounded in the mass ratios indicated in Table 2, and the resultant was subjected to polymerization reaction in a solvent containing a carboxylic acid (TC1 or TC2), thereby obtaining polyamic acid solutions (E2) to (E15).

Here, the carboxylic acid (T1) in Table 2 is cyclobutanetetracarboxylic dianhydride, and the carboxylic acid (T2) is 2,3,5-tricarboxycyclopentyl acetic dianhydride. In the case of using any of the carboxylic acids, a carboxylic acid was added in such an amount to provide the same molar number (equimolar amount) as the total number of moles of diamine 1 and diamine 2.

### Examples 2 to 15

Using each of polyamic acid solutions (E2) to (E15), a liquid crystal alignment layer was formed on the respective glass substrates in the same manner as in Example 1.

Subsequently, an IPS liquid crystal cell in which the liquid crystal composition A was injected was prepared in the same manner as in Example 1, and an AC burn-in (24 hours voltage application), VHR, and AC burn-in (336 hours voltage application) were evaluated in the same manner as in Example 1. The results are shown in Table 2.

TABLE 2

| | | | | | Diamine 1 | Diamine 2 | | AC burn-in | | AC burn-in |
|---|---|---|---|---|---|---|---|---|---|---|
| | Photoalignable | Carboxylic | | | (parts | (parts | Yield | (after 24 | | (after 336 |
| | polymer | acid | Diamine 1 | Diamine 2 | by mass) | by mass) | (%) | hours) | VHR | hours) |
| Comparative | Polyamic acid (R1) | TC1 | DA-C1 | — | 100 | 0 | 59 | 1.08 | 96.9 | 1.08 |
| Example 1 | | | | | | | | | | |
| Comparative | Polyacrylate (PA-R1) | — | — | — | — | — | | 1.22 | 97.0 | 1.24 |
| Example 2 | | | | | | | | | | |
| Example 1 | Polyamic acid (E1) | TC1 | DA-C1 | DA-A1 | 90 | 10 | 62 | 1.04 | 96.2 | 1.04 |
| Example 2 | Polyamic acid (E2) | TC1 | DA-C1 | DA-A1 | 80 | 20 | 62 | 1.03 | 96.9 | 1.03 |
| Example 3 | Polyamic acid (E3) | TC1 | DA-C1 | DA-A1 | 70 | 30 | 67 | 1.02 | 97.0 | 1.02 |
| Example 4 | Polyamic acid (E4) | TC1 | DA-C2 | DA-A1 | 90 | 10 | 44 | 1.05 | 97.0 | 1.05 |
| Example 5 | Polyamic acid (E5) | TC1 | DA-C2 | DA-A1 | 80 | 20 | 62 | 1.04 | 96.6 | 1.04 |
| Example 6 | Polyamic acid (E6) | TC1 | DA-C2 | DA-A1 | 70 | 30 | 59 | 1.04 | 96.6 | 1.04 |
| Example 7 | Polyamic acid (E7) | TC1 | DA-C1 | DA-A2 | 90 | 10 | 70 | 1.05 | 96.6 | 1.05 |
| Example 8 | Polyamic acid (E8) | TC1 | DA-C1 | DA-A2 | 80 | 20 | 56 | 1.05 | 97.0 | 1.05 |
| Example 9 | Polyamic acid (E9) | TC1 | DA-C1 | DA-A2 | 70 | 30 | 55 | 1.04 | 96.6 | 1.04 |
| Example 10 | Polyamic acid (E10) | TC2 | DA-C1 | DA-A1 | 90 | 10 | 63 | 1.04 | 96.3 | 1.04 |
| Example 11 | Polyamic acid (E11) | TC2 | DA-C1 | DA-A1 | 80 | 20 | 50 | 1.03 | 97.4 | 1.03 |
| Example 12 | Polyamic acid (E12) | TC2 | DA-C1 | DA-A1 | 70 | 30 | 44 | 1.04 | 97.3 | 1.04 |
| Example 13 | Polyamic acid (E13) | TC1 | DA-C2 | DA-A3 | 90 | 10 | 49 | 1.05 | 97.3 | 1.05 |
| Example 14 | Polyamic acid (E14) | TC1 | DA-C2 | DA-A3 | 80 | 20 | 56 | 1.03 | 97.2 | 1.03 |
| Example 15 | Polyamic acid (E15) | TC1 | DA-C2 | DA-A3 | 70 | 30 | 63 | 1.04 | 96.6 | 1.04 |

From the above results, it was confirmed that the AC burn-in was reduced in the liquid crystal cell equipped with the liquid crystal alignment layer of the present invention in the present invention. From the above, it was found that the liquid crystal alignment layer of the examples according to the present invention exhibits the excellent alignment regulating force. Further, in the producing of the liquid crystal alignment layer, the irradiation amount of the polarized ultraviolet ray was small, and thus it was found that the polymer of the examples of the present invention has high sensitivity to polarized ultraviolet ray. In addition, the liquid crystal alignment layer of the examples in the present invention is formed of a polymer having a polyimide main chain, and thus it is clear that the durability is excellent.

### INDUSTRIAL APPLICABILITY

The polymer of the present invention is widely applicable to the technical fields of liquid crystal display elements.

### REFERENCE SIGNS LIST

1 . . . COMB-TOOTH ELECTRODE,
2 . . . LIQUID CRYSTAL MOLECULE

1. A polymer comprising:
one or more kinds of side chain units Ma represented by General Formula (I): 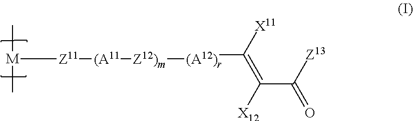
(wherein M represents a polymer main chain;
Z¹¹ and Z¹² each independently represent a single bond, —(CH₂)ᵤ— (where u represents 1 to 20), —OCH₂—, —CH₂O—, —COO—, —OCO—, —CH═CH—, —CF═CF—, —CF₂O—, —OCF₂—, —CF₂CF₂—, or —C≡C—, and one or more non-adjacent —CH₂— groups in these substituents each may be independently substituted with —O—, —CO—, —CO—O—, —O—CO—, —Si(CH₃)₂—O—Si(CH₃)₂—, —NR—, —NR—CO—, —CO—NR—, —NR—CO—O—, —O—CO—NR—, —NR—CO—NR—, —CH═CH—, —C≡C—, or —O—CO—O— (where R independently represents a hydrogen atom or an alkyl group having 1 to 5 carbon atoms);
A¹¹ and A¹² each independently represent (a) a trans-1,4-cyclohexylene group (one methylene group present or two or more non-adjacent methylene groups in the group may be substituted with —O—, —NH—, or —S—), (b) a 1,4-phenylene group (one or two or more —CH═'s present in this group may be substituted with —N═), and (c) a group selected from the group consisting of a 1,4-cyclohexenylene group, a 2,5-thiophenylene group, a 2,5-furanylene group, a 1,4-bicyclo[2.2.2]octylene group, a naphthalene-1,4-diyl group, a naphthalene-2,6-diyl group, a decahydronaphthalene-2,6-diyl group, and a 1,2,3,4-tetrahydronaphthalene-2,6-diyl group, and the group (a), group (b), or group (c) each may be unsubstituted or one or more hydrogen atoms thereof may be substituted with a fluorine atom, a chlorine atom, a cyano group, a methyl group, or a methoxy group;
m represents 0, 1 or 2, and in the case where m represents 2, plural A¹¹'s may be the same or different and plural Z¹²'s may be the same or different;
r represents 0, 1, or 2, and in the case where r represents 2, plural A¹²'s may be the same or different;
X¹¹ and X¹² each independently represent a hydrogen atom, a fluorine atom, a chlorine atom, a cyano group, or an alkyl group having 1 to 20 carbon atoms, the hydrogen atoms in the alkyl group may be substituted with a fluorine atom, and one —CH₂— group or two or more non-adjacent —CH₂— groups in the alkyl group may be substituted with one or more selected from —O—, —CO—O—, —O—CO—, and —CH═CH—; and
Z¹³ is represented by General Formula (Ia) or (Ib): 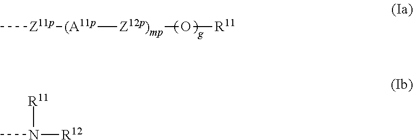
(wherein the dashed lines represent a bond to a carbon atom to which Z¹³ is bonded, R¹¹ and R¹² each independently represent a hydrogen atom or a linear or branched alkyl group having 1 to 30 carbon atoms, one —CH₂— group or two or more non-adjacent —CH₂— groups in R¹¹ and R¹² may be substituted with one or more selected from —O—, —CO—, —CO—O—, —O—CO—, —CO—NH—, —NH—CO—, —NCH₃—, —CH═CH—, —CF═CF—, and —C≡C—, one or two or more —CH₂— groups in R¹¹ and R¹² each may be independently substituted with a cycloalkylene group having 3 to 8 ring members, and the hydrogen atoms in R¹¹ and R¹² may be substituted with an alkyl group having 1 to 20 carbon atoms, a cyano group, or a halogen atom;
Z^{11p} and Z^{12p} each independently represent a single bond, —(CH₂)ᵤ— (where u represents 1 to 20), —OCH₂—, —CH₂O—, —COO—, —OCO—, —CH═CH—, —CF═CF—, —CF₂O—, —OCF₂—, —CF₂CF₂—, or —C≡C—, and one or more non-adjacent —CH₂— groups in these substituents may be independently substituted with —O—, —CO—, —CO—O—, —O—CO—, —Si(CH₃)₂—O—Si(CH₃)₂—, —NR—, —NR—CO—, —CO—NR—, —NR—CO—O—, —O—CO—NR—, —NR—CO—NR—, —CH═CH—, —C≡C—, or —O—CO—O— (where R independently represents a hydrogen atom or an alkyl group having 1 to 5 carbon atoms);
A^{11p} represents (a) a trans-1,4-cyclohexylene group (one methylene group or two or more non-adjacent methylene groups present in the group may be substituted with —O—, —NH—, or —S—), (b) a 1,4-phenylene group (one or two or more —CH═'s present in this group may be substituted with —N═), and (c) a group selected from the group consisting of a 1,4-cyclohexenylene group, a 2,5-thiophenylene group, a 2,5-furanylene group, a 1,4-bicyclo[2.2.2]octylene group, a naphthalene-1,4-diyl group, a naphthalene-2,6-diyl group, a decahydronaphthalene-2,6-diyl group, and a 1,2,3,4-tetrahydronaphthalene-2,6-diyl group, and the group (a), group (b), or group (c) each may be unsubstituted or one or more hydrogen atoms thereof may be substituted with a fluorine atom, a chlorine atom, a cyano group, a methyl group, or a methoxy group;
mp represents 0, 1 or 2, and in the case where mp represents 2, plural A^{11p}'s may be the same or different and plural Z^{12p}'s may be the same or different; and
g represents 0 or 1)); and
one or more kinds of side chain units Mb represented by General Formula (II): 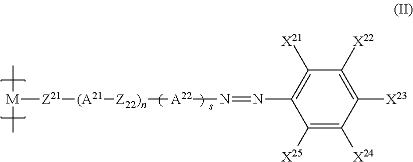
(wherein M represents a polymer main chain;
A²¹ and A²² each independently represent a trans-1,4-cyclohexylene group, a trans-1,3-dioxane-2,5-diyl group, a 1,4-naphthylene group, 2,6-naphthylene group, a pyridine-2,5-diyl group, a pyrimidine-2,5-diyl group, a 2,5-thiophenylene group, 2,5-furanylene group, or a 1,4-phenylene group, these may be unsubstituted or one or more hydrogen atoms thereof may be substituted with a fluorine atom, a chlorine atom, or a linear or branched alkyl group having 1 to 20 carbon atoms (one or more non-adjacent —CH₂— groups in the alkyl group may be independently substituted with —O—, —COO—, —OCO—, —CH═CH—, —CF═CF—, —CF₂O—, —OCF₂—, —CF₂CF₂—, —C≡C—, —CO—, —S—, —Si(CH₃)₂—O—Si(CH₃)₂—, —NR′—, —NR′—CO—, —CO—NR′—, —NR′—CO—O—, —O—CO—NR′—, —NR′—CO—NR′—, —CH═CH—, —C≡C—, or —O—CO—O— (in the formulae, R′ independently represents a hydrogen atom or an alkyl group having 1 to 5 carbon atoms), and one or more hydrogen atoms of the alkyl group having 1 to 20 carbon atoms may be substituted with a fluorine atom, a chlorine atom, a hydroxy group, or a cyano group);
X²¹, X²², X²³, X²⁴, and X²⁵ each may independently denote a hydrogen atom, a fluorine atom, a chlorine atom, a hydroxy group, a nitro group, a cyano group, or Formula (IIa):
-A²³-(Z²³-A²⁴)_{q}-R² (IIa)
wherein the dashed line represents a bond to a carbon atom to which X²¹ to X²⁵ are bonded;
A²³ and A²⁴ represent a single bond, a trans-1,4-cyclohexylene group, a trans-1,3-dioxane-2,5-diyl group, a 1,4-naphthylene group, 2,6-naphthylene group, a pyridine-2,5-diyl group, a pyrimidine-2,5-diyl group, a 2,5-thiophenylene group, 2,5-furanylene group, or a 1,4-phenylene group, these may be unsubstituted or one or more hydrogen atoms thereof may be substituted with a fluorine atom, a chlorine atom, or a linear or branched alkyl group having 1 to 20 carbon atoms (one or more non-adjacent —CH₂— groups in the alkyl group each may be independently substituted with —O—, —COO—, —OCO—, —CH═CH—, —CF═CF—, —CF₂O—, —OCF₂—, —CF₂CF₂—, —C≡C—, —CO—, —S—, —Si(CH₃)₂—O—Si(CH₃)₂—, —NR′—, —NR′—CO—, —CO—NR′—, —NR′—CO—O—, —O—CO—NR′—, —NR′—CO—NR′—, —CH═CH—, —C≡C—, or —O—CO—O— (where R′ independently represents a hydrogen atom or an alkyl group having 1 to 5 carbon atoms), and one or more hydrogen atoms of the alkyl group having 1 to 20 carbon atoms may be substituted with a fluorine atom, a chlorine atom, a hydroxy group, or a cyano group);
Z²¹, Z²², and Z²³ each independently represent a single bond, a linear or branched alkylene group having 1 to 40 carbon atoms, —OCH₂—, —CH₂O—, —COO—, —OCO—, —CH═CH—, —CF═CF—, —CF₂O—, —OCF₂—, —CF₂CF₂—, —N═N—, or —C≡C—, one or more non-adjacent —CH₂— groups in the alkylene group may be substituted with —O—, —COO—, —OCO—, —CH═CH—, —CF═CF—, —CF₂O—, —OCF₂—, —CF₂CF₂—, —C≡C—, —CO—, —S—, —Si(CH₃)₂—O—Si(CH₃)₂—, —NR′—, —NR′—CO—, —CO—NR′—, —NR′—CO—O—, —O—CO—NR′—, —NR′—CO—NR′—, —CH═CH—, —C≡C— or —O—CO—O— (where R′ independently represents a hydrogen atom or an alkyl group having 1 to 5 carbon atoms), and the hydrogen atoms of one or more —CH₂— groups in the alkylene group may be substituted with a fluorine atom, a chlorine atom, a hydroxy group, or a cyano group;
n and q each independently represent 0 or 1;
s represents 1 or 2, and in the case where s represents 2, plural A²²'s may be the same or different; and
R² represents a hydrogen atom or a linear or branched alkyl group having 1 to 40 carbon atoms, one or more non-adjacent —CH₂— groups in the alkyl group may be independently substituted with —O—, —COO—, —OCO—, —CH═CH—, —CF═CF—, —CF₂O—, —OCF₂—, —CF₂CF₂—, —C≡C—, —CO—, —S—, —Si(CH₃)₂—O—Si(CH₃)₂—, —NR′—, —NR′—CO—, —CO—NR′—, —NR′—CO—O—, —O—CO—NR′—, —NR′—CO—NR′—, —CH═CH—, —C≡C—, or —O—CO—O— (where R′ each independently represents a hydrogen atom or an alkyl group having 1 to 5 carbon atoms), the hydrogen atoms of one or more —CH₂— groups in the alkyl group having 1 to 40 carbon atoms may be substituted with a halogen atom, a hydroxy group, or a cyano group, and one or more —CH₂— groups of the alkyl group having 1 to 40 carbon atoms may be independently substituted with a cycloalkylene group having 3 to 8 ring members,
provided that in the case where A²³ is a single bond and q is 0, R² is not a hydrogen atom; and X²¹, X²², X²³, X²⁴, and X²⁵ are not the hydrogen atom at the same time),
wherein a polymer main chain represented by M in the side chain units Ma and Mb has a repeating unit represented by at least one of General Formulae (U-11) and (U-12): 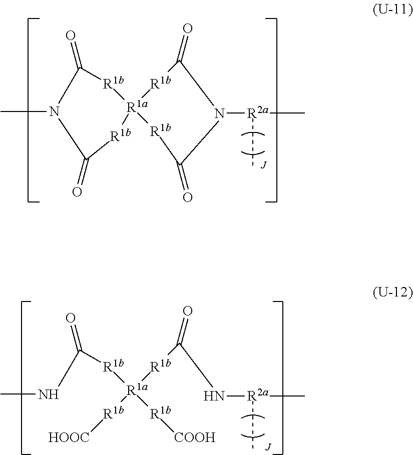
(wherein the dashed lines represent a bond to a group being bonded to M representing the polymer main chain of each side chain unit, R^{1a}'s each independently represent a tetravalent organic group containing a cyclic group, R^{1b}'s each independently represent a single bond or an alkylene group having 1 to 4 carbon atoms, R^{2a}'s each independently represent a trivalent or tetravalent organic group, and J represents 1 or 2).

2. The polymer according to claim 1,
wherein in General Formula (IIa), R² represents a linear or branched alkyl group having 1 to 30 carbon atoms (one or two or more —CH₂— groups in the alkyl group each may be independently substituted with a cycloalkylene group having 3 to 8 ring members, and the hydrogen atoms in the alkyl group may be unsubstituted or substituted with an alkyl group having 1 to 20 carbon atoms, a cyano group, or a halogen atom).

3. The polymer according to claim 1,
wherein in General Formula (Ia), Z^{11p} is a single bond, mp is 0, and g is 1.

4. The polymer according to claim 1,
wherein in General Formula (Ia) or (Ib), R¹¹ is represented by General Formula (Ic): 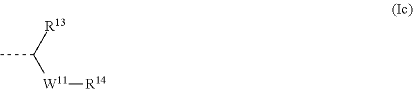
(wherein the dashed line represents the bond to the atom to which R¹¹ bonds, W¹¹ represents a methylene group (the hydrogen atom of the methylene group may be unsubstituted or substituted with an alkyl group having 1 to 5 carbon atoms), —CO—O— or —CO—NH—, R¹³ represents a hydrogen atom or an alkyl group having 1 to 5 carbon atoms, and R¹⁴ represents a linear or branched alkyl group having 1 to 20 carbon atoms (one —CH₂— group or two or more non-adjacent —CH₂— groups in the alkyl group may be substituted with —O—, —CO—, —CO—O—, —O—CO—, —CO—NH—, —NH—CO—, or —NCH₃—, one or two or more —CH₂— groups in the alkyl group each are independently substituted with a cycloalkylene group having 3 to 8 ring members, and the hydrogen atoms in the alkyl group may be unsubstituted or substituted with a fluorine atom, a chlorine atom, or a cyano group)).

5. The polymer according to claim 1,
wherein in General Formula (Ia) or (Ib), R¹¹ represents a linear or branched alkyl group having 1 to 30 carbon atoms (one —CH₂— group or two or more non-adjacent —CH₂— groups in the alkyl group are substituted with one or more selected from —CH═CH—, —CF═CF—, and —C≡C—, one or two or more —CH₂— groups in the alkyl group each may be independently substituted with a cycloalkylene group having 3 to 8 ring members, and the hydrogen atoms in the alkyl group may be substituted with an alkyl group having 1 to 20 carbon atoms, a cyano group, or a halogen atom), and R¹² represents a linear or branched alkyl group having 1 to 30 carbon atoms (one or two or more —CH₂— groups in the alkyl group each may be independently substituted with a cycloalkylene group having 3 to 8 ring members, and the hydrogen atoms in the alkyl group may be unsubstituted or substituted with an alkyl group having 1 to 20 carbon atoms, a cyano group, or a halogen atom).

6. The polymer according to claim 1,
wherein in General Formula (Ia) or (Ib), R¹¹ is represented by General Formula (Id) or (If): 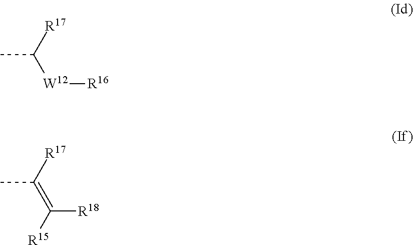
(wherein the dashed lines represent the bond to the atom to which R¹¹ bonds, W¹² represents a single bond, —CH₂—, —CO—O—, or —CO—NH—, R¹⁷ represents a hydrogen atom or an alkyl group having 1 to 5 carbon atoms, R¹⁸ represents a hydrogen atom or a linear or branched alkyl group having 1 to 20 carbon atoms (one or two or more —CH²— groups in the alkyl group each may be independently substituted with a cycloalkyl group having 3 to 8 ring members, and the hydrogen atoms in the alkyl group may be unsubstituted or substituted with a fluorine atom or a chlorine atom), R¹⁵ represents an alkyl group having 1 to 20 carbon atoms (the hydrogen atoms in the alkyl group may be substituted with a fluorine atom), and R¹⁶ represents an alkyl group having 1 to 20 carbon atoms (one —CH₂— group or two or more non-adjacent —CH₂— groups in the alkyl group are substituted with one or more selected from —CH═CH—, —CF═CF—, and —C≡C—, one or two or more —CH₂— groups in the alkyl group each may be independently substituted with a cycloalkyl group having 3 to 8 ring members, and the hydrogen atoms in the alkyl group may be substituted with a fluorine atom or a chlorine atom).

7. The polymer according to claim 1,
wherein in General Formula (I), X¹¹ and X¹² represent a hydrogen atom.

8. The polymer according to claim 1,
wherein in General Formula (I), r represents 1, A¹² represents any of a 2,6-naphthylene group, a pyridine-2,5-diyl group, a pyrimidine-2,5-diyl group, or a 1,4-phenylene group, one or more hydrogen atoms in any of the groups may be substituted with a fluorine atom, a chlorine atom, a methyl group, or a methoxy group, Z¹¹ represents any of a single bond, —(CH₂)ᵤ— (where u represents 1 to 20), —OCH₂—, —CH₂O—, —COO—, —OCO—, —CH═CH—, or —C≡C—, and one or more non-adjacent —CH₂— groups in any of the groups may be independently substituted with —O—, —CO—, —CO—O—, —O—CO—, —CH═CH—, or —C≡C—.

9. The polymer according to claim 1,
wherein in General Formula (II), at least one of X²² and X²⁴ is a fluorine atom, a chlorine atom, a hydroxy group, a nitro group, a cyano group, or a group represented by General Formula (IIa).

10. The polymer according to claim 1,
wherein a ratio of mole fraction (Ma/Mb) represented by the side chain unit Ma/side chain unit Mb is 99/1 to 60/40.

11. The polymer according to claim 1, further comprising one or more kinds of side chain units Mc represented by General Formula (QX): 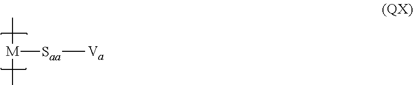
(wherein M represents a polymer main chain, the polymer main chain has a repeating unit represented by at least one of General Formulae (U-11) and (U-12), the dashed lines in General Formulae (U-11) and (U-12) bond to Sₐₐ in General Formula (QX), Sₐₐ represents a single bond or an alkylene group having 1 to 20 carbon atoms, Vₐ represents a monovalent organic group, one —CH₂— group or two or more non-adjacent —CH₂— groups of the alkylene group are may be independently substituted with one or more substituents selected from —O—, —CO—, —CO—O—, —O—CO—, —Si(CH₃)₂—O—Si(CH₃)₂—, —NR—, —NR—CO—, —CO—NR—, —NR—CO—O—, —O—CO—NR—, —NR—CO—NR— (where R independently represents a hydrogen atom or an alkyl group having 1 to 5 carbon atoms), —CH═CH—, —C≡C—, and —O—CO—O—, and one or more hydrogen atoms bonded to the group represented by General Formula (QX) may be substituted with a fluorine atom, a chlorine atom, a cyano group, a hydroxyl group, a carboxyl group, an amide group, a fluorine, a sulfide group, and a nitro group).

12. A polymer solution comprising any one of the polymers according to claim 1 and an organic solvent as essential components.

13. The polymer solution according to claim 12,
which has a solid content concentration of 1% to 20% by mass.

14. A liquid crystal alignment layer comprising the polymer according to claim 1.

15. The liquid crystal alignment layer according to claim 14.

16. A liquid crystal display element comprising the liquid crystal alignment layer according to claim 14.

17. An optically anisotropic body comprising the liquid crystal alignment layer according to claim 14.

18. The liquid crystal alignment layer is provided by applying the polymer solution according to claim 12 onto a substrate, drying and performing irradiation with polarized ultraviolet rays, and, as necessary, heating.
